(19) United States
(12) Patent Application Publication
(10) Pub. No.: US 2007/0109218 A1
(43) Pub. Date: May 17, 2007

(54) DISPLAY APPARATUS AND DISPLAY ELEMENT DRIVING METHOD

(75) Inventors: Nobuyoshi Saito, Kanagawa (JP); Shintaro Enomoto, Kanagawa (JP); Yukitami Mizuno, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/531,185

(22) Filed: Sep. 12, 2006

(30) Foreign Application Priority Data
Nov. 15, 2005 (JP) 2005-330618

(51) Int. Cl. G09G 3/20

(52) U.S. Cl. 345/55

(57) ABSTRACT

A display apparatus includes a display element that includes an electrolyte solution layer containing an electrochemical luminescent material; and a voltage applying unit that applies a voltage with a waveform having a gradient for a first period and a flat top for a second period following the first period, to the electrolyte solution layer, so that the electrochemical luminescent material emits light.

### CROSS-REFERENCE TO RELATED APPLICATIONS

This application is based upon and claims the benefit of priority from the prior Japanese Patent Application No. 2005-330618, filed on Nov. 15, 2005; the entire contents of which are incorporated herein by reference.

### BACKGROUND OF THE INVENTION

1. Field of the Invention

The present invention relates to a display apparatus that drives a display element using an electrochemical luminescent material so as to perform luminous display, and a display element driving method.

2. Description of the Related Art

As display apparatuses like liquid crystal display apparatuses that utilize display elements for enabling luminous display in a cell structure containing a liquid crystal, display apparatuses that utilize electrochemical luminescence (ECL) elements are preset. As disclosed in JP-A No. 2002-324401 (KOKAI), the ECL elements are constituted so that an electrochemical luminescent material (ECL material) and electrolyte are disposed between two electrodes. The ECL material emits light by reacting ion radical species having different polarities which are generated by electrochemical oxidation or reduction. When a voltage is applied to the ECL element so as to drive it, the ECL material emits light by itself so that the ECL element performs luminous display.

In a method of driving such an ECL element, generally an applied voltage is precipitously raised at the time of emission of light, that voltage is maintained for a constant period of time, the voltage is repeatedly dropped to zero precipitously at the time of extinction, and the voltage is applied to the ECL element so that a voltage waveform is a rectangular waveform.

Further, as display apparatuses such as mobile telephones which are used in the open air and in doors, semi-transmission type LCDs which enable both reflection display and luminous display are proposed. As disclosed in JP-A No. 2003-241188 (KOKAI) for example, in the semi-transmission type LCDs, a convexo-concave reflection layer is provided to a part of a pixel in order to perform reflection display for reflecting an external light beam so as to display a pixel. Further, a transmissive display unit is provided to another area in order to perform luminous display in which transmission of a light beam from back light is controlled and the light beam is led to the outside, and the back light is provided below the transmissive display unit.

In the method for enabling both the reflection display and the luminous display, the luminous display can be performed sufficiently bright and clearly depending on brightness of the back light. The reflection display, however, is subject to a restraint of liquid crystal display principle such as use of a polarizing plate and a restraint of a display area such that one pixel is divided into two areas for the reflection display and the luminous display. For this reason, clear display having sufficient contrast cannot be obtained. Since the polarizing plate is used, the utilization efficiency of the light decreases by half.

On the other hand, as display apparatuses that enable the reflection display with high contrast, electrochromic display apparatuses (ECD) are present. As disclosed in JP-A No. 2003-021848 (KOKAI) for example, such display apparatuses are constituted so that a colored substance (EC material), which are discolored, separated out or dissolved due to electrochemical oxidation or reduction, and electrolyte are disposed between two electrodes. Since ECD, however, performs only the reflection display, the display is hardly seen in dark places.

In the conventional methods of driving the ECL element, a phenomenon that luminance remarkably reduces after the voltage is applied occurs, and thus the display with high luminance cannot be obtained stably for a long period of time.

It is desired to provide a display apparatus which is not subject to the restraint of the display area per one pixel, performs clear display with sufficient contrast even in dark places and enables both the reflection display and the luminous display, and to stably obtain the display with high luminance for a long period of time in this display apparatus.

### SUMMARY OF THE INVENTION

According to one aspect of the present invention, a display apparatus includes a display element that includes an electrolyte solution layer containing an electrochemical luminescent material; and a voltage applying unit that applies a voltage with a waveform having a gradient for a first period and a flat top for a second period following the first period, to the electrolyte solution layer, so that the electrochemical luminescent material emits light.

According to another aspect of the present invention, a display apparatus includes a first layer that includes an electrochemical luminescent material; a second layer that includes an electrochromic material which is located so as to be opposed to at least a part of the first layer; a first voltage applying unit that applies a voltage to the first layer so that the electrochemical luminescent material emits light; a second voltage applying unit that applies a voltage to the electrochromic material to change a color of the electrochromic material; and a switching unit that selectively operates the first voltage applying unit and the second voltage applying unit.

According to still another aspect of the present invention, a method of driving a display element that includes an electrolyte solution layer containing an electrochemical luminescent material includes gradually increasing a voltage to be applied to the electrolyte solution layer up to a predetermined level; and maintaining the voltage of the predetermined level so that the electrochemical luminescent material emits light.

According to still another aspect of the present invention, a method of driving a display element that includes a first layer containing an electrochemical luminescent material and a second layer containing an electrochromic material and located so as to be opposed to at least a part of the first layer includes selectively executing a first voltage applying step and a second voltage applying step. The first voltage applying step includes applying a voltage to the first layer so that the electrochemical luminescent material emits light, and the second voltage applying step includes applying a voltage to the second layer to change a color of the electrochromic material.

### BRIEF DESCRIPTION OF THE DRAWINGS

FIG. 1 is a schematically explanatory diagram showing one example of a display element to be a display cell of a pixel of a display apparatus and a power supply circuit according to a first embodiment;

FIG. 2 is a circuit diagram showing an example in which a low-pass filter (LPF) is used in order that a waveform of a voltage between a first electrode and a second electrode becomes trapezoidal;

FIG. 3 is an explanatory diagram showing the display element and a circuit configuration of a driving unit when the second electrode is divided into a plurality of portions;

FIG. 4 is an explanatory diagram showing a waveform of an AC voltage to be applied to the display element of the display apparatus according to the first embodiment;

FIG. 5 is an explanatory diagram showing a waveform of a DC voltage to be applied to the display element of the display apparatus according to the first embodiment;

FIG. 6A is an explanatory diagram showing a waveform of an AC voltage to be applied to the display element of a conventional display apparatus;

FIG. 6B is an explanatory diagram showing a waveform of a DC voltage to be applied to the display element of a conventional display apparatus;

FIG. 7 is an explanatory diagram showing comparison between light emitting states of the display elements in the display apparatus according to the first embodiment and the conventional display apparatus;

FIG. 8 is a schematically sectional view showing one example of a configuration of the display element of the pixel in the display apparatus according to a second embodiment;

FIG. 9 is a schematically sectional view showing one example of a configuration of the pixel element in the display apparatus according to a first modified example of the second embodiment;

FIG. 10 is a schematically sectional view showing one example of the pixel element in the display apparatus according to a second modified example of the second embodiment;

FIG. 11 is a schematically sectional view showing one example of the pixel element in the display apparatus according to a third modified example of the second embodiment;

FIG. 12 is a sectional view schematically showing the display element to be the display cell in the display apparatus according to a third embodiment;

FIG. 13 is a sectional view schematically showing the display element to be the pixel in the display apparatus according to a fourth embodiment;

FIG. 14 is a sectional view schematically showing the display element to be the pixel in the display apparatus according to the fourth embodiment;

FIG. 15 a sectional view schematically showing the display element to be the display cell in the display apparatus according to a fifth embodiment;

FIG. 16 is a sectional view schematically showing the display element to be the display cell in the display apparatus according to a modified example of the fifth embodiment;

FIG. 17 is a sectional view schematically showing the display element to be the display cell in the display apparatus according to a sixth embodiment;

FIG. 18 is a sectional view schematically showing the display element to be the display cell in the display apparatus according to a modified example of the sixth embodiment;

FIG. 19 is a sectional view schematically showing the display element to be the display cell in the display apparatus according to a seventh embodiment;

FIG. 20 is a sectional view schematically showing the display element to be the display cell in the display apparatus according to a modified example of the seventh embodiment;

FIG. 21 is a sectional view schematically showing the display element to be the display cell in the display apparatus according to an eighth embodiment;

FIG. 22 is a sectional view schematically showing the display element to be the display cell in the display apparatus according to a modified example of the eighth embodiment;

FIG. 23 is a sectional view schematically showing the display element to be the display cell in the display apparatus according to a ninth embodiment;

FIG. 24 is a sectional view schematically showing the display element to be the display cell in the display apparatus according to a tenth embodiment;

FIG. 25 is a sectional view schematically showing the display element to be the display cell in the display apparatus according to a modified example of the tenth embodiment;

FIG. 26 is a sectional view schematically showing the display element to be the display cell in the display apparatus according to an eleventh embodiment;

FIG. 27 is a plan view showing a part (portion of 2×2) of an arrangement of the pixels in the display apparatus according to the first embodiment; and

FIG. 28 is a plan view showing a part (portion of 2×2) of an arrangement of the pixels in the display apparatus according to the second to eleventh embodiments.

### DETAILED DESCRIPTION OF THE INVENTION

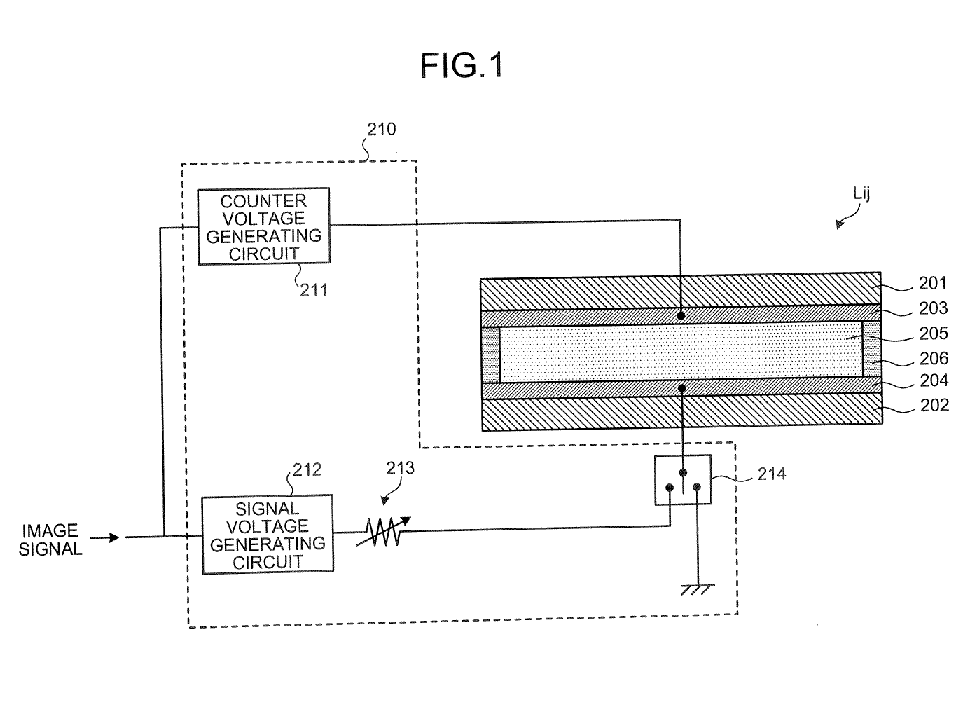

A display apparatus according to a first embodiment includes arrangement of pixels having display cells L_{i,j}, L_{i+1,j}, L_{i,j+1}, and L_{i+1,j+1}. Display apparatuses according to second to eleventh embodiments also have the similar configuration. FIG. 1 is a schematically explanatory diagram showing one example of a configuration of the display element L_{i,j} to be a display cell of a pixel X_{i,j} in the display apparatus according to the first embodiment and a configuration of a power supply circuit, where i=1 to n, j=1 to m, and n and m are positive integers. In FIG. 1, the configuration of the display element L_{i,j} is illustrated as a sectional view.

As shown in FIG. 1, the display element L_{i,j} in this embodiment has a first electrode 203 formed on a substrate 201, a second electrode 204 formed on a substrate 202 so as to be opposed to and separated from the first electrode 203, a spacer 206 which is installed securely to an end of the substrate 201 and an end of the substrate 202, and an electrolyte solution layer 205 in a sealed cell formed by the two substrates 201 and 202 and the spacer 206.

The first electrode 203 and the second electrode 204 are constructed in the sealed cell formed by the two substrates 201 and 202 and the spacer 206.

The electrolyte solution layer 205 is formed by an electrolyte solution containing an electrochemical luminescent material (ECL material) for emitting light due to the electrolyte solution, electrochemical oxidation or reduction. That is, as to the electrolyte solution, the electrolyte includes the electrochemical luminescent material (ECL molecules) as a luminescent material for emitting light due to electrochemical oxidation or reduction. The electrolyte is a liquid or a solid which can realize ECL light emission, and is normally composed of supporting electrolyte and organic solvent. The electrolyte is not limited to the supporting electrolyte and the organic solvent, and thus may be a liquid or a solid which improves oxidation and reduction of luminescent molecules. The luminescent molecules is oxidized near the electrodes so as to become radical cation and is reduced to become radical anion. When both the radical cation and the radical anion associate with each other and disappear, an exciting state of the luminescent material is generated, and light is emitted at the deactivation process.

Examples of the supporting electrolyte to be used as the electrolyte solution are tetrabutylammonium perchlorate, potassium hexafluorophosphate, lithium trifluoromethane sulfonate, lithium perchlorate, tetrafluoroboric tetra-n-butylammonium, tripropylamine, and tetra-n-butylammonium fluoroborate.

Examples of the solvent are acetonitrile, N,N-dimethylform-amide, propylene carbonate, o-dichlorobenzene, glycerin, water, ethyl alcohol, propyl alcohol, dimethyl carbonate, ethylene carbonate, γ-butyrolactone, N-methylpyrrolidone (NMP), 2-methyltetrahydrofuran, 1,2-dimethoxyethane, toluene, tetrahydrofuran, benzonitrile, cyclohexane, n-hexane, acetone, nitrobenzen, 1,3-dioxolan, furan and benzotrifluoride.

Examples of the ECL material are a naphthacene derivative (rubrene, 5,12-diphenyl naphthacene), an anthracene derivative (9,10-diphenyl anthracene), a pentacene derivative (6,10-diphenyl pentacene), a poly-para-phenylene vinylene derivative, a polythiophene derivative, a poly-para-phenylene derivative and a polyfluorene derivative as pi-conjugated polymer, coumalin as heteroaromatic compound, Ru (bpy) 32 as a chelate metallic complex, tris(2-phenylpyridine) iridium as organic metal compound, a chelate lanthanoids complex.

At least one of the substrate 201 formed with the first electrode 203 and the substrate 202 formed with the second electrode 204 is normally a display unit as an observation surface of the display element. For this reason, the substrate to be the display unit is formed by an optically-transparent material. Examples of the optically-transparent material are preferably materials with less absorption in a visible light region including inorganic materials such as glass and organic materials such as optically-transparent resin. More specific examples are polyethylene terephthalate (PET), polyethylene naphthalate (PEN), polyether sulfone (PES), and polycarbonate (PC).

In order to enable display by the electrolyte solution layer 205 to be observed, one of the first electrode 203 and the second electrode 204, which is positioned between the electrolyte solution layer 205 and the substrates to be the display unit, is formed by an optically-transparent material. Examples of such an optically-transparent material are oxides of transition metal such as oxides of titanium, zirconium, hafnium, strontium, zinc, tin, indium, yttrium, lanthanum, vanadium, niobium, tantalum, chromium, molybdenum and tungsten, perovskite such as SrTiO₃, CaTiO₃, BaTiO₃, MgTiO₃ and SrNb₂O₆, and their compound oxide, their oxide mixture, and GaN as metal oxide semiconductor. Further, the electrode formed on the substrate which does not become the display unit does not have to be formed by the optically-transparent material, and thus an arbitrary conductive material can be used. A material with high reflectivity such as Al or Ag is used as the electrode formed on the substrate which does not become the display unit and a conductive material with high light transmission property is used as the electrode formed on the substrate to be the display unit. As a result, the luminous display of the display element can be preformed more brightly and clearly.

A power supply circuit 210 is connected to the first electrode 203 and the second electrode 204 of the display element L_{i,j} having the above configuration. The power supply circuit 210 is composed of a counter voltage generating circuit 221, a signal voltage generating circuit 212, a variable resistor 213 and a switching element 214. This is a circuit that applies a voltage between the first electrode 203 and the second electrode 204 so that a voltage waveform becomes trapezoid.

The counter voltage generating circuit 211 is connected to the first electrode 203, and applies an alternating voltage (hereinafter referred to as “AC voltage”) to the first electrode 203 in a rectangular wave mode. The signal voltage generating circuit 212 is connected to the second electrode 204, and applies an AC voltage to the second electrode 204 in a rectangular wave mode. For this reason, an AC voltage of a difference between the AC voltage generated by the counter voltage generating circuit 211 and the AC voltage generated by the signal voltage generating circuit 212 is applied between the first electrode 203 and the second electrode 204. The application of this AC voltage generates radical species (radical anion and radical cation) with different polarities which are luminous molecules of the ECL material alternately in the vicinities of the first electrode 203 and the second electrode 204. When the generated radical anion and radical cation associate with each other to disappear and the excited ECL material is created and deactivated, light is emitted. When such application of the voltage is not successively performed, a non-luminous state is obtained.

In this embodiment, the AC voltage is applied between the first electrode 203 and the second electrode 204, but the counter voltage generating circuit 211 and the signal voltage generating circuit 212 may be constituted so that a direct voltage (hereinafter referred to as “DC voltage”) is applied between the first electrode 203 and the second electrode 204. The application of the DC voltage allows the first electrode 203 and the second electrode 204 to generate radical anion and radical cation as radical species with different polarities. The generated radical anion and the radical cation associate with each other to disappear, and the excited ECL material is created and deactivated so that the light is emitted.

The switching element 214 switches the connection between the second electrode 204 and the signal voltage generating circuit 212 and between the second electrode 204 and earth. That is, when the switching element 214 is switched into a right side of FIG. 1, the voltage between the first electrode 203 and the second electrode 204 becomes 0, and when the switching element 214 is switched into a left side of FIG. 1, a voltage is applied between the first electrode 203 and the second electrode 204.

The variable resistor 213 applies an AC voltage of the rectangular wave mode generated from the signal voltage generating circuit 212 to the second electrode 204 in a triangular wave mode in which the voltage gradually increases. Further, when a resistance value is variable by using the variable resistor 213, the gradient of the triangular wave can be arbitrarily changed.

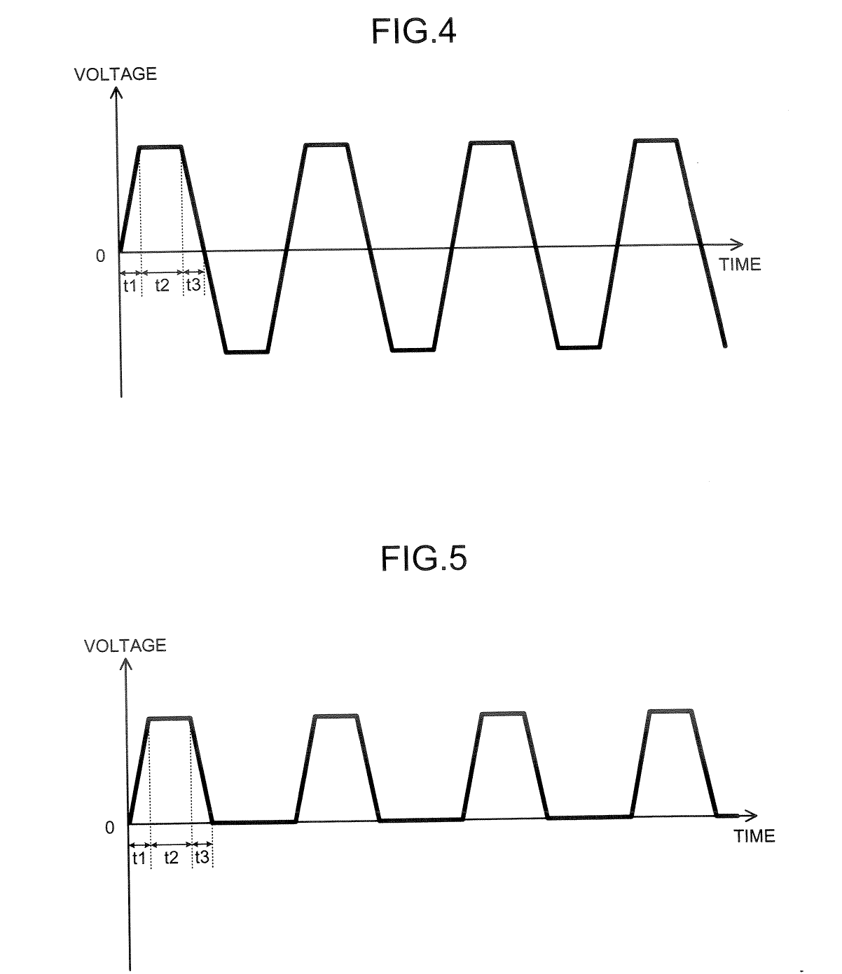

That is, as shown in FIG. 4 for example, when the AC voltage generated from the signal voltage generating circuit 212 is applied to the second electrode 204, the voltage passes through the variable resistor 213, so that while the voltage value is gradually increasing for a first period (t1), the voltage reaches a predetermined voltage value at the time when the first period elapses. In this embodiment, a resistor is given to the voltage to be applied so that a trapezoidal waveform is obtained. The trapezoidal waveform is such that the predetermined voltage is maintained for a second period (t2) which starts from the elapse of the first period, and while the voltage is gradually decreasing for a third period (t3) which starts from the elapse of the second period, the voltage value becomes 0 after constant time elapses. When the voltage with such a trapezoidal waveform is applied while its polarity is changed alternately, the AC voltage with the trapezoidal waveform is applied to the second electrode 204. In the power supply circuit 210 in this embodiment, the voltage is applied between the first electrode 203 and the second electrode 204 repeatedly with a constant cycle by the switching operation of the variable resistor 213 and the switching element 214 so that the voltage waveform for one cycle includes two trapezoidal waveforms with different polarities. Further, when the voltage with the trapezoidal waveform is applied repeatedly without changing the polarity, the DC voltage with the trapezoidal waveform is applied to the second electrode 204.

The voltage is applied in the triangular wave mode by the power supply circuit 210 when the display element L_{i,j} emits light. As a result, a peak current does not flow, efficient oxidation and reduction cycles are realized, and driving is carried out by a constant voltage so that the light emission with high luminance by the display element L_{i,j} can be maintained for a long period of time.

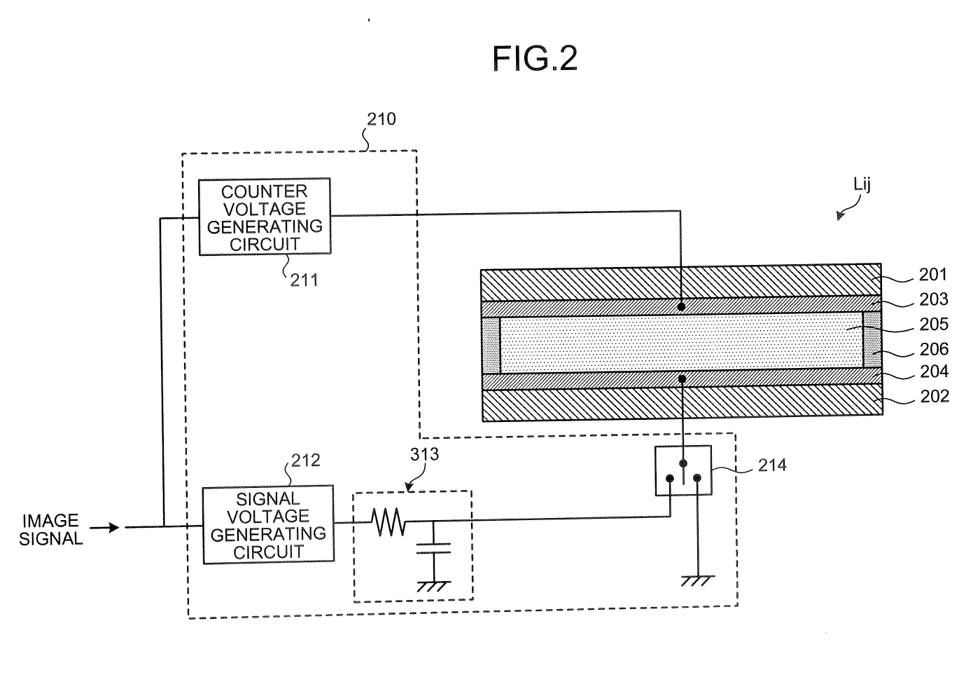

In this embodiment, the AC voltage is applied between the first electrode 203 and the second electrode 204 by the counter voltage generating circuit 211 and the signal voltage generating circuit 212, and the variable resistor 213 enables the AC voltage to obtain the trapezoidal waveform. However, a circuit or a circuit element other than the variable resistor 213 can be used as long as the waveform of the voltage becomes trapezoid. FIG. 2 is a circuit diagram showing an example using a low pass filter 313 (LPF) in order that the waveform of the voltage between the first electrode 203 and the second electrode 204 becomes trapezoid.

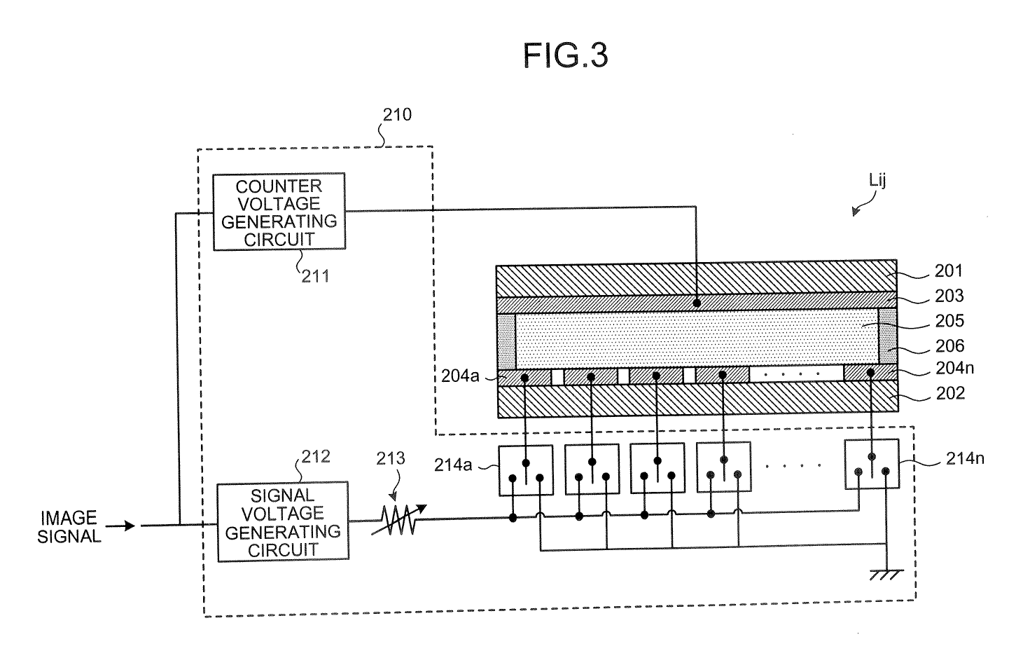

In the display element L_{i,j} of this embodiment, the second electrode 204 has a single structure, but the second electrode 204 may be divided into a plurality of portions and the display element L_{i,j} is used as a segment type display element L_{i,j}. FIG. 3 is an explanatory diagram showing a configuration of the display element L_{i,j} and a circuit configuration of the driving unit when the second electrode 204 is divided into a plurality of portions. In this example, as shown in FIG. 3, the second electrode is divided into a plurality of electrode portions 204a to 204n, and a plurality of switching elements 214a to 214n corresponding to them are connected to the signal voltage generating circuit 212 and the electrode portions 204a to 204n.

The switching elements 214a to 214n switch the connection between the connected electrode portions 204a to 204n as the second electrode and the signal voltage generating circuit 212 and between the electrode portions 204a to 204n and the earth. When, therefore, the switching elements 214a to 214n are switched into the right side, the voltage between the first electrode 203 and the electrodes 204a to 204n becomes 0. When the switching elements 214a to 214n are switched into the left side shown in FIG. 3, the voltage is applied between the first electrode 203 and the electrode portions 204a to 204n.

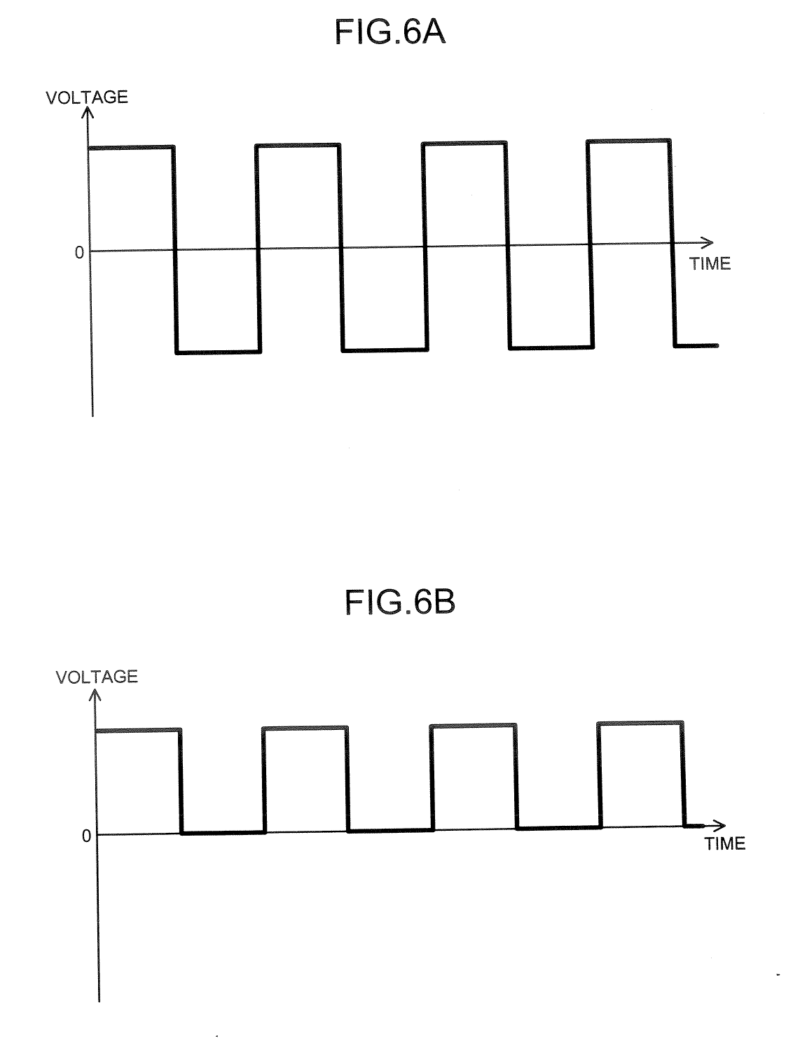

The following explains a waveform of the voltage to be applied between the first electrode 203 and the second electrode 204 of the display element L_{i,j} by the power supply circuit 210. FIG. 4 is an explanatory diagram showing the waveform of the AC voltage to be applied to the display element L_{i,j} in the display apparatus according to the first embodiment. FIG. 5 is an explanatory diagram showing the waveform of the DC voltage to be applied to the display element L_{i,j} in the display apparatus according to the first embodiment. On the other hand, FIG. 6A is an explanatory diagram showing the waveform of the AC voltage to be applied to the display element L_{i,j} in the conventional display apparatus, and FIG. 6B is an explanatory diagram showing the waveform of the DC voltage to be applied to the display element L_{i,j} in the conventional display apparatus. In all FIGS. 4, 5, 6A and 6B, the axis of abscissas represents the time, and the axis of ordinates represents the voltage value (V).

In contrast to the conventional display apparatus where the AC voltage which has a rectangular waveform with different polarities as shown in FIG. 6A is applied to the display element L_{i,j}, in the display apparatus according to the first embodiment, the power supply circuit 210 repeatedly applies the AC voltage which obtains a waveform where trapezoid waves with different polarities appear with each one cycle to the display element L_{i,j} as shown in FIG. 4. In contrast to the conventional display apparatus where the DC voltage which has a rectangular waveform as shown in FIG. 6B is applied to the display element L_{i,j}, in the display apparatus according to the first embodiment, the power supply circuit 210 may repeatedly apply the DC voltage which has a trapezoidal waveform with one polarity as shown in FIG. 5 to the display element L_{i,j}. When the voltage of the rectangular waveform is applied like the conventional display apparatus, a peak of a charging current is observed in the value of the current flowing in the display element L_{i,j}, but it is preferable that the gradient of the trapezoidal waveform in the display apparatus of this embodiment is enough gentle to prevent the peak of the charging current from appearing.

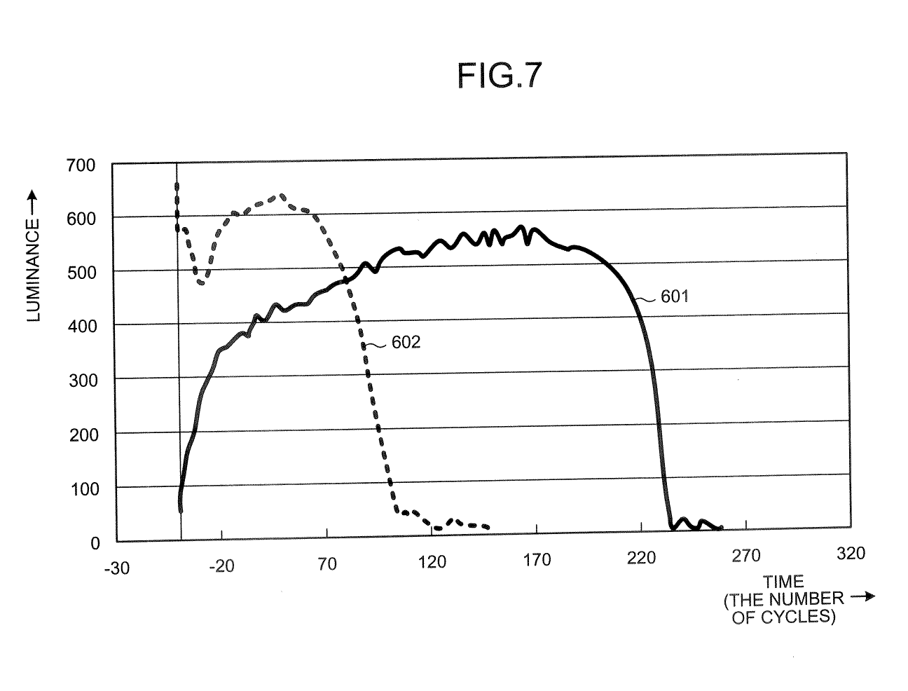

FIG. 7 is an explanatory diagram showing comparison of the light emitting state of the display element L_{i,j} between the display apparatus in the first embodiment and the conventional display apparatus. In FIG. 7, the axis of abscissas represents the time, and the axis of ordinates represents the luminance of the display element. In FIG. 7, a curve 601 shows the light emitting state (a change in the luminance) of the display element L_{i,j} in this embodiment, and a curve 602 shows the light emitting state (a change in the luminance) of the display element L_{i,j} in the conventional display apparatus. As is clear from FIG. 7, in this embodiment (curve 601), when the voltage of the trapezoidal waveform is repeatedly applied to the display element, the light emission with high luminance by the display element can be maintained for a longer period of time in comparison with the case where the voltage of the rectangular waveform is applied like the conventional display apparatus (curve 602).

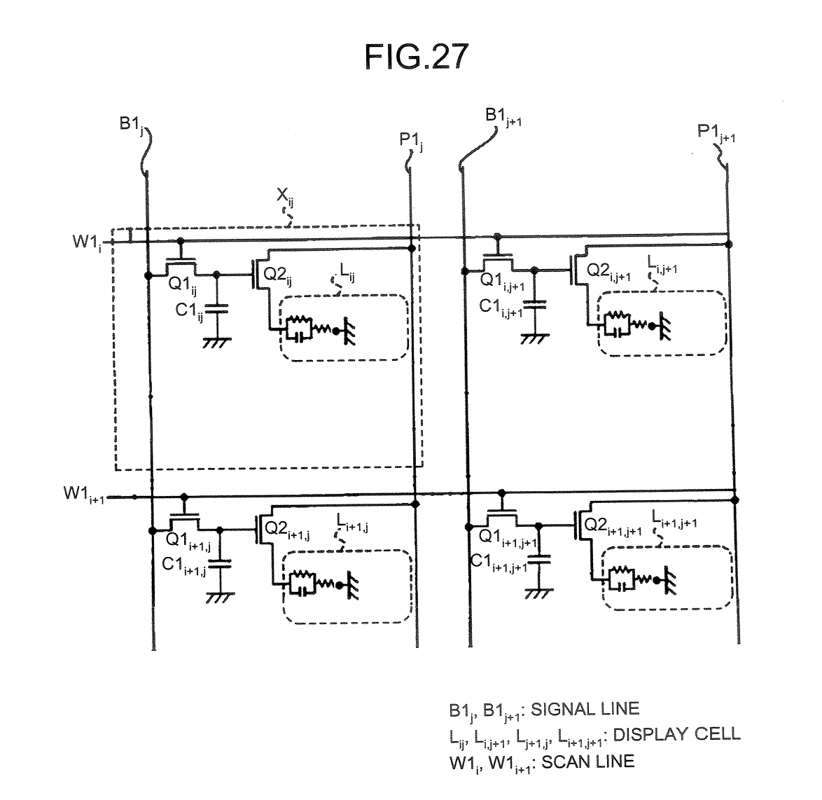

The following explains a configuration of an arrangement of pixels in the display apparatus having the display element L_{i,j} according to the first embodiment. FIG. 27 is a plan view showing a part (portion of 2×2) of the arrangement of the pixels in the display apparatus having the display element L_{i,j} according to the first embodiment. In the display apparatus according to the first embodiment, as shown in FIG. 27, pixels X_{i,j} are respectively arranged inside a matrix two-dimensionally. The matrix is composed of a plurality of signal wirings B1ⱼ, B1ⱼ₊₁ . . . which are laid in a vertical direction (column-wise direction) and a plurality of scanning wirings W1ᵢ, W1i₊₁, . . . which extend in a horizontal direction (row direction) perpendicular to the signal wirings B1ⱼ, B1ⱼ₊₁ . . . (i=1 to n; j=1 to m: n and m are positive integers). Further, power source wirings P1ⱼ, P1ⱼ₊₁, . . . are laid parallel with the signal wirings B1ⱼ, B1ⱼ₊₁, . . . .

As shown in FIG. 27, a first terminal of a writing transistor (TFT) Q1_{i,j} is connected to the signal wiring B1ⱼ, and a control terminal of the writing transistor Q1_{i,j} is connected to the scanning wiring W1ᵢ. A second terminal of the writing transistor Q1_{i,j} is connected to a control terminal of a driving transistor (TFT) Q2_{i,j} and one terminal of an auxiliary capacitor C1_{i,j}. A first terminal of the driving transistor Q2_{i,j} is connected to the power supply wiring P1ⱼ, and a second terminal of the driving transistor Q2_{i,j} is connected to a display cell L_{i,j}. The other terminal of the auxiliary capacitor C1_{i,j} is grounded. “The first terminal” means one of an emitter terminal and a collector terminal in a bipolar transistor (BJT). The first terminal means one of a source terminal and a drain terminal in a field-effect transistor (FET) or a static induction transistor (SIT). “The second terminal” means one of an emitter terminal and a collector terminal which does not become the first terminal in BJT or the like, and means one of a source terminal and a drain terminal which does not become the first terminal in FET or SIT. That is, when the first terminal is the emitter terminal, the second terminal is the collector terminal, and when the first terminal is the source terminal, the second terminal is the drain terminal. “The control terminal” means a terminal for controlling an electric current flowing between the first terminal and the second terminal, a Schottky junction terminal, a terminal or a configuration of an insulating gate. For example, the control terminal means the gate terminal or the gate configuration in FET or SIT, and means the base terminal in BJT. Since the first terminal and the second terminal generally have symmetrical configurations in TFT or the like, it is a simply matter of selection as to which is called as the source terminal or the drain terminal or which is called as the emitter terminal or the collector terminal.

A first terminal of the writing transistor (TFT) Q1_{i+1,j} is connected to the signal wiring B1ⱼ, and a control terminal of the writing transistor Q1_{i+1,j} is connected to the scanning wiring W1ᵢ₊₁. A second terminal of a writing transistor Q1_{i+1,j} is connected to a control terminal of a driving transistor (TFT) Q2_{i+1,j} and one terminal of an auxiliary capacitor C1_{i+1,j}. A first terminal of the driving transistor Q2_{i+1,j} is connected to the power supply wiring P1ⱼ, and a second terminal of the driving transistor Q2_{i+1,j} is connected to a display cell L_{i+1,j}. The other terminal of the auxiliary capacitor C1_{i+1,j} is grounded.

A first terminal of a writing transistor (TFT) Q1_{i,j+1} is connected to the signal wiring B1ⱼ₊₁, and a control terminal of the writing transistor Q1_{i,j+1} is connected to the scanning wiring W1ᵢ. A second terminal of the writing transistor Q1_{i,j+1} is connected to a control terminal of a driving transistor (TFT) Q2_{i,j+1} and one terminal of an auxiliary capacitor C1_{i,j+1}. A first terminal of the driving transistor Q2_{i,j+1} is connected to the power supply wiring P1ⱼ₊₁, and a second terminal of the driving transistor Q2_{i,j+1} is connected to a display cell L_{1,j+1}. The other terminal of the auxiliary capacitor C1_{i,j+1} is grounded.

A first terminal of a writing transistor (TFT) Q1_{i+,j+1} is connected to the signal wiring B1ⱼ₊₁, and a control terminal of the writing transistor Q1_{i+1,j+1} is connected to the scanning wiring W1ᵢ₊₁. A second terminal of the writing transistor Q1_{i+1,j+1} is connected to a control terminal of a driving transistor (TFT) Q2_{i+1,j+1} and one terminal of an auxiliary capacitor C1_{i+1,j+1}. A first terminal of the driving transistor Q2_{i+1,j+1} is connected to the power supply wiring P1ⱼ₊₁, and a second terminal of the driving transistor Q2_{i+1,j+1} is connected to a display cell L_{i+1,j+1}. The other terminal of the auxiliary capacitor C1_{i+1,j+1} is grounded.

The writing transistors Q1_{i,j}, Q1_{i+1,j}, Q1_{i,j+1} and Q1_{i+1,j+1}, the driving transistors Q2_{i,j}, Q2_{i+1,j}, Q2_{i,j+1} and Q2_{i+1,j+1} may be TFT which is used for an active matrix substrate used in an LCD or an organic EL.

The scanning wirings W1ᵢ, W1ᵢ₊₁, . . . and the signal wirings B1ⱼ, B1ⱼ₊₁, . . . are synchronized with each other and the voltage is applied, and display signals from the writing transistors Q1_{i,j}, Q1_{i+1,j}, Q1_{i,j+1}, Q1_{i+1,j+1} . . . are accumulated in the auxiliary capacities C1_{i,j}, C1_{i+1,j}, C1_{i,j+1}, C1_{i+1,j+1}, . . . . The driving transistors Q2_{i,j}, Q2_{i+1,j}, Q2_{i,j+}, Q2_{i+1,j+1} . . . can control the amount of a current to flow in the display cells Li_{,j}, L_{i+1,j}, L_{i,j+1} and L_{i+1,j+1} according to the charge content of the display signals in the auxiliary capacities C1_{i,j, C1}_{i+1,j}, C1_{i,j+1}, C1_{i+1,j+1}, . . . .

A second embodiment is explained below.

The display apparatus in the first embodiment performs only the luminous display using the electrolyte solution layer of the display element, but the display apparatus in the second embodiment performs the luminous display using a first layer of the display element, and performs reflection display using a second layer of the display element.

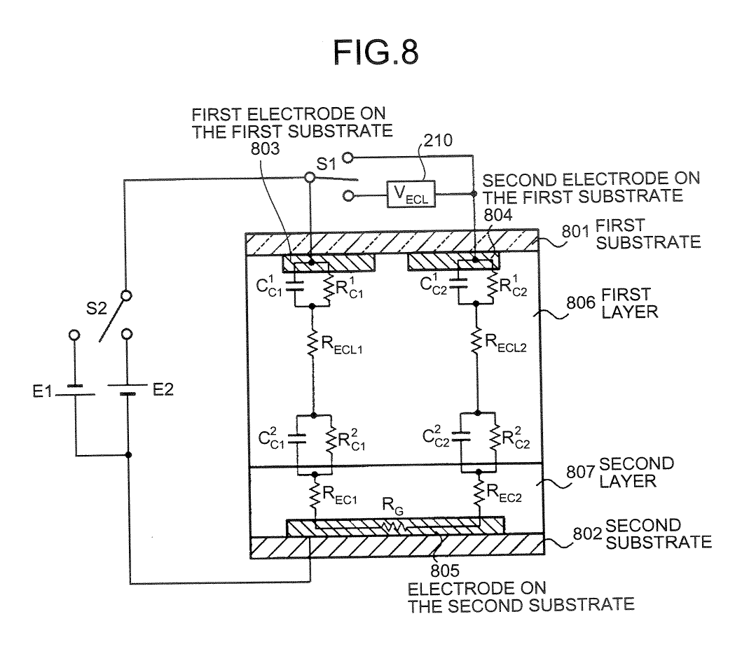

In the display apparatus in this embodiment, the configuration of the display element L_{i,j} of the pixel X_{i,j} is different from that in the first embodiment. FIG. 8 is a schematically sectional view showing one example of the configuration of the display element L_{i,j} to be a display cell of the pixel X_{i,j} in the display apparatus according to the second embodiment, where i=1 to n, j=1 to m, and n and m are positive integers.

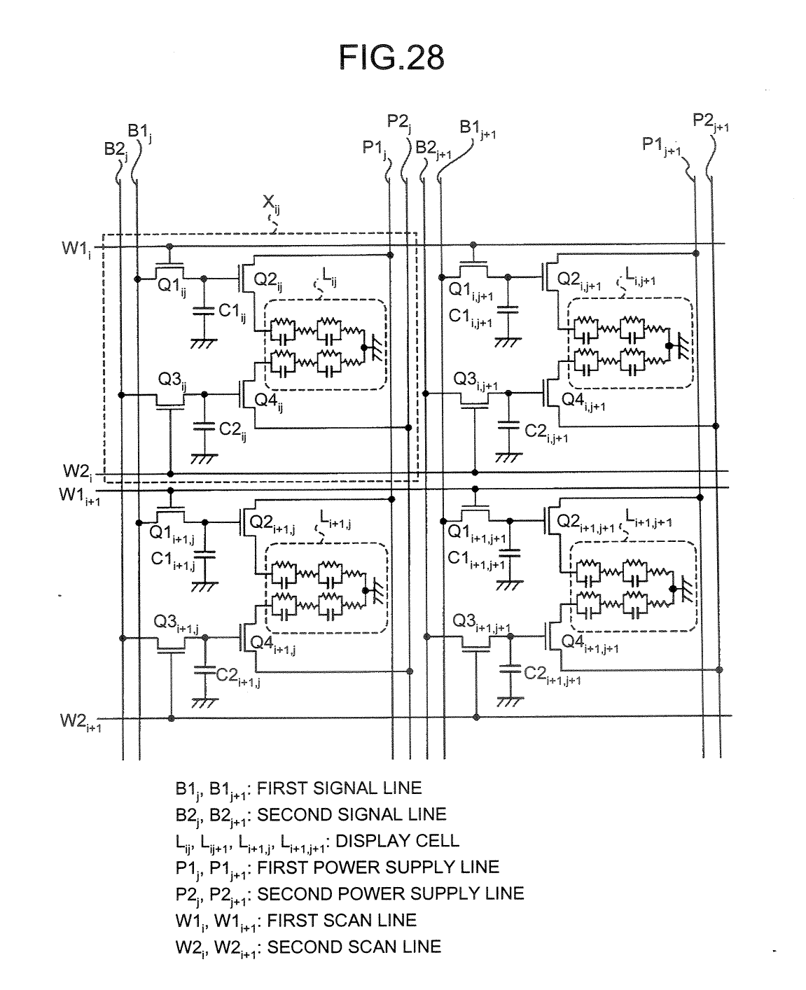

As shown in FIG. 8, each of the pixels X_{i,j} includes a first layer 806, a second layer 807, a first voltage applying unit (803, 804, V_{ECL}), a second voltage applying unit (803, 804, 805, E1, E2), and a switching unit (S1, S2). The first layer 806 includes an electrochemical luminescent material (ECL material). The second layer 807 is arranged so as to be opposed to at least a part of the first layer 806 and includes an electrochromic material. The first voltage applying unit applies a voltage to the first layer 806 so as to allow the electrochemical luminescent material to electrochemically emit light. The second voltage applying unit applies a voltage to the electrochromic material (EC material) so as to discolor the electrochromic material. The switching unit selectively operates the first voltage applying unit and the second voltage applying unit. That is, the display cell L_{i,j} of the pixel X_{i,j} has a first substrate 801, and a first electrode-on-first-substrate (electrode on the first ECL side) 803 and a second electrode-on-first-substrate (second electrode on the first ECL side) 804 which are electrically separated from each other are provided onto the first substrate 801. A second substrate 802 is provided so as to be opposed to and separated from the first substrate 801, and an electrode-on-second-substrate (electrode on the EC side) 805 is provided onto the second substrate 802. The first electrode-on-first-substrate 803 is connected to a second terminal of a first driving transistor Q2_{i,j} shown in FIG. 28, mentioned later, and the second electrode-on-first-substrate 804 is connected to a second terminal of a second driving transistor Q4_{i,j} shown in FIG. 28.

Similarly to the electrolyte solution layer of the display apparatus according to the first embodiment, the first layer 806 is a luminescent material. The luminescent material emits light when it is excited by migration and recombination of oxidant (radical cation) and reductant (radical anion) generated by electrochemical oxidation or reduction of the ECL material or another material due to the application of the voltage, and the luminescent material is deactivated. That is, the luminescent material is a material showing electrochemical luminescence (ECL). ECL means that when the ECL material or another material is oxidized near the electrode or an EC film so as to become radical cation or reduced so as to become radical anion by the application of a voltage, and both the radical cation and the radical anion associate with each other to disappear, the excited state of the ECL material is generated and the ECL material emits light at the deactivation process. In such a manner, the luminous display is performed.

The first layer 806 includes the ECL material and the electrolyte. Examples of the ECL material are tris(2,2′-bipyrazyl) ruthenium (II) [Ru(bpy)3]²⁺ as a chelate metal complex (ruthenium bipyridyl complex), a naphthacene derivative (rubrene expressed by a formula [II], 5,12-diphenyl naphthacene expressed by a formula [IV]), an anthracene derivative (9,10-diphenyl anthracene) expressed by a formula [III], a penthacene derivative (6,10-diphenyl penthacene) and a perifratin derivative (dibenzotetra (methylphenyl) perifratin) expressed by a formula [V] as a polyaromatic compound, a polyparaphenylenevinylene derivative, a polythiophene derivative, a polyparaphenylene derivative, and a polyfluorene derivative as pi-conjugated polymer, coumalin as a heteroaromatic compound, tris(2-phenylpyridine) isodium as an organic metal compound, and a chelate lanthanoid complex.

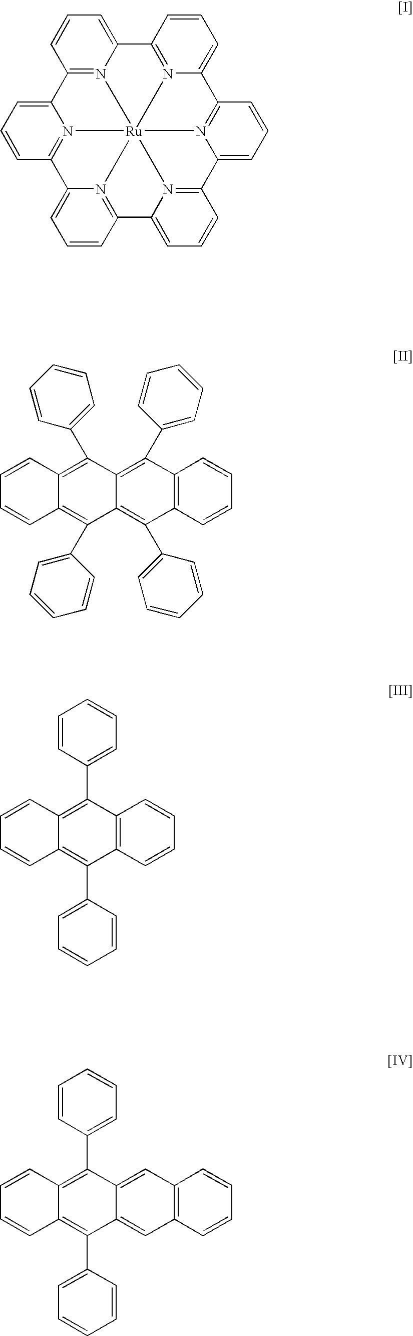

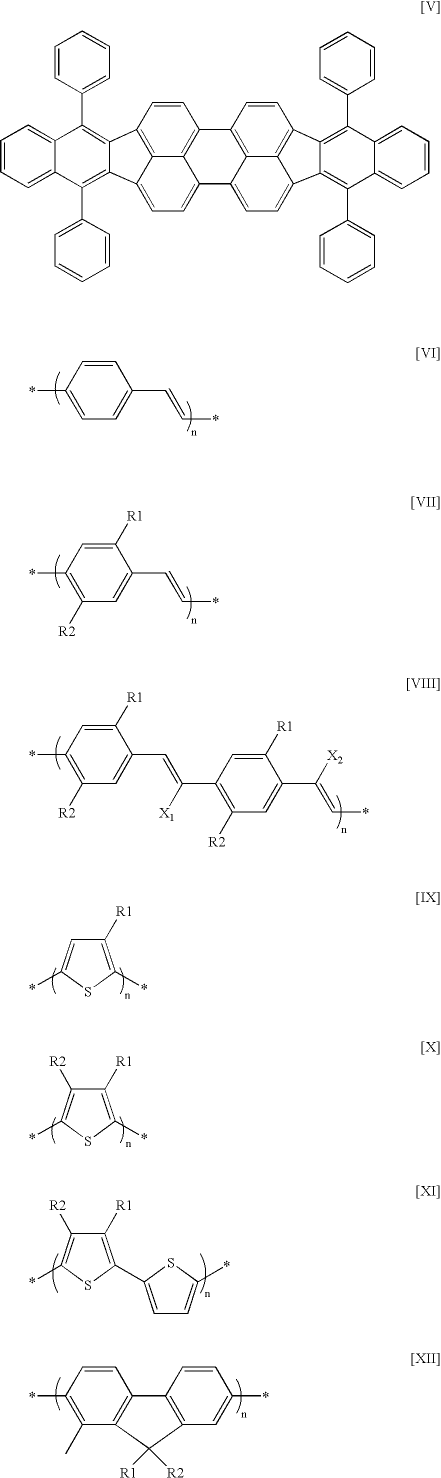

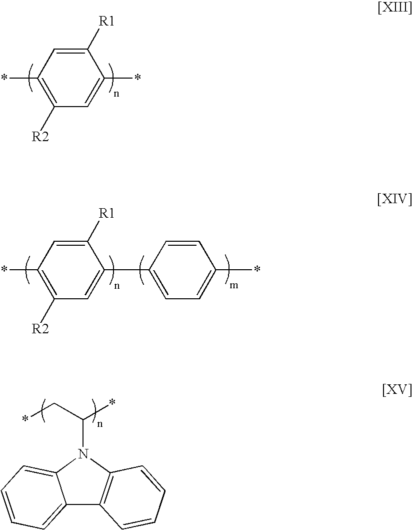

Examples of R1 and R2 in the formulas [VII] to [XIV] are an alkyl group, a cycloalkyl group, an alkoxy group, an alkoxyalkyl group, an alkoxyalkoxyalkyl group and an alkoxyalkoxyalkoxyalkyl group in which the number of hydrogens and carbons is up to 24, an aryl group, an aryloxy group and an aralkyl group where the number of carbons is 6 to 18.

The electrolyte has a solvent (when the first layer 806 is a liquid layer as the liquid electrolyte), or a gelled polymer which is swelled by the solvent (when the first layer 806 is a solid layer as a solid electrolyte), and a supporting electrolyte which dissolves in the polymer. Examples of the supporting electrolyte are tetrabutylammonium perchlorate, potassium hexafluorophosphate, lithium trifluoromethanesulfonate, lithium perchlorate, tetra-n-butylammonium tetrafluoroborate, tripropylamine, and tetra-n-butylammonium fluoroborate.

Examples of the solvent are a single solvent or a mixed solvent composed of acetonitrile, N,N-dimethylform-amide, propylene carbonate, o-dichlorobenzene, 1,2 dimethoxyethane, glycerin, water, ethyl alcohol, propyl alcohol, dimethyl carbonate, ethylene carbonate, γ-butyrollactone, N-methyl-2-pyrrolidone (NMP), 2-methyltetrahydrofuran, toluene, tetrahydrofuran, benzonitrile, cyclohexane, normal hexane, acetone, nitrobenzene, 1,3-dioxolane, furan, benzotrifluoride and the like.

Examples of the gelled polymer are a copolymer of polyacrylonitrile (PAN), vinylidene fluoride (VDF) and propylene hexafluoride (HEP), and a polyethylene oxide (PEO).

When the first layer 806 is the liquid layer, the supporting electrolyte and the ECL material may be dissolved in the solvent. They may be infused between the first substrate 801 and the second substrate 802. The first substrate 801 is formed with the first electrode-on-first-substrate 803 and the second electrode-on-first-substrate 804. The second substrate 802 is constituted so that an electrode-on-second-substrate 805 and a second layer 807 are laminated. When the first layer 806 is the solid layer, a solution of the gelled polymer including the supporting electrolyte and a solvent (the amount of the solvent is larger) may be applied and dried.

The second layer 807 includes a coloring material which is discolored due to electrochemical oxidation or reduction caused by the application of a voltage, namely, a material which shows an electrochromic (EC) phenomenon. In the EC phenomenon, the EC material is reduced so as to be colored or is bleached, or is oxidized so as to be bleached or colored. At this time, the electrolyte included in the first layer 806 or electrolyte including ion relating to the EC reaction of the EC material is fundamental to the EC reaction. For example, tungsten oxide (W₁O₃) as the EC material is bleached by the oxidation so as to be transparent, and it is colored by the reduction so as to be blue. Also the ion in the first layer (ECL, electrolyte layer) 806 including the ECL material relates to the EC (oxidation, reduction) reaction of the reflection display depending on the EC materials to be used. When a second layer (EC layer) 807 made of W₁O₃, for example, is used as the ECL material, the first layer (electrolyte layer) 806 including the ECL material contains Li⁺ (lithium salt complex (LiCF₃SO₃ or the like) as the supporting electrolyte). In this case, the EC reaction like formula (1) occurs.
W₁O₃+xe⁻+xLi⁺ [symbol] LixW₁O₃ (1)

In the oxidation shown by a left arrow in formula (1), the material is bleached (transparent), and in the reduction shown by a right arrow in formula (1), the material is colored (blue). Such a property of the EC phenomenon is utilized, so that the reflection display is performed. Examples of the EC material to be used for the second layer 807 are manganese oxide (MnO₂), cobalt oxyhydroxide (CoOOH), nickel oxyhydroxide (NiOOH), copper oxide (CuO), ruthenium oxide (RuO₂), rhodium oxide (Rh₂O₃), iridium oxide (IrOₓ), Prussian blue, tungsten oxide (W₁O₃), molybdenum oxide (MoO₃) titanic oxide (TiO₂), vanadium oxide (V₂O₅), niobium oxide (Nb₂O₅) and silver iodide (AgI) as organic materials.

Viologen organic materials as a low molecular organic material can be used as the EC material.

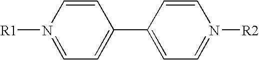

Another examples of the low-molecular organic material are orthochloranil, a 4-benzoyl pyridium derivative, ruthenium-tris, ruthenium-bis osmium-tris, an osmium-bis type transition metal complex (see formula [XVI]), a polynuclear complex, a ruthenium-cis-diaqua-bipyrisyl complex, phthalocyanine pigment, naphthalocyanine pigment, porphyrin pigment, perylene pigment, anthraquinone pigment, azo pigment, quinophthalone pigment, naphthoquinone pigment, cyanine pigment, merocyanine pigment, a diphthalocyanine complex, 2,4,5,7-tetranitro-9-fluorene, 2,4,7-nitriro-9-fluorenydeline malononitrile and tetra-cyanoquinodimethane. They can be used as the EC material.

Further, examples of the EC material are conductive polymer as expressed in formulas [XVII] to [XXIV], such as a polypyrrole derivative, a polythiophene derivative, a polyaniline derivative, a polyazulene derivative, polyisothianaphthene, poly(N-methylisoindole), poly (dithieno[3,4-b:3′,4′-d]thiophene), a polydiallylamine derivative, a polypyrrolopyrol derivative and an Ru complex type conductive polymer. The EC materials are, however, not limited to them.

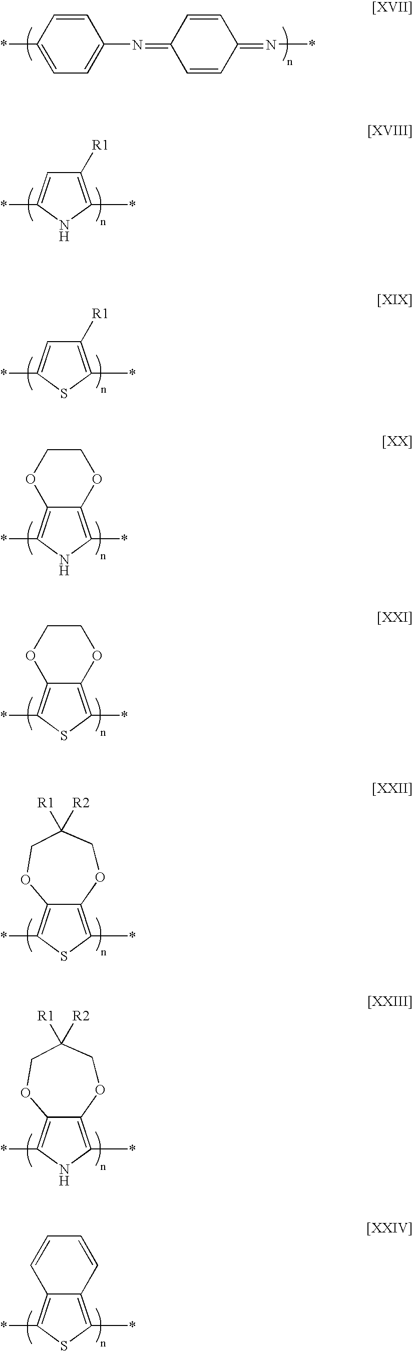

Examples of R1 and R2 in the formulas [XVI], [XVIII], [XIX], [XXII] and [XXIII] are an alkyl group, a cycloalkyl group, an alkoxy group, an alkoxyalkyl group, an alkoxyalkoxyalkyl group and an alkoxyalkoxyalkoxyalkyl group in which the number of hydrogens and carbons is up to 24, an aryl group, an aryloxy group and an aralkyl group where the number of carbons is 6 to 18.

When an inorganic material is used as the second layer 807, a film is deposited by vacuum evaporation, sputtering, vapor-phase growth, a solgel method, fine particle sintering or applying and drying a polyacid perioxide solution as a precursor. Further, when the low-molecular organic material is used, it is vacuum-evaporated, or is applied and dried (be soluble). The conductive polymer is applied and dried (be soluble) or is subject to electrolytic polymerization. As a result, a solid layer can be formed.

An equivalent circuit in accordance with the configuration of the display element L_{i,j} to be the display cell of the pixel X_{i,j} in the display apparatus of the second embodiment shown in FIG. 8 is explained below. In FIG. 8, on an interface between the first electrode-on-first-substrate 803 and the first layer (electrolyte layer) 806, a parallel circuit composed of an interface resistor R¹c₁ and an interface capacitor C¹c₁, which shows interface impedance of an ion moving process on the interface is provided. Similarly, on an interface between the second electrode-on-first-substrate 804 and the first layer (electrolyte layer) 806, a parallel circuit composed of an interface resistor R¹c₂ and an interface capacitor C¹c₂, which shows interface impedance of the ion moving process on the interface is provided. The interface impedance of the first electrode-on-first-substrate 803 and the second electrode on the first substrate shown in FIGS. 8 to 11 causes the oxidation and reduction of a host lattice in the first electrode-on-first-substrate 803 and the second electrode-on-first-substrate 804, namely, exchange of electrons between the host lattice and the first layer (electrolyte layer) 806, and the movement of the electrons for propagating the oxidation and reduction in the host lattice. Therefore, it is considered that the progress of the reaction of the display cell L_{i,j} represents respective reaction steps including movement of Li⁺ across the interface, rearrangement of the host lattices and their propagation, the movement of the electrons in the host lattices, and movement of Li⁺ on the interface as expressed by formula (1).

A resistor R_{ECL1} to be connected to the parallel circuit composed of the interface resistor R¹c₁ and the interface capacitor C¹c₁ shows a resistance component in the first layer (electrolyte layer) 806, and a resistor R_{ECL2} to be connected to the parallel circuit composed of the interface resistor R¹c₂ and also the interface capacitor C¹c₂ shows a resistance component in the first layer (electrolyte layer) 806.

A parallel circuit composed of an interface resistor R²c₁ and an interface capacitor C²c₁ connected to the resistor R_{ECL1} shows interface impedance of the ion moving process on the interface between the first layer (electrolyte layer) 806 and the second layer (EC layer) 807. Similarly, a parallel circuit composed of an interface resistor R²c₂ and an interface capacitor C²c₂ connected to the resistor R_{ECL2} also shows interface impedance of the ion moving process on the interface between the first layer (electrolyte layer) 806 and the second layer (EC layer) 807.

A resistor R_{EC1} to be connected to the parallel circuit composed of the interface resistor R²c₁ and the interface capacitor C²c₁ shows a resistance component in the second layer (EC layer) 807, and a resistor R_{EC2} to be connected to the parallel circuit composed of the interface resistor R²c₂ and the interface capacitor C²c₂ also shows a resistance component in the second layer (EC layer) 807. A resistor R_{G} which connects the resistor R_{EC1} and the resistor R_{EC2} shows a resistance of the electrode-on-second-substrate 805.

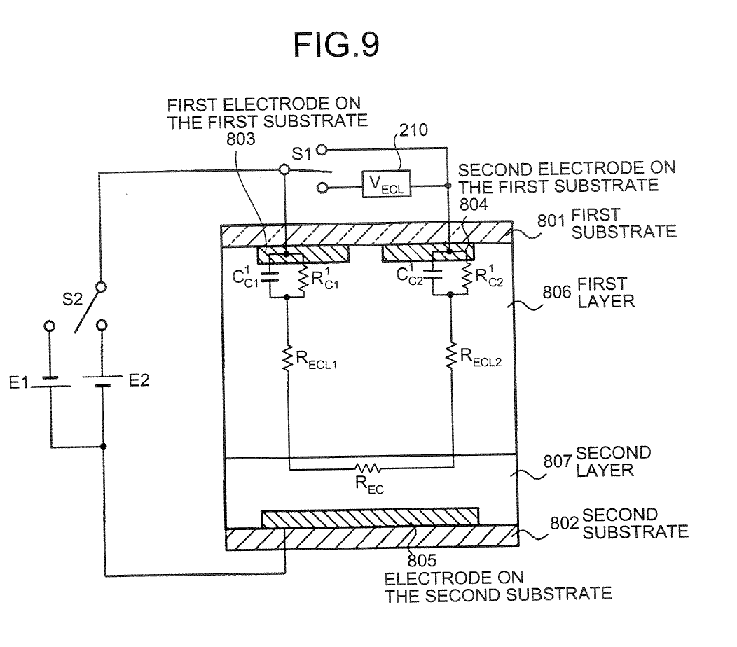

In FIG. 9, the parallel circuit composed of the interface resistor R²c₁ and the interface capacitor C²c₁ connected to the resistor R_{ECL1} and the parallel circuit composed of the interface resistor R²c₂ and the interface capacitor C²c₂ connected to the R_{ECL2} shown in FIG. 8 are omitted, and a resistance component R_{EC} in the second layer (EC layer) 807 is simply shown. It is considered that the luminous display is performed by causing the ECL reaction in the equivalent circuit of FIG. 8 and the ECL reaction in the equivalent reaction of FIG. 9 in a concerted manner. A determination is made which reaction is dominant by components.

In the display apparatus according to the second embodiment, similarly to the first embodiment, the first electrode-on-first-substrate 803 and the second electrode-on-first-substrate 804 are connected to an AC power supply circuit V_{ECL} 210 via a switching element S1, which composes the first voltage applying unit (803, 804, V_{ECL} 210) as shown in FIGS. 8 and 9.

The AC power supply circuit V_{ECL} 210 has the similar configuration to that of the power supply circuit 210 in the first embodiment, and thus is composed of the counter voltage generating circuit 211, the signal voltage generating circuit 212, the variable resistor 213 and the switching element 214. It is a power supply circuit that applies an AC voltage between the first electrode-on-first-substrate 803 and the second electrode-on-first-substrate 804 so that the voltage waveform becomes trapezoid as shown in FIG. 4.

Specifically, the counter voltage generating circuit 211 is connected to the first electrode-on-first-substrate 803, and the signal voltage generating circuit 212 is connected to the second electrode-on-first-substrate 804 via the variable resistor 213 and the switching element 214. Similarly to the first embodiment, when the AC voltage generated from the signal voltage generating circuit 212 is applied to the second electrode-on-first-substrate 804, the AC voltage passes through the variable resistor 213, so that while the voltage value is being gradually increased for a first period, the voltage is allowed to reach a predetermined voltage value at the time when the first period elapses. The predetermined voltage is maintained for a second period starting from the elapse of the first period. While the voltage is being gradually reduced for a third period starting from the elapse of the second period, the voltage is applied so that the voltage obtains a trapezoidal waveform where the value becomes 0 after elapse of constant period of time. Such application of the voltage is repeated so that the trapezoidal waveform where the polarity differs alternately is obtained. In such a manner, the AC voltage of trapezoidal waveform is applied.

In the AC power supply circuit V_{ECL} 210, the AC voltage is applied between the first electrode-on-first-substrate 803 and the second electrode-on-first-substrate 804 by the switching operation of the variable resistor 213 and the switching element 214 repeatedly per constant cycle so that the voltage waveform for one cycle becomes trapezoid as shown in FIG. 4.

In the AC power supply circuit V_{ECL} 210 according to this embodiment, the counter voltage generating circuit 211 is connected to the first electrode-on-first-substrate 803, and the signal voltage generating circuit 212 is connected to the second electrode-on-first-substrate 804 via the variable resistor 213 and the switching element 214. On the contrary, however, the counter voltage generating circuit 211 may be connected to the second electrode-on-first-substrate 804, and the signal voltage generating circuit 212 may be connected to the first electrode-on-first-substrate 803 via the variable resistor 213 and the switching element 214.

In this embodiment, the variable resistor 213 is used in the AC power supply circuit V_{ECL} 210 so that the voltage waveform becomes trapezoid. Instead of the variable resistor 213, another circuit such as the low pass filter 313 shown in FIG. 2 may be used so that the voltage waveform becomes trapezoid.

The display element L_{i,j} shown in FIGS. 8 and 9 has the configuration when the inside state of the pixel X_{i,j} is observed from the first substrate 801 side. The first substrate 801 is made of a transparent material, and the first electrode-on-first-substrate 803 and the second electrode-on-first-substrate 804 are preferably made of an approximately transparent material.

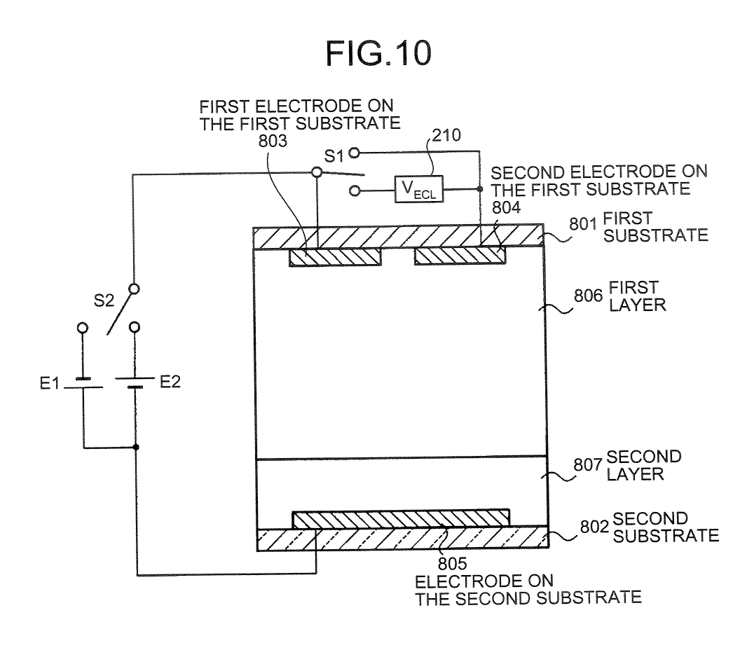

On the contrary, the display element L_{i,j} shown in FIG. 10 has the configuration when the inside state of the pixel X_{i,j} is observed from the second substrate 802 side. The second substrate 802 and the electrode-on-second-substrate 805 are made of a transparent material, and the first electrode-on-first-substrate 803 and the second electrode-on-first-substrate 804 or the first substrate 801 function as a reflection layer, or a reflection layer is separately provided. Since the first substrate 801 is normally a portion to be an observation surface of the display apparatus, the first substrate 801 is formed by an optically-transparent material. As such an optically-transparent material, materials where absorption is less in the visible light region, such as inorganic material such as glass and organic material such as optically-transparent resin are preferable. Concrete examples are polyethylene terephthalate (PET), polyethylene naphthalate (PEN), polyether sulfon (PES), and polycarbonate (PC). The second substrate 802 does not require the optically-transparent property, but it is generally made of the similar material to the first substrate 801. The other part of the configuration other than such a material is similar to the display element L_{i,j} shown in FIG. 9.

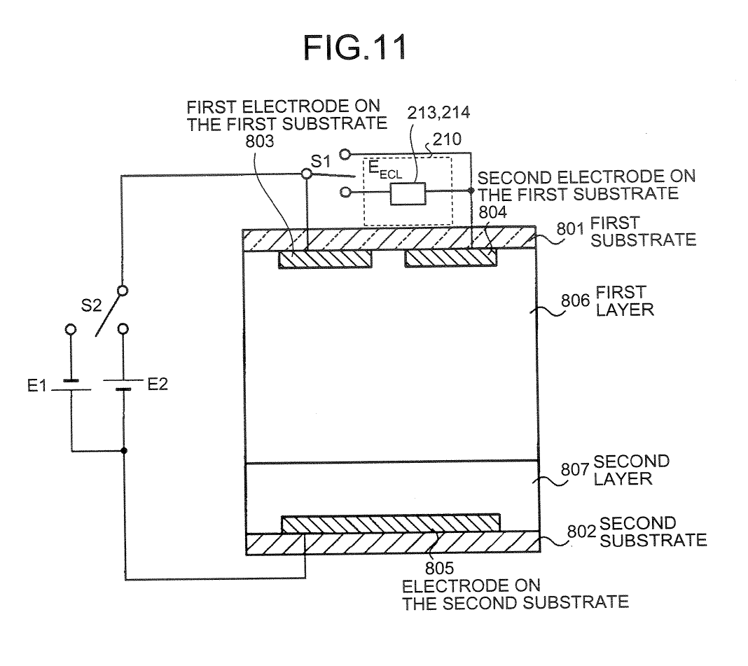

As shown in FIG. 11, the DC power supply circuit 210 composed of the counter voltage generating circuit 211 and the signal voltage generating circuit 212 may be connected so that a DC voltage is applied between the first electrode-on-first-substrate 803 and the second electrode-on-first-substrate 804. The DC power supply circuit 210 has the similar configuration to that of the power supply circuit 210 in the first embodiment. The circuit 210 is composed of DC power supply E_{ECL} including the counter voltage generating circuit 211 and the signal voltage generating circuit 212, the variable resistor 213 and the switching element 214. It applies a DC voltage between the first electrode-on-first-substrate 803 and the second electrode-on-first-substrate 804 so that the voltage waveform becomes trapezoid as shown in FIG. 5.

More specifically, the counter voltage generating circuit 211 is connected to the first electrode-on-first-substrate 803, and the signal voltage generating circuit 212 is connected to the second electrode-on-first-substrate 804 via the variable resistor 213 and the switching element 214. Similarly to the first embodiment, when the DC voltage generated from the signal voltage generating circuit 212 is applied to the second electrode-on-first-substrate 804, the voltage passes through the variable resistor 213. As a result, while the voltage value is being gradually increased for the first period, the voltage is allowed to reach a predetermined voltage value at the time when the first period elapses. The predetermined voltage is maintained for the second period starting from the elapse of the first period, and while the voltage value is being gradually reduced for the third period starting from the elapse of the second period, the voltage is applied so as to have a trapezoidal waveform where the value becomes 0 after elapse of constant period of time. Such application is repeated without changing polarity, so that the DC voltage with a trapezoid waveform is applied.

In the DC power supply circuit 210, the DC voltage is applied between the first electrode-on-first-substrate 803 and the second electrode-on-first-substrate 804 by the switching operation of the variable resistor 213 and the switching element 214 repeatedly per constant cycle so that the voltage waveform for one cycle becomes trapezoid as shown in FIG. 5.

In the display apparatus according to the second embodiment, the display element shown in FIGS. 8 and 9 is used so that a user can select the luminous display or the reflection display. That is, the user can selectively instruct any one display according to the usage environment. The AC power supply circuit V_{ECL} 210 (or the DC power supply circuit 210) and the DC power supplies E1 and E2 with different polarities are switched according to the switch instruction information. As a result, a predetermined voltage is applied to the first electrode-on-first-substrate 803, the second electrode-on-first-substrate 804 and the electrode-on-second-substrate 805, so that the inside state of the pixel X_{i,j} is displayed by the luminous display or the reflection display.

In the display apparatus according to the second embodiment, the AC power supply circuit V_{ECL} 210 and the DC power supply circuit 210 repeat the application of the voltage with trapezoidal waveform to the display element. As a result, the light emission with high luminance by the display element can be maintained for a longer period of time in comparison with the case where the voltage with rectangular waveform is applied like the conventional display apparatuses.

A third embodiment is explained below.

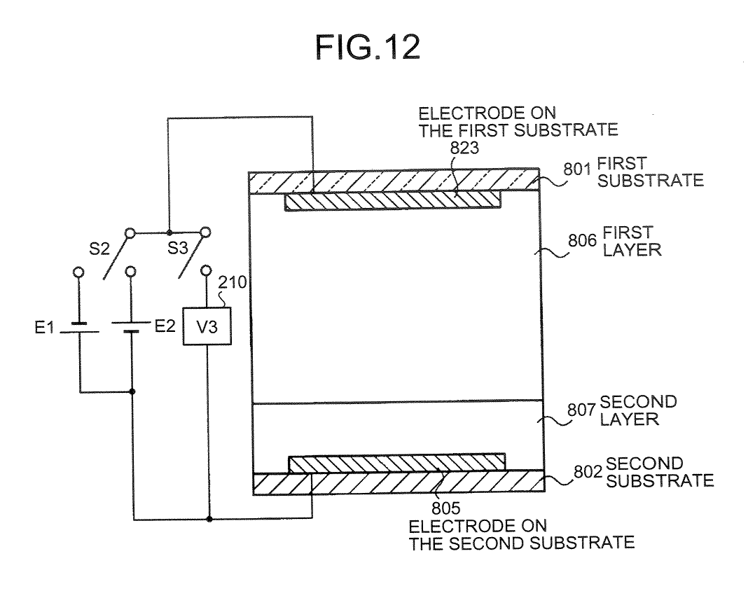

In the display apparatus of the second embodiment, the two electrodes on the first substrate side are provided onto the first substrate 801, but in the display apparatus according to the third embodiment, a single electrode on the first substrate side is provided onto the first substrate 801 as shown in FIG. 12.

FIG. 12 is a sectional view schematically showing a configuration of the display element L_{i,j} to be the display cell in the display apparatus according to the third embodiment. Only a part of the display apparatus in the third embodiment which is different from the second embodiment is explained, and the like parts are designated by like reference numerals, and their explanation is not repeated.

The reflection/luminous display realized by the display element L_{i,j} in the first embodiment can be switched by a difference in an effective voltage (electric potential) and a reaction speed necessary for the ECL reaction and the EC reaction. On the contrary, in the display apparatus according to the third embodiment, only an electrode-on-first substrate 823 is provided onto the first substrate 801 as shown in FIG. 12.

In the display apparatus according to the third embodiment, the electrode-on-first-substrate (electrode on the ECL side) 823 and the electrode-on-second-substrate (electrode on the EC side) 805 are connected to the AC power supply circuit V3 via the switching element S3 as shown in FIG. 12. They compose the first voltage applying unit (823, 805, V3). The electrode-on-first-substrate 823 and the electrode-on-second-substrate 805 are connected to the DC power supplies E1 and E2 with different polarities via the switching element S2. They compose the second voltage applying unit (823, 805, E1, E2).

The switching elements S3 and S2 selectively operate the first voltage applying unit (823, 805, V3, 210) and the second voltage applying unit (823, 805, E1, E2).

In the configuration shown in FIG. 12, when the switching element S2 is opened, the switching element S3 is closed, and an AC voltage is applied between the electrode-on-first-substrate 823 and the electrode-on-second-substrate 805 at a frequency which the EC reaction cannot follow. In the luminous display, light emission can be observed in the first layer 806.

In the reflection display, the switching element S2 is closed, the switching element S3 is opened, and the DC power supplies E1 and E2 with different polarities is connected between the electrode-on-first-substrate 823 and the electrode-on-second-substrate 805. A voltage (electric potential) for causing the EC reaction is applied therebetween, and coloring and bleaching are observed in the second layer 807. When the polarities of the applied voltages from the DC power supplies E1 and E2 are changed, the color of the second layer 807 becomes transparent, or the transparent second layer 807 is colored. As a result, a background color or the coloring is observed from the first substrate 801 side. At the time of driving the reflection display, an electric double layer is formed on the interface between the ECL and electrolyte layer and EC layer in the second layer 807/first layer 806. As a result, ions come in and out of the second layer 807 via the first layer 806, and also the ECL material occasionally oxidized and reduced (possibly, malfunction in the luminous display). However, a voltage (electric potential) and an electric current which are suitable for the EC reaction are controlled by dropping the effective voltage (electric potential) of the second layer 807 or the like, so that satisfactory reflection display can be performed.

In this embodiment, similarly to the first embodiment, when the AC voltage generated from the signal voltage generating circuit 212 is applied to the electrode-on-first-substrate 823, the voltage passes through the variable resistor 213. As a result, while the voltage value is gradually increased for the first period (t1) shown in FIG. 4, the voltage is allowed to obtain a predetermined voltage value at the time when the first period elapses. The predetermined voltage is maintained for the second period (t2) starting from the elapse of the first period, and while the voltage value is being gradually reduced for the third period (t3) starting from the elapse of the second period, the voltage is applied so that the voltage has a trapezoidal waveform where the value becomes 0 after the elapse of a constant period of time. Such application is repeated so that the voltage has the trapezoidal waveform where polarities differ alternately. In such a manner, the AC voltage of the trapezoid waveform is applied.

In the AC power supply circuit V3 210, the AC voltage is applied between the electrode-on-first-substrate 823 and the electrode-on-second-substrate 805 by the switching operation of the variable resistor 213 and the switching element 214 repeatedly per constant cycle so that the voltage waveform for one cycle becomes trapezoid as shown in FIG. 4.

In the AC power supply circuit V3 210 of this embodiment, the counter voltage generating circuit 211 is connected to the electrode-on-second-substrate 805, and the signal voltage generating circuit 212 is connected to the electrode-on-first substrate 823 via the variable resistor 213 and the switching element 214. On the contrary, the counter voltage generating circuit 211 may be connected to the electrode-on-first substrate 823, and the signal voltage generating circuit 212 may be connected to the electrode-on-second-substrate 805 via the variable resistor 213 and the switching element 214.

In this embodiment, the variable resistor 213 is used in the AC power supply circuit V3 210 so that the voltage waveform becomes trapezoid. Instead of the variable resistor 213, however, another circuit such as the low pass filter 313 shown in FIG. 2 may be used so that the voltage waveform becomes trapezoid.

Further, in this embodiment, the AC power supply circuit V3 210 applies the AC voltage between the electrode-on-first substrate 823 and the electrode-on-second-substrate 805. However, the counter voltage generating circuit 211 and the signal voltage generating circuit 212 may be constituted so that a DC voltage with trapezoidal waveform shown in FIG. 5 is applied between the electrode-on-first substrate 823 and the electrode-on-second-substrate 805.

According to the display apparatus according to the third embodiment, the reflection and luminous display can be realized by the simpler configuration in comparison with the second embodiment.

In the display apparatus according to the third embodiment, the AC power supply circuit V3 210 repeatedly applies the voltage with trapezoidal waveform to the display element. As a result, the light emission with high luminance by the display element can be maintained for a longer period of time in comparison with the case where the voltage with rectangular waveform is applied like the conventional display apparatuses.

A fourth embodiment is explained below.

The display apparatus according to the fourth embodiment in the configuration of the display element further includes an intermediate electrode and an electrolyte layer. In the display apparatus according to this embodiment, the configuration of the display element L_{i,j} in the pixel X_{i,j} is different from the configuration in the first embodiment.

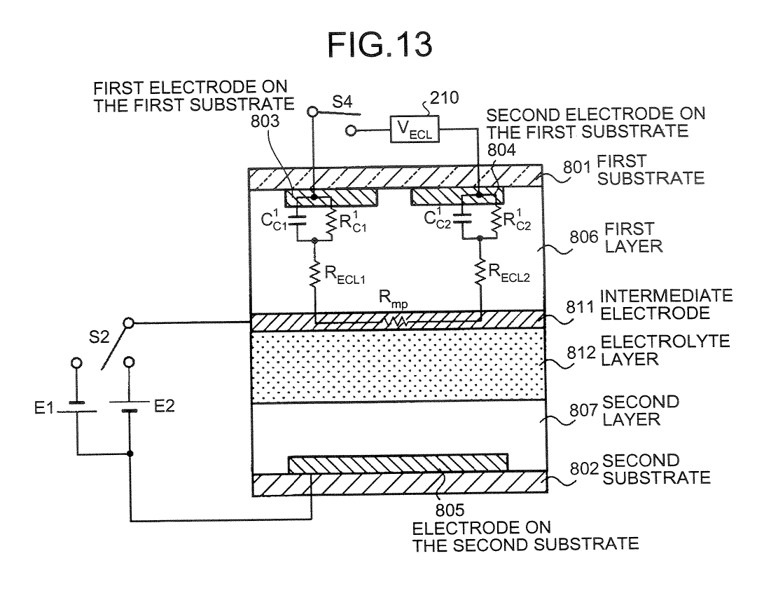

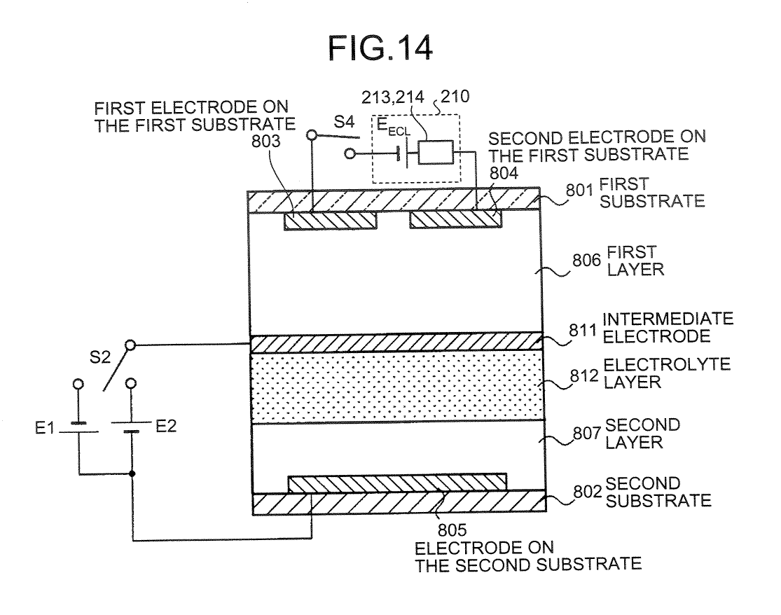

FIGS. 13 and 14 are sectional views schematically showing the display element L_{i,j} to be the pixel X_{i,j} in the display apparatus according to the fourth embodiment. Only portions of the display apparatus according to the fourth embodiment which are different from the second embodiment are explains, and like portions are designated by like reference numerals, and the explanation thereof is not repeated.

As shown in FIGS. 13 and 14, in the display element L_{i,j} of the display apparatus according to the fourth embodiment, transparent intermediate electrode 811 and electrolyte layer 812 are provided between the second layer 807 and the first layer 806. The intermediate electrode 811 is normally made of an optically-transparent material so that display can be observed. Examples of the optically-transparent material are oxide of transition metal such as (compound) oxide of titanium (Ti), zirconium (Zr), hafnium (Hf), strontium (Sr), zinc (Zn), tin (Sn), indium (In), yttrium (Y), lanthanum (La), vanadium (V), niobium (Nb), tantalum (Ta), chromium (Cr), molybdenum (Mo) and tungsten (W) as metal oxide semiconductor, perovskite such as SrTiO₃, CaTiO₃, BlaTiO₃, MgTiO₃ and SrNb₂O₆, compound oxide and oxide mixture of them, and gallium nitride (GaN). Examples of the transparent electrode to be frequently used are an oxide indium (In₂O₃) film (ITO) where tin (Sn) is doped, an oxide zinc (ZnO) film (IZO) where indium (In) is doped, an oxide zinc film (GZO) where gallium (Ga) is doped, and an oxide zinc film (FTO) where oxide tin (SnO₂) and fluorine for acid resistance are doped.

The material of the electrolyte layer 812 includes a solvent (when the first layer 806 is a liquid layer as the liquid electrolyte) or a gelled polymer which is swelled by this solvent (when the first layer 806 is a solid layer as a solid electrolyte) and a supporting electrolyte which is dissolved with the solvent or the polymer. Examples of the supporting electrolyte are tetrabutylammonium perchlorate, potassium hexafluorophosphate, lithium trifluoromethanesulfonate, lithium perchlorate, tetra-n-butylammonium tetrafluoroborate, tripropyl amine, and tetra-n-butylammonium fluoroborate.

Examples of the solvent are single solvent or mixed solvent composed of acetonitrile, N,N-dimethylformamide, propylene carbonate, o-dichlorobenzene, 1,2dimethoxyethane, glycerin, water, ethyl alcohol, propyl alcohol, dimethyl carbonate, ethylene carbonate, γ-butylolactone, N-methyl-2-pyrrolidone (NMP), 2-methyltetrahydrofuran, toluene, tetrahydrofuran, benzonitrile, cyclohexane, n-hexane, acetone, nitrobenzene, 1.3-dioxolan, furan, benzotrifuloride and the like.

Examples of the gelled polymer are a copolymer of polyacrylonitrile (PAN), vinylidene fluoride (VDF) and vinylidene hexafluoride (HFP), and polyethylene oxide (PEO).

The luminous display is preformed by applying an AC voltage between the first electrode-on-first-substrate (first electrode on the ECL side) 803 and the second electrode-on-first-substrate (second electrode on the ECL side) 804.

In the display apparatus according to the fourth embodiment, the first electrode-on-first-substrate 803 and the second electrode on the first electrode side 804 are connected to the AC power supply circuit V_{ECL} 210 via the switching element S4 as shown in FIG. 13. They compose the first voltage applying unit (803, 803, V_{ECL} 210). The switching elements S4 and S2 selectively operate the first voltage applying unit (803, 804, V_{ECL} 210) and the second voltage applying unit (811, 805, E1, E2).

In the configuration shown in FIG. 13, in the luminous display, the switching element S2 is opened, the intermediate electrode 811 and the electrode-on-second-substrate (electrode on the EC side) 805 are disconnected from the DC power supplies E1 and E2. Further, the switching element S4 is closed, and the first electrode-on-first-substrate 803 and the second electrode-on-first-substrate 804 are connected to the AC power supply circuit V_{ECL} 210. An AC voltage is, therefore, generated between the first electrode-on-first-substrate 803 and the second electrode-on-first-substrate 804 (via the intermediate electrode 811). The first layer 806 including the luminescent material emits light due to the voltage, and luminous color is observed. If a color filter is provided onto the first substrate 801 of the pixel X_{i,j}, the filter color is observed from the first substrate 801 side. When the application of the voltage from the AC power supply circuit V_{ECL} 210 is stopped, the first layer 806 does not emit light, and a background color of the pixel X_{i,j}, for example, black is displayed.

The AC power supply circuit V_{ECL} 210 has the configuration similar to that of the power supply circuit 210 in the first embodiment. The circuit V_{ECL} 210 is composed of the counter voltage generating circuit 211, the signal voltage generating circuit 212, the variable resistor 213 and the switching element 214. It is a power supply circuit that applies an AC voltage between the first electrode-on-first-substrate 803 and the second electrode-on-first-substrate 804 so that the voltage has a trapezoidal waveform shown in FIG. 4.

More specifically, the counter voltage generating circuit 211 is connected to the first electrode-on-first-substrate 803, and the signal voltage generating circuit 212 is connected to the second electrode-on-first-substrate 804 via the variable resistor 213 and the switching element 214. Similarly to the first embodiment, when the AC voltage generated from the signal voltage generating circuit 212 is applied to the second electrode-on-first-substrate 804, the voltage passes through the variable resistor 213. As a result, while the voltage value is being gradually increased for the first period (t1) shown in FIG. 4, the voltage is allowed to obtain a predetermined voltage value at the time when the first period elapses. The predetermined voltage is maintained for the second period (t2) starting from the elapse of the first period, and while the voltage value is being gradually reduced for the third period (t3) starting from the elapse of the second period, the voltage is applied so as to have a trapezoidal waveform where the value becomes 0 after the constant period of time elapses. Such application is repeated so that the voltage has the trapezoidal waveform where polarities differ alternately. As a result, the AC voltage with trapezoid wave is applied.

In the AC power supply circuit V_{ECL} 210, the AC voltage is applied between the first electrode-on-first-substrate 803 and the second electrode-on-first-substrate 804 repeatedly per constant cycle by the switching operation of the variable resistor 213 and the switching element 214 so that the voltage waveform for one cycle becomes trapezoid as shown in FIG. 4.

In the AC power supply circuit V_{ECL} 210 of this embodiment, the counter voltage generating circuit 211 is connected to the first electrode-on-first-substrate 803, and the signal voltage generating circuit 212 is connected to the second electrode-on-first-substrate 804 via the variable resistor 213 and the switching element 214. On the contrary, however, the counter voltage generating circuit 211 may be connected to the second electrode-on-first-substrate 804, and the signal voltage generating circuit 212 may be connected to the first electrode-on-first-substrate 803 via the variable resistor 213 and the switching element 214.

In this embodiment, the variable resistor 213 is used in the AC power supply circuit 210 so that the voltage waveform becomes trapezoid. Instead of the variable resistor 213, however, another circuit such as the low pass filter 313 shown in FIG. 2 may be used, so that the voltage waveform becomes trapezoid.

In this embodiment, the AC power supply circuit V_{ECL} 210 applies the AC voltage between the first electrode-on-first-substrate 803 and the second electrode-on-first-substrate 804. As shown in FIG. 14, however, the DC power supply circuit 210 may be composed of the counter voltage generating circuit 211 and the signal voltage generating circuit 212 so as to apply the DC voltage with trapezoidal waveform shown in FIG. 5 between the first electrode-on-first-substrate 803 and the second electrode-on-first-substrate 804. The DC power supply circuit 210 has the similar configuration to that of the power supply circuit 210 in the first embodiment, and is composed of the DC power supply E_{ECL} including the counter voltage generating circuit 211 and the signal voltage generating circuit 212, the variable resistor 213, and the switching element 214. it is a power supply circuit that applies the DC voltage between the first electrode-on-first-substrate 803 and the second electrode on the first electrode side 804 so that the voltage waveform becomes trapezoid.

More specifically, the counter voltage generating circuit 211 is connected to the first electrode-on-first-substrate 803, and the signal voltage generating circuit 212 is connected to the second electrode-on-first-substrate 804 via the variable resistor 213 and the switching element 214. Similarly to the first embodiment, when the DC voltage generated from the signal voltage generating circuit 212 is applied to the second electrode-on-first-substrate 804, the voltage passes through the variable resistor 213. While the voltage value is being gradually increased for the first period, the voltage is allowed to obtain a predetermined voltage value at the time when the first period elapses. The predetermined voltage is maintained for the second period starting from the elapse of the first period, and while the voltage value is being gradually decreased for the third period starting from the elapse of the second period, the voltage is applied so as to obtain a trapezoidal waveform where the value becomes 0 after a constant period of time elapses. Such application is repeated without changing polarity, so that the DC voltage of trapezoid wave is applied.

In the DC power supply circuit 210, the DC voltage is applied between the first electrode-on-first-substrate 803 and the second electrode-on-first-substrate 804 by the switching operation of the variable resistor 213 and the switching element 214 repeatedly per constant cycle as shown in FIG. 5 so that the voltage waveform for one cycle becomes trapezoid.

In the DC power supply circuit 210 of this embodiment, the counter voltage generating circuit 211 is connected to the first electrode-on-first-substrate 803, and the signal voltage generating circuit 212 is connected to the second electrode-on-first-substrate 804 via the variable resistor 213 and the switching element 214. On the contrary, however, the counter voltage generating circuit 211 may be connected to the second electrode-on-first-substrate 804, and the signal voltage generating circuit 212 may be connected to the first electrode-on-first-substrate 803 via the variable resistor 213 and the switching element 214.

In this embodiment, the variable resistor 213 is used in the DC power supply circuit 210, so that the voltage waveform becomes trapezoid. Instead of the variable resistor 213, however, another circuit such as the low pass filter 313 shown in FIG. 2 may be used so that the voltage waveform may be trapezoid.

In the luminous display of FIG. 14, the switching element S12 is opened, and the intermediate electrode 811 and the electrode-on-second-substrate 805 are disconnected from the DC power supplies E1 and E2. Further, the switching element S4 is closed, and the first electrode-on-first-substrate 803 and the second electrode-on-first-substrate 804 are connected to the DC power supply circuit 210. A DC voltage is, therefore, generated between the first electrode-on-first-substrate 803 and the second electrode-on-first-substrate 804 (via the intermediate electrode 811). The first layer 806 including the luminescent material emits lie due to the voltage, and luminous color is observed. Similarly to FIG. 13, if a color filter is provided onto the first substrate 801 of the pixel X_{i,j}, the filter color is observed from the first substrate 801 side. When the application of the voltage from the DC power supply circuit 210 is stopped, the first layer 806 does not emit light, and thus the background color of the pixel X_{i,j}, for example, black is displayed.

In the reflection display, the switching element S2 is closed, and the intermediate electrode 811 and the electrode-on-second-substrate 805 are connected to any of the DC power supplies E1 and E2 with different polarities, respectively. Therefore, the DC voltage is generated between the intermediate electrode 811 and the electrode-on-second-substrate 805, and the second layer 807 including the material showing the EC phenomenon is colored or becomes transparent. As a result, the second substrate 802 is observed as a background color via the colored second layer 807 or the transparent second layer 807 from the outside of the first substrate 801. When the polarities of the applied voltages from the DC power supplies E1 and E2 are changed, the colored second layer 807 becomes transparent or the transparent second layer 807 is colored. As a result, the background color or the color of the second layer 807 is observed from the first substrate 801 side.

According to the display apparatus in the fourth embodiment, the reflection display unit and the luminous display unit become independent systems, and thus malfunction hardly occurs.

In the display apparatus according to the fourth embodiment, when the AC power supply circuit V_{ECL} 210 or the DC power supply circuit 210 repeat the application of the voltage of trapezoidal waveform to the display element, the light emission with high luminance can be maintained for a longer period of time in comparison with the case where a voltage with rectangular waveform is applied like conventional display apparatuses.

A fifth embodiment is explained below.

In the display apparatus according to the fourth embodiment, the two electrodes on the first substrate side are formed on the first substrates 801, but in the display apparatus according to the fifth embodiment, a single electrode on the first substrate side is provided onto the first substrate 801.

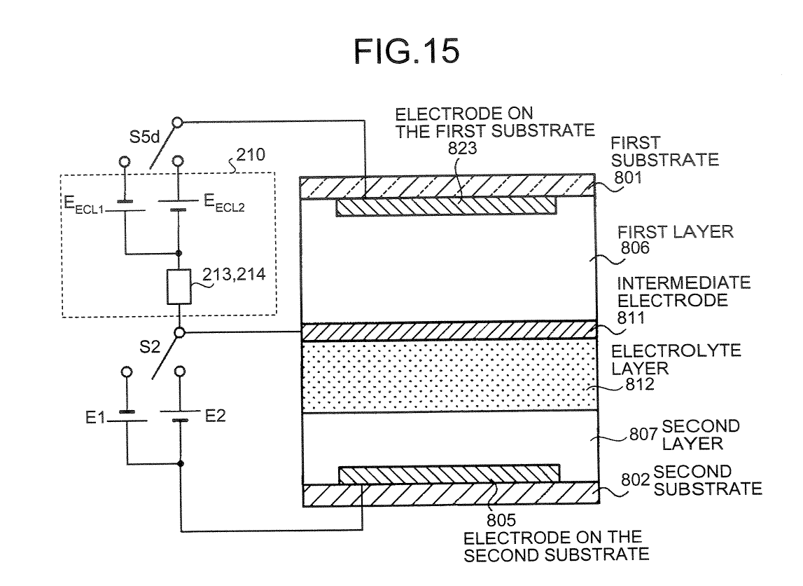

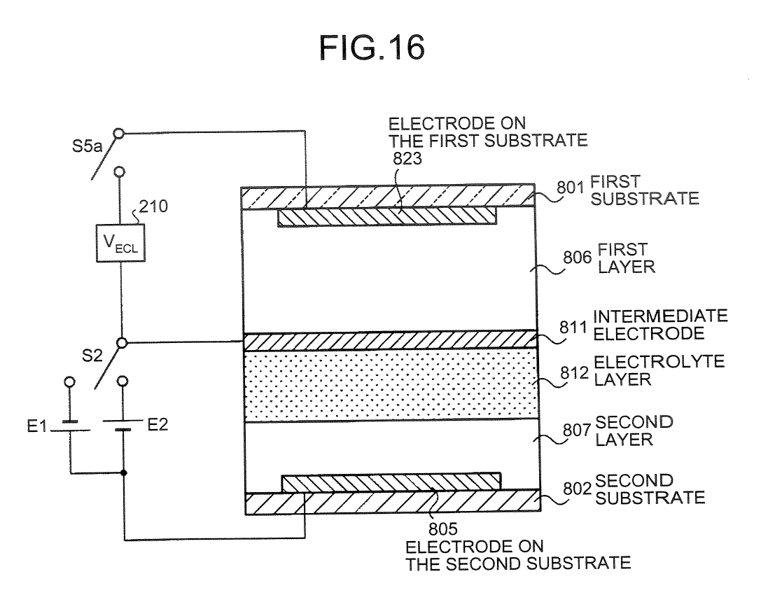

FIGS. 15 and 16 are sectional views schematically showing configurations of the display element L_{i,j} to be the display cell in the display apparatus according to the fifth embodiment. As to the display apparatus according to the fifth embodiment, only portions different from the fourth embodiment are explained, and like portions are designated by like reference numerals and the explanation thereof is not repeated.

In the display element L_{i,j} according to this embodiment, as shown in FIGS. 15 and 16, the intermediate electrode 811 and the electrolyte layer 812 are provided between the second layer 807 and the first layer 806. This point is similar to the display element L_{i,j} of the pixel X_{i,j} in the display apparatus according to the fourth embodiment. However, only the electrode on the first substrate side (electrode on the ECL side) 803 is provided to the first substrate 801 similarly to the display apparatus according to the third embodiment. This point is different from the display element L_{i,j} of the pixel X_{i,j} in the display apparatus according to the fourth embodiment.

The intermediate electrode 811 is normally made of an optically-transparent material so that the display can be observed. Examples of the optically-transparent material are oxide of transition metal such as (compound) oxide of titanium (Ti), zirconium (Zr), hafnium (Hf), strontium (Sr), zinc (Zn), tin (Sn), indium (In), yttrium (Y), lanthanum (La), vanadium (V), niobium (Nb), tantalum (Ta), chromium (Cr), molybdenum (Mo) and tungsten (W) as metal oxide semiconductor, perovskite such as SrTiO₃, CaTiO₃, BlaTiO₃, MgTiO₃ and SrNb₂O₆, compound oxide of them and oxide mixture, and gallium nitride (GaN). Examples of the transparent electrode to be frequently used are an oxide indium (In₂O₃) film (ITO) where tin (Sn) is doped, an oxide zinc (ZnO) film (IZN) where indium (In) is doped, an oxide zinc film (GZO) where gallium (Ga) is doped, and an oxide zinc film (FTO) where oxide tin (SnO₂) and fluorine for acid resistance are doped. The material of the electrolyte layer 812 includes a solvent (when the first layer 806 is a liquid layer as the liquid electrolyte) or a gelled polymer which is swelled by this solvent (when the first layer 806 is a solid layer as a solid electrolyte) and a supporting electrolyte which is dissolved with the solvent or the polymer. Examples of the supporting electrolyte are tetrabutylammonium perchlorate, potassium hexafluorophosphate, lithium trifluoromethanesulfonate, lithium perchlorate, tetra-n-butylammonium tetrafluoroborate, tripropyl amine, and tetra-n-butylammonium fluoroborate.

Examples of the solvent are single solvent or mixed solvent composed of acetonitrile, N,N-dimethylformamide, propylene carbonate, o-dichlorobenzene, 1,2dimethoxyethane, glycerin, water, ethyl alcohol, propyl alcohol, dimethyl carbonate, ethylene carbonate, γ-butylolactone, N-methyl-2-pyrrolidone (NMP), 2-methyltetrahydrofuran, toluene, tetrahydrofuran, benzonitrile, cyclohexane, n-hexane, acetone, nitrobenzene, 1.3-dioxolan, furan, benzotrifuloride and the like.

Examples of the gelled polymer are a copolymer of polyacrylonitrile (PAN), vinylidene fluoride (VDF) and vinylidene hexafluoride (HFP), and polyethylene oxide (PEO).

In the pixel X_{i,j} of the display apparatus according to the fifth embodiment, as shown in FIG. 15, the electrode-on-first substrate 823 and the intermediate electrode 811 are connected to the DC power supply circuit 210 via the switching element S5d. The DC power supply circuit 210 is composed of a DC power supply E_{ECL} 1 and a DC power supply E_{ECL} 2 including the counter voltage generating circuit 211 and the signal voltage generating circuit 212, variable resistor 213 and the switching element 214. The DC power supply circuit 210 is a circuit that applies a DC voltage between the electrode-on-first substrate 823 and the intermediate electrode 811 so that the voltage waveform becomes trapezoid. The DC power supplies E_{ECL} 1 and E_{ECL} 2 have different polarities. The DC power supply circuit 210, the electrode-on-first substrate 823 and the intermediate electrode 811 compose the first voltage applying unit (823, 811, 210).

The switching elements S5d and S2 selectively operate the first voltage applying unit (823, 811, 210) and the second voltage applying unit (811, 805, E1, E2).

The counter voltage generating circuit 211 is connected to the electrode-on-first substrate 823, and the signal voltage generating circuit 212 is connected to the intermediate electrode 811 via the variable resistor 213 and the switching element 214.

Similarly to the first embodiment, when the DC voltage generated from the signal voltage generating circuit 212 is applied to the intermediate electrode 811, the voltage passes through the variable resistor 213. While the voltage value is being gradually increased for the first period, the voltage is allowed to obtain a predetermined voltage value at the time when the first period elapses. The predetermined voltage is maintained for the second period starting from the elapse of the first period, and while the voltage value is being gradually decreased for the third period starting from the elapse of the second period, the voltage is applied so as to obtain a trapezoidal waveform where the value becomes 0 after a constant period of time elapses. Such application is repeated without changing polarity, so that the DC voltage of trapezoid wave is applied.

In the configuration shown in FIG. 15, the switching element S2 is opened, and the intermediate electrode 811 and the electrode-on-second-substrate (electrode on the EC side) 805 are disconnected from the DC power supplies E1 and E2. Further, the switching element S5d is closed with one of the polarities, and the electrode on the first substrate side 803 and the intermediate electrode 811 are connected to any of the DC power supplies E_{ECL} 1 and E_{ECL} 2 having different polarities, respectively. A DC voltage is, therefore, generated between the electrode-on-first substrate 823 and the intermediate electrode 811, and the first layer 806 including the luminescent material emits light due to this voltage so that the luminescence color is observed. If a color filter is provided onto the first substrate 801 of the pixel X_{i,j}, the filter color is observed from the first substrate 801 side. When the application of the voltage from the DC power supply circuit 210 is stopped, the first layer 806 does not emit light, and the background color of the pixel X_{i,j}, for example, black is displayed.

In the DC power supply circuit 210, the DC voltage is applied between the electrode-on-first substrate 823 and the intermediate electrode 811 by the switching operation of the variable resistor 213 and the switching element 214 repeatedly per constant cycle as shown in FIG. 5 so that the voltage waveform for one cycle becomes trapezoid.

In the DC power supply circuit 210 of this embodiment, the counter voltage generating circuit 211 is connected to the electrode-on-first substrate 823, and the signal voltage generating circuit 212 is connected to the intermediate electrode 811 via the variable resistor 213 and the switching element 214. On the contrary, however, the counter voltage generating circuit 211 may be connected to the intermediate electrode 811, and the signal voltage generating circuit 212 may be connected to the electrode on the first substrate side 803 via the variable resistor 213 and the switching element 214.

In this embodiment, the variable resistor 213 is used in the DC power supply circuit 210, so that the voltage waveform becomes trapezoid. Instead of the variable resistor 213, however, another circuit such as the low pass filter 313 shown in FIG. 2 may be used so that the voltage waveform becomes trapezoid.

Meanwhile, in FIG. 16, the electrode-on-first substrate 823 and the intermediate electrode 811 are connected to the AC power supply circuit V_{ECL} 210 via the switching element S5a, which compose the first voltage applying unit (823, 811, V_{ECL} 210).

The AC power supply circuit V_{ECL} 210 has the similar configuration to that of the power supply circuit 210 in the first embodiment, and is composed of the counter voltage generating circuit 211, the signal voltage generating circuit 212, the variable resistor 213, and the switching element 214. It is a power supply circuit that applies the AC voltage between the electrode on the first substrate side 803 and the intermediate electrode 811 so that the voltage waveform becomes trapezoid.

More specifically, the counter voltage generating circuit 211 is connected to the intermediate electrode 811, and the signal voltage generating circuit 212 is connected to the electrode-on-first substrate 823 via the variable resistor 213 and the switching element 214. Similarly to the first embodiment, when the AC voltage generated from the signal voltage generating circuit 212 is applied to the electrode-on-first substrate 823, the voltage passes through the variable resistor 213. As a result, while the voltage value is being gradually increased for the first period, the voltage is allowed to obtain a predetermined voltage value at the time when the first period elapses. The predetermined voltage is maintained for the second period starting from the elapse of the first period, and while the voltage value is being gradually decreased for the third period starting from the elapse of the second period, the voltage is applied so as to obtain a trapezoidal waveform where the value becomes 0 after a constant period of time elapses. Such application is repeated so that the voltage has trapezoidal waveform where polarities differ alternately. In such a manner, the AC voltage of trapezoid wave is applied.

In the AC power supply circuit V_{ECL} 210, the AC voltage is applied between the electrode-on-first substrate 823 and the intermediate electrode 811 by the switching operation of the variable resistor 213 and the switching element 214 repeatedly per constant cycle as shown in FIG. 4 so that the voltage waveform for one cycle becomes trapezoid.

In the AC power supply circuit V_{ECL} 210 of this embodiment, the counter voltage generating circuit 211 is connected to the intermediate electrode 811, and the signal voltage generating circuit 212 is connected to the electrode-on-first substrate 823 via the variable resistor 213 and the switching element 214. On the contrary, however, the counter voltage generating circuit 211 may be connected to the electrode-on-first substrate 823, and the signal voltage generating circuit 212 may be connected to the intermediate electrode 811 via the variable resistor 213 and the switching element 214.

According to the display apparatus in the fifth embodiment, the reflection display unit and the luminous display unit become independent systems, and thus the reflection display and the luminous display can be realized by more simple configuration in comparison with the fourth embodiment.

In the display apparatus according to the fifth embodiment, when the AC power supply circuit V_{ECL} 210 repeats the application of the voltage of trapezoidal waveform to the display element, the light emission with high luminance by the display element can be maintained for a longer period of time in comparison with the case where a voltage with rectangular waveform is applied like conventional display apparatuses.

A sixth embodiment is explained below.

In the display apparatus according to the sixth embodiment, an electrolyte layer and a porous electrode are further provided to the display element. In the display apparatus according to this embodiment, the configuration of the display element L_{i,j} of the pixel X_{i,j} is different from that in the first embodiment. As to the display apparatus according to the sixth embodiment, only different point from the first embodiment is explained, and like portions are designated by like reference numerals and the explanation thereof is not repeated.

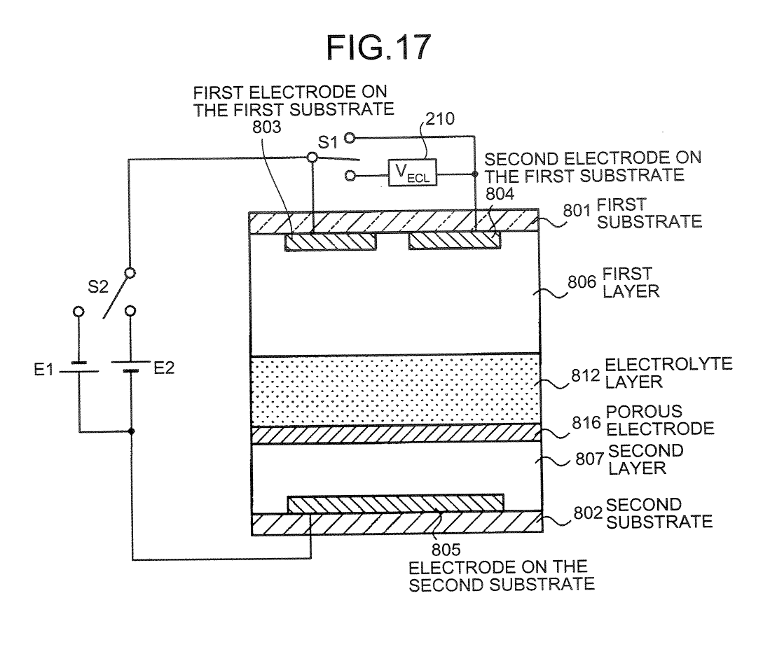

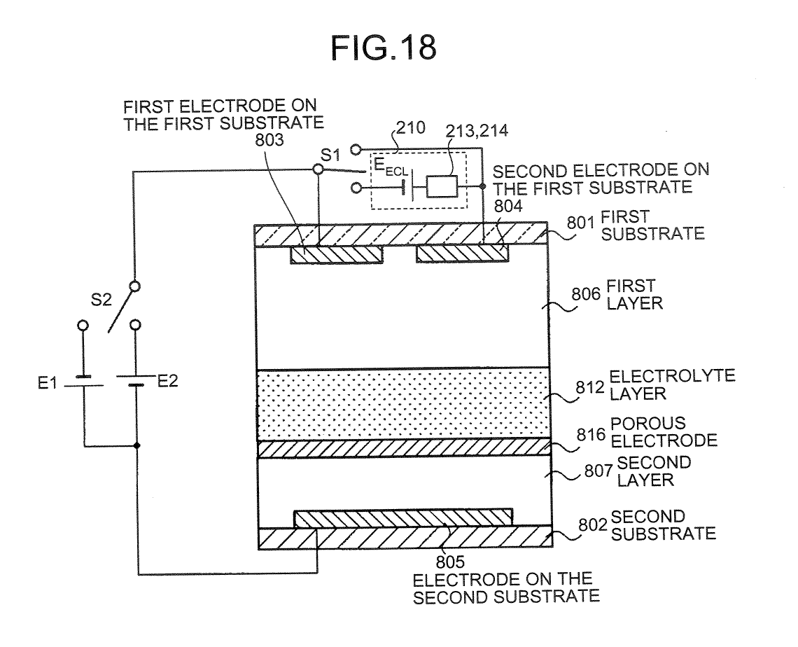

FIGS. 17 and 18 are sectional views schematically showing the configuration of the display element L_{i,j} to be the display cell in the display apparatus according to the sixth embodiment. The display element L_{i,j} according to this embodiment is similar to the first embodiment in that the first electrode-on-first-substrate (first electrode on the ECL side) 803 and the second electrode-on-first-substrate (second electrode on the ECL side) 804 are provided onto the first substrate 801 as shown in FIGS. 17 and 18. The sixth embodiment is different from the first embodiment in that an electrolyte layer 812 and the porous electrode or a porous electrode (first porous electrode) 816 including a porous material are provided between the second layer 807 and the first layer 806.

The porous electrode (first porous electrode) 816 may be a composite membrane composed of a porous electrode (EC layer side) and a porous insulating film (electrolyte side). A pore diameter of the porous electrode (first porous electrode) 816 may fall within a range of 1 nm to 1000 nm, preferably a range of 1 nm to 100 nm. Various conductive materials (ITO, FTO, SnO₂ and the like) can be used, and thus it is not necessary that the pore shape and the pore diameter are uniform as long as the pore diameter falls within these ranges. The porous electrode (first porous electrode) 816 is normally made of an optically-transparent material so that the display can be observed. Examples of such an optically-transparent material are oxide of transition metal such as (compound) oxide of titanium (Ti), zirconium (Zr), hafnium (Hf), strontium (Sr), zinc (Zn), tin (Sn), indium (In), yttrium (Y), lanthanum (La), vanadium (V), niobium (Nb), tantalum (Ta), chromium (Cr), molybdenum (Mo) and tungsten (W) as metal oxide semiconductor, perovskite such as SrTiO₃, CaTiO₃, BlaTiO₃, MgTiO₃ and SrNb₂O₆, compound oxide of them and oxide mixture, and gallium nitride (GaN). Examples of the optically-transparent material to be frequently used are an oxide indium (In₂O₃) film (ITO) where tin (Sn) is doped, an oxide zinc (ZnO) film (IZN) where indium (In) is doped, an oxide zinc film (GZO) where gallium (Ga) is doped, and an oxide zinc film (FTO) where oxide tin (SnO₂) and fluorine for acid resistance are doped.

The material of the electrolyte layer 812 includes a solvent (when the first layer 806 is a liquid layer as the liquid electrolyte) or a gelled polymer which is swelled by this solvent (when the first layer 806 is a solid layer as a solid electrolyte) and a supporting electrolyte which is dissolved with the solvent or the polymer. Examples of the supporting electrolyte are tetrabutylammonium perchlorate, potassium hexafluorophosphate, lithium trifluoromethanesulfonate, lithium perchlorate, tetra-n-butylammonium tetrafluoroborate, tripropyl amine, and tetra-n-butylammonium fluoroborate.

Examples of the solvent are single solvent or mixed solvent composed of acetonitrile, N,N-dimethylformamide, propylene carbonate, o-dichlorobenzene, 1,2dimethoxyethane, glycerin, water, ethyl alcohol, propyl alcohol, dimethyl carbonate, ethylene carbonate, γ-butylolactone, N-methyl-2-pyrrolidone (NMP), 2-methyltetrahydrofuran, toluene, tetrahydrofuran, benzonitrile, cyclohexane, n-hexane, acetone, nitrobenzene, 1.3-dioxolan, furan, benzotrifuloride and the like.

Examples of the gelled polymer are a copolymer of polyacrylonitrile (PAN), vinylidene fluoride (VDF) and vinylidene hexafluoride (HFP), and polyethylene oxide (PEO).

In the display element L_{i,j} of the pixel X_{i,j} in the display apparatus according to the sixth embodiment, as shown in FIG. 17, the electrode on the first substrate side (the first electrode on the ECL side) 803 and the electrode on the first substrate side (second electrode on the ECL side) 804 are connected to the AC power supply circuit V_{ECL} 210 via the switching element S1. They compose the first voltage applying unit (803, 804, V_{ECL} 210). The first electrode 803 on the first substrate side 803, the second electrode-on-first-substrate 804 and the electrode-on-second-substrate (electrode on the EC side) 805 are connected to the DC power supplies E1 and E2 with different polarities via the switching element S2. They compose the second voltage applying unit (803, 804, 805, E1; E2). The switching elements S1 and S2 selectively operate the first voltage applying unit (803, 804, V_{ECL} 210) and the second voltage applying unit (803, 804, 805, E1, E2).

The AC power supply circuit V_{ECL} 210 has the similar configuration to that of the power supply circuit 210 in the first embodiment, and is composed of the counter voltage generating circuit 211, the signal voltage generating circuit 212, the variable resistor 213 and the switching element 214. The circuit V_{ECL} 210 applies an AC voltage between the first electrode-on-first-substrate 803 and the second electrode-on-first-substrate 804 so that the voltage waveform becomes trapezoid as shown in FIG. 4.

The counter voltage generating circuit 211 is connected to the first electrode-on-first-substrate 803, and the signal voltage generating circuit 212 is connected to the second electrode-on-first-substrate 804 via the variable resistor 213 and the switching element 214. Similarly to the first embodiment, when the AC voltage generated from the signal voltage generating circuit 212 is applied to the second electrode-on-first-substrate 804, the AC voltage passes through the variable resistor 213, so that while the voltage value is being gradually increased for the first period, the voltage is allowed to reach a predetermined voltage value at the time when the first period elapses. The predetermined voltage is maintained for the second period starting from the elapse of the first period. While the voltage is being gradually reduced for the third period starting from the elapse of the second period, the voltage is applied so that the voltage obtains a trapezoidal waveform where the value becomes 0 after elapse of constant period of time. Such application of the voltage is repeated so that the trapezoid wave where polarities differ alternately is obtained. In such a manner, the AC voltage of the trapezoid wave is applied.

In the luminous display of FIG. 18, the switching element S2 is opened, and the first electrode-on-first-substrate 803, the second electrode-on-first-substrate 804 and the electrode-on-second-substrate 805 are disconnected from the DC power supplies E1 and E2. Further, the switching element S1 is closed, and the first electrode-on-first-substrate 803 and the second electrode-on-first-substrate 804 are connected to the DC power supply circuit 210. A DC voltage is, therefore, generated between the first electrode-on-first-substrate 803 and the second electrode-on-first-substrate 804 (via the porous electrode 816). The first layer 806 including the luminescent material emits light due to the voltage, and luminous color is observed. Similarly to FIG. 17, if a color filter is provided onto the first substrate of the pixel X_{i,j}, the filter color is observed from the first substrate 801 side. When the application of the voltage from the DC power supply circuit 210 is stopped, the first layer 806 does not emit light, and thus the background color of the pixel X_{i,j}, for example, black is displayed.

In the reflection display, the switching element S1 is switched so that the first electrode-on-first-substrate 803 and the second electrode-on-first-substrate 804 short-circuit. The switching element S2 is closed, and any of the DC power supplies E1 and E2 with different polarities are connected among the first electrode-on-first-substrate 803, the second electrode-on-first-substrate 804 and the electrode-on-second-substrate 805 of the same electric potential. Therefore, the DC voltage is generated among the first electrode-on-first-substrate 803, the second electrode-on-first-substrate 804 and the electrode-on-second-substrate 805 of the same electric potential, and the second layer 807 including the material showing the EC phenomenon is colored or becomes transparent. As a result, the second substrate 807 is observed as a background color via the colored second layer 807 or the transparent second layer 807 from the outside of the first substrate 801. When the polarities of the applied voltages from the DC power supplies E1 and E2 are changed, the colored second layer 807 becomes transparent or the transparent second layer 807 is colored. As a result, the background color or the color of the second layer 807 is observed from the first substrate 801 side.

In the AC power supply circuit V_{ECL} 210, the AC voltage is applied between the first electrode-on-first-substrate 803 and the second electrode-on-first-substrate 804 by the switching operation of the variable resistor 213 and the switching element 214 repeatedly per constant cycle so that the voltage waveform for one cycle becomes trapezoid.

In the AC power supply circuit V_{ECL} 210 of this embodiment, the counter voltage generating circuit 211 is connected to the first electrode-on-first-substrate 803, and the signal voltage generating circuit 212 is connected to the second electrode-on-first-substrate 804 via the variable resistor 213 and the switching element 214. On the contrary, however, the counter voltage generating circuit 211 may be connected to the second electrode-on-first-substrate 804, and the signal voltage generating circuit 212 may be connected to the first electrode-on-first-substrate 803 via the variable resistor 213 and the switching element 214.

In this embodiment, the variable resistor 213 is used in the AC power supply circuit V_{ECL} 210 so that the voltage waveform becomes trapezoid. Instead of the variable resistor 213, another circuit such as the low pass filter 313 shown in FIG. 2 may be used so that the voltage waveform becomes trapezoid.

As shown in FIG. 18, the DC power supply circuit 210 composed of the counter voltage generating circuit 211 and the signal voltage generating circuit 212 may be connected so that the DC voltage is applied between the first electrode-on-first-substrate 803 and the second electrode-on-first-substrate 804. The DC power supply circuit 210 has the similar configuration to that of the power supply circuit 210 in the first embodiment, and is composed of the DC power supply E_{ECL} including the counter voltage generating circuit 211 and the signal voltage generating circuit 212, the variable resistor 213 and the switching element 214. The circuit V_{ECL} 210 applies a DC voltage between the first electrode-on-first-substrate 803 and the second electrode-on-first-substrate 804 so that the voltage waveform becomes trapezoid as shown in FIG. 5.

More specifically, the counter voltage generating circuit 211 is connected to the electrode on the first substrate side 803, and the signal voltage generating circuit 212 is connected to the second electrode-on-first-substrate 804 via the variable resistor 213 and the switching element 214. Similarly to the first embodiment, when the DC voltage generated from the signal voltage generating circuit 212 is applied to the second electrode-on-first-substrate 804, the DC voltage passes through the variable resistor 213, so that while the voltage value is being gradually increased for the first period (t1) shown in FIG. 4, the voltage is allowed to reach a predetermined voltage value at the time when the first period elapses. The predetermined voltage is maintained for the second period (t2) starting from the elapse of the first period. While the voltage is being gradually reduced for the third period (t3) starting from the elapse of the second period, the voltage is applied so that the voltage obtains a trapezoidal waveform where the value becomes 0 after elapse of constant period of time. Such application of the voltage is repeated without changing polarity, so that the DC voltage of the trapezoid wave is applied.

In the DC power supply circuit 210, the DC voltage is applied between the first electrode-on-first-substrate 803 and the second electrode-on-first-substrate 804 by the switching operation of the variable resistor 213 and the switching element 214 repeatedly per constant cycle so that the voltage waveform for one cycle becomes trapezoid as shown in FIG. 5.

In the DC power supply circuit 210 of this embodiment, the counter voltage generating circuit 211 is connected to the first electrode-on-first-substrate 803, and the signal voltage generating circuit 212 is connected to the second electrode-on-first-substrate 804 via the variable resistor 213 and the switching element 214. On the contrary, however, the counter voltage generating circuit 211 may be connected to the second electrode-on-first-substrate 804, and the signal voltage generating circuit 212 may be connected to the first electrode-on-first-substrate 803 via the variable resistor 213 and the switching element 214.

In this embodiment, the variable resistor 213 is used in the DC power supply circuit 210 so that the voltage waveform becomes trapezoid. Instead of the variable resistor 213, another circuit such as the low pass filter 313 shown in FIG. 2 may be used so that the voltage waveform becomes trapezoid.

According to the display apparatus in the sixth embodiment, the reflection display and the luminous display can be realized by the simpler configuration than the fifth embodiment.

In the display apparatus according to the sixth embodiment, the AC power supply circuit V_{ECL} 210 and the DC power supply circuit 210 repeat the application of the voltage with trapezoidal waveform to the display element. As a result, the light emission with high luminance by the display element can be realized for a longer period time in comparison with the case where the voltage with rectangular waveform is applied like the conventional display apparatuses.

A seventh embodiment is explained below.

In the display apparatus according to the seventh embodiment, an electrolyte layer and a porous electrode are further provided to the display element. In the display apparatus according to this embodiment, the configuration of the display element L_{i,j} of the pixel X_{i,j} is different from that in the first embodiment. As to the display apparatus according to the seventh embodiment, only different point from the first embodiment is explained, and like portions are designated by like reference numerals and the explanation thereof is not repeated.

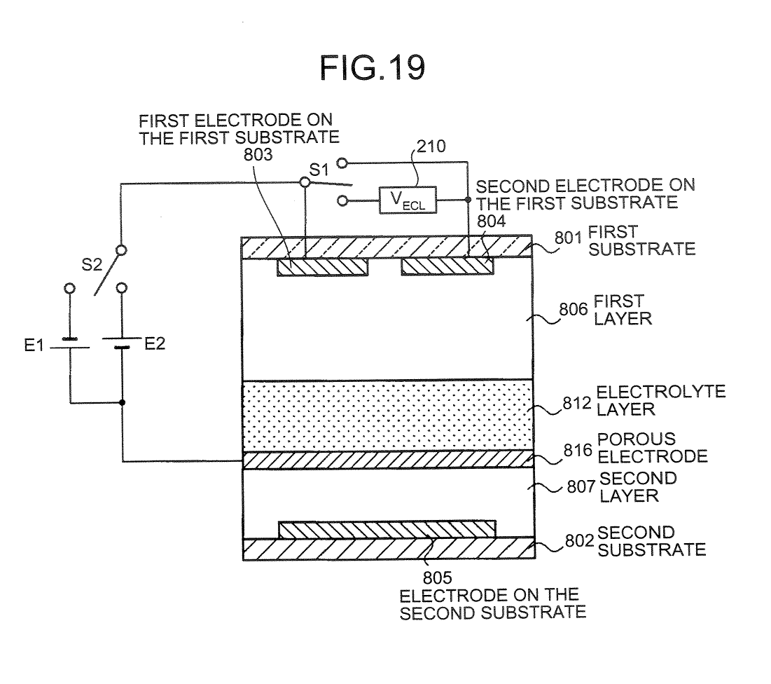

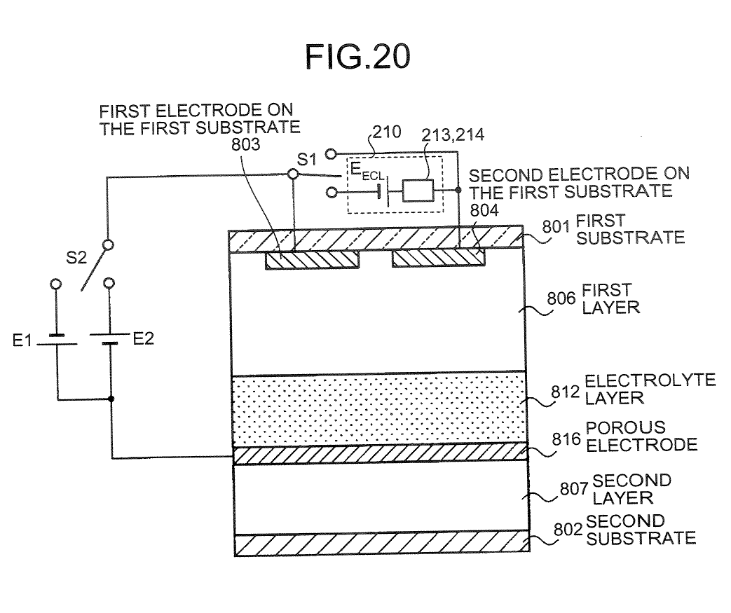

FIGS. 19 and 20 are sectional views schematically showing the configuration of the display element L_{i,j} to be the display cell in the display apparatus according to the seventh embodiment. The display element L_{i,j} according to this embodiment is different from the first embodiment in that, as shown in FIGS. 19 and 20, the electrolyte layer 812 and the porous electrode or a porous electrode (first porous electrode) 816 including a porous material are provided between the second layer 807 and the first layer 806.

The porous electrode (first porous electrode) 816 may be a composite membrane composed of a porous electrode (EC layer side) and a porous insulating film (electrolyte side). A pore diameter of the porous electrode (first porous electrode) 816 may fall within a range of 1 nm to 1000 nm, preferably a range of 1 nm to 100 nm. Various conductive materials (ITO, FTO, SnO₂ and the like) can be used, and thus it is not necessary that the pore shape and the pore diameter are uniform as long as the pore diameter falls within these ranges. The porous electrode (first porous electrode) 816 is normally made of an optically-transparent material so that the display can be observed. Examples of such an optically-transparent material are oxide of transition metal such as (compound) oxide of titanium (Ti), zirconium (Zr), hafnium (Hf), strontium (Sr), zinc (Zn), tin (Sn), indium (In), yttrium (Y), lanthanum (La), vanadium (V), niobium (Nb), tantalum (Ta), chromium (Cr), molybdenum (Mo) and tungsten (W) as metal oxide semiconductor, perovskite such as SrTiO₃, CaTiO₃, BlaTiO₃, MgTiO₃ and SrNb₂O₆, compound oxide of them and oxide mixture, and gallium nitride (GaN). Examples of the optically-transparent material to be frequently used are an oxide indium (In₂O₃) film (ITO) where tin (Sn) is doped, an oxide zinc (ZnO) film (IZO) where indium (In) is doped, an oxide zinc film (GZO) where gallium (Ga) is doped, and an oxide zinc film (FTO) where oxide tin (SnO₂) and fluorine for acid resistance are doped.

The material of the electrolyte layer 812 includes a solvent (when the first layer 806 is a liquid layer as the liquid electrolyte) or a gelled polymer which is swelled by this solvent (when the first layer 806 is a solid layer as a solid electrolyte) and a supporting electrolyte which is dissolved with the solvent or the polymer. Examples of the supporting electrolyte are tetrabutylammonium perchlorate, potassium hexafluorophosphate, lithium trifluoromethanesulfonate, lithium perchlorate, tetra-n-butylammonium tetrafluoroborate, tripropyl amine, and tetra-n-butylammonium fluoroborate.

Examples of the solvent are single solvent or mixed solvent composed of acetonitrile, N,N-dimethylformamide, propylene carbonate, o-dichlorobenzene, 1,2dimethoxyethane, glycerin, water, ethyl alcohol, propyl alcohol, dimethyl carbonate, ethylene carbonate, γ-butylolactone, N-methyl-2-pyrrolidone (NMP), 2-methyltetrahydrofuran, toluene, tetrahydrofuran, benzonitrile, cyclohexane, n-hexane, acetone, nitrobenzene, 1.3-dioxolan, furan, benzotrifuloride and the like.

Examples of the gelled polymer are a copolymer of polyacrylonitrile (PAN), vinylidene fluoride (VDF) and vinylidene hexafluoride (HFP), and polyethylene oxide (PEO). As shown in FIG. 15, the luminous display of the pixel X_{i,j} of the display apparatus according to seventh embodiment is performed by applying AC or DC voltage between the first electrode-on-first-substrate (first electrode on the ECL side) 803 and the second electrode-on-first-substrate 804 (second electrode on the ECL side). The reflection display is performed by applying the DC voltage among the first electrode-on-first-substrate 803, the second electrode-on-first-substrate 804 (with the same electric potential) and the porous electrode (first porous electrode) 816.

That is, in the pixel X_{i,j} of the display apparatus according to the seventh embodiment, as shown in FIG. 19, the first electrode-on-first-substrate 803 and the second electrode-on-first-substrate 804 are connected to the AC power supply circuit V_{ECL} 210 via the switching element S1. They compose the first voltage applying unit (803, 803, V_{ECL} 210).

The first electrode-on-first-substrate 803, the second electrode-on-first-substrate 804 and the porous electrode (first porous electrode) 816 are connected to the DC power supplies E1 and E2 with different polarities via the switching element S2. They compose the second voltage applying unit (803, 804, 805, E1, E2). The switching elements S1 and S2 selectively operate the first voltage applying unit (803, 804, V_{ECL} 210) and the second voltage applying unit (803, 804, 805, E1, E2).

The AC power supply circuit V_{ECL} 210 has the similar configuration to that of the power supply circuit 210 in the first embodiment, and is composed of the counter voltage generating circuit 211, the signal voltage generating circuit 212, the variable resistor 213 and the switching element 214. The circuit V_{ECL} 210 applies an AC voltage between the first electrode-on-first-substrate 803 and the second electrode-on-first-substrate 804 so that the voltage waveform becomes trapezoid as shown in FIG. 4.

The counter voltage generating circuit 211 is connected to the first electrode-on-first-substrate 803, and the signal voltage generating circuit 212 is connected to the second electrode-on-first-substrate 804 via the variable resistor 213 and the switching element 214. Similarly to the first embodiment, when the AC voltage generated from the signal voltage generating circuit 212 is applied to the second electrode-on-first-substrate 804, the AC voltage passes through the variable resistor 213, so that while the voltage value is being gradually increased for the first period, the voltage is allowed to reach a predetermined voltage value at the time when the first period elapses. The predetermined voltage is maintained for the second period starting from the elapse of the first period. While the voltage is being gradually reduced for the third period starting from the elapse of the second period, the voltage is applied so that the voltage obtains a trapezoidal waveform where the value becomes 0 after elapse of constant period of time. Such application of the voltage is repeated so that the trapezoid wave where polarities differ alternately is obtained. In such a manner, the AC voltage of the trapezoid wave is applied.

In the luminous display by the display element L_{i,j} shown in FIG. 19, the switching element S2 is opened, and the first electrode-on-first-substrate 803, the second electrode-on-first-substrate 804 and the porous electrode (first porous electrode) 816 are disconnected from the DC power supplies E1 and E2. Further, the switching element S1 is closed, and the first electrode-on-first-substrate 803 and the second electrode-on-first-substrate 804 are connected to the AC power supply circuit V_{ECL} 210. An AC voltage is, therefore, generated between the first electrode-on-first-substrate 803 and the second electrode-on-first-substrate 804 (via the porous electrode 816). The first layer 806 including the luminescent material emits light due to the voltage, and luminous color is observed. If a color filter is provided onto the first substrate of the pixel X_{i,j}, the filter color is observed from the first substrate 801 side. When the application of the voltage from the DC power supply circuit V_{ECL} 210 is stopped, the first layer 806 does not emit light, and thus the background color of the pixel X_{i,j}, for example, black is displayed.

In the AC power supply circuit V_{ECL} 210 of this embodiment, the counter voltage generating circuit 211 is connected to the first electrode-on-first-substrate 803, and the signal voltage generating circuit 212 is connected to the second electrode-on-first-substrate 804 via the variable resistor 213 and the switching element 214. On the contrary, however, the counter voltage generating circuit 211 may be connected to the second electrode-on-first-substrate 804, and the signal voltage generating circuit 212 may be connected to the first electrode-on-first-substrate 803 via the variable resistor 213 and the switching element 214.

In this embodiment, the variable resistor 213 is used in the AC power supply circuit V_{ECL} 210 so that the voltage waveform becomes trapezoid. Instead of the variable resistor 213, another circuit such as the low pass filter 313 shown in FIG. 2 may be used so that the voltage waveform becomes trapezoid.

As shown in FIG. 20, the DC power supply circuit 210 composed of the counter voltage generating circuit 211 and the signal voltage generating circuit 212 may be connected so that the DC voltage with trapezoidal waveform is applied between the first electrode-on-first-substrate 803 and the second electrode-on-first-substrate 804. The DC power supply circuit 210 has the similar configuration to that of the power supply circuit 210 in the first embodiment, and is composed of the DC power supply E_{ECL} including the counter voltage generating circuit 211 and the signal voltage generating circuit 212, the variable resistor 213 and the switching element 214. The circuit V_{ECL} 210 applies a DC voltage between the first electrode-on-first-substrate 803 and the second electrode-on-first-substrate 804 so that the voltage waveform becomes trapezoid.

More specifically, the counter voltage generating circuit 211 is connected to the first electrode-on-first-substrate 803, and the signal voltage generating circuit 212 is connected to the second electrode-on-first-substrate 804 via the variable resistor 213 and the switching element 214. Similarly to the first embodiment, when the DC voltage generated from the signal voltage generating circuit 212 is applied to the second electrode-on-first-substrate 804, the DC voltage passes through the variable resistor 213, so that while the voltage value is being gradually increased for the first period, the voltage is allowed to reach a predetermined voltage value at the time when the first period elapses. The predetermined voltage is maintained for the second period starting from the elapse of the first period. While the voltage is being gradually reduced for the third period starting from the elapse of the second period, the voltage is applied so that the voltage obtains a trapezoidal waveform where the value becomes 0 after elapse of constant period of time. Such application of the voltage is repeated without changing polarity, so that the DC voltage of the trapezoid wave is applied.

In the DC power supply circuit 210 of this embodiment, the counter voltage generating circuit 211 is connected to the first electrode-on-first-substrate 803, and the signal voltage generating circuit 212 is connected to the second electrode-on-first-substrate 804 via the variable resistor 213 and the switching element 214. On the contrary, however, the counter voltage generating circuit 211 may be connected to the second electrode-on-first-substrate 804, and the signal voltage generating circuit 212 may be connected to the first electrode-on-first-substrate 803 via the variable resistor 213 and the switching element 214.

In this embodiment, the variable resistor 213 is used in the DC power supply circuit 210 so that the voltage waveform becomes trapezoid. Instead of the variable resistor 213, another circuit such as the low pass filter 313 shown in FIG. 2 may be used so that the voltage waveform becomes trapezoid.

In the display cell L_{i,i} as shown in FIG. 20, the first electrode-on-first-substrate 803 and the second electrode-on-first-substrate 804 are connected to the DC power supply circuit 210 via the switching element S1. They compose the first voltage applying unit (803, 803, 210). Further, the first electrode-on-first-substrate 803, the second electrode-on-first-substrate 804 and the porous substrate 816 are connected to the DC power supplies E1 and E2 with different polarities via the switching element S2. They compose the second voltage applying unit (803, 804, 805, E1, E2). The switching elements S1 and S2 compose the switching units (S1 and S2) that selectively operate the first voltage applying unit (803, 804, 210) and the second voltage applying unit (803, 804, 805, E1, E2).

In the luminous display of FIG. 20, the switching element S2 is opened, and the first electrode-on-first-substrate 803, the second electrode-on-first-substrate 804 and the porous electrode 816 are disconnected from the DC power supplies E1 and E2. Further, the switching element S1 is closed, and the first electrode-on-first-substrate 803 and the second electrode-on-first-substrate 804 are connected to the DC power supply circuit 210. A DC voltage is, therefore, generated between the first electrode-on-first-substrate 803 and the second electrode-on-first-substrate 804 (via the porous electrode 816). The first layer 806 including the luminescent material emits light due to the voltage, and luminous color is observed. Similarly to FIG. 19, if a color filter is provided onto the first substrate 801 of the pixel X_{i,j}, the filter color is observed from the first substrate 801 side. When the application of the voltage from the DC power supply circuit 210 is stopped, the first layer 806 does not emit light, and thus the background color of the pixel X_{i,j}, for example, black is displayed.

In the reflection display, the switching element S1 is switched so that the first electrode-on-first-substrate 803 and the second electrode-on-first-substrate 804 short-circuit. The switching element S2 is closed, and any of the DC power supplies E1 and E2 with different polarities are connected between the first electrode-on-first-substrate 803, the second electrode-on-first-substrate 804 and the porous electrode 816 with the same electric potential, respectively. Therefore, the DC voltage is generated between the first electrode-on-first-substrate 803, the second electrode-on-first-substrate 804 and the porous electrode 816 with the same electric potential, and the electrolyte layer 812 including the material showing the EC phenomenon is colored or becomes transparent. As a result, the second substrate 802 is observed as a background color via the colored electrolyte layer 812 or the transparent electrolyte layer 812 from the outside of the first substrate 801. When the polarities of the applied voltages from the DC power supplies E1 and E2 are changed, the colored electrolyte layer 812 becomes transparent or the transparent electrolyte layer 812 is colored. As a result, the background color or the color of the electrolyte layer 812 is observed from the first substrate 801 side.

According to the display apparatus in the seventh embodiment, the reflection display and the luminous display can be realized by the simpler configuration than the fifth embodiment.

In the display apparatus according to the seventh embodiment, the AC power supply circuit V_{ECL} 210 and the DC power supply circuit 210 repeat the application of the voltage with trapezoidal waveform to the display element. As a result, the light emission with high luminance by the display element can be realized for a longer period of time in comparison with the case where the voltage with rectangular waveform is applied like the conventional display apparatuses.

An eighth embodiment is explained below.

In the display apparatus according to the eighth embodiment, as to the configuration of the display element, only a single electrode on the first substrate side is provided onto the first substrate 801, and an intermediate electrode, an electrolyte layer and a porous layer are further provided. In the display apparatus according to this embodiment, the configuration of the display element L_{i,j} of the pixel X_{i,j} is different from that in the first embodiment. As to the display apparatus according to the eighth embodiment, only different point from the first embodiment is explained, and like portions are designated by like reference numerals and the explanation thereof is not repeated.

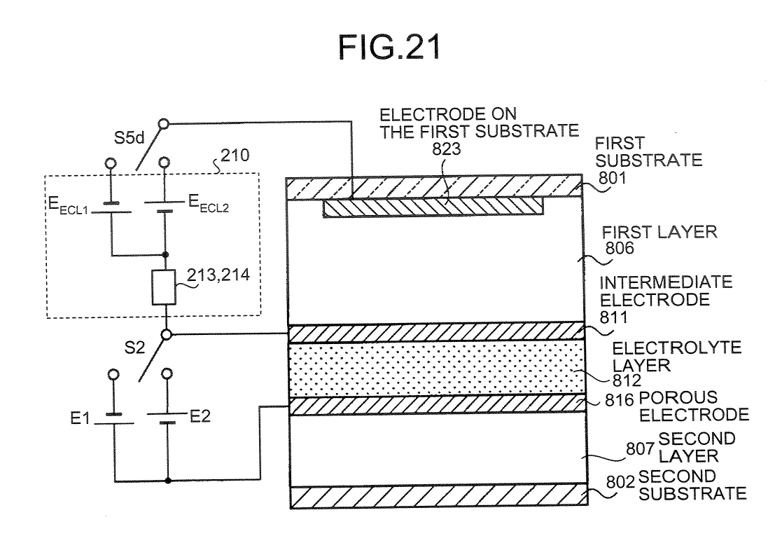

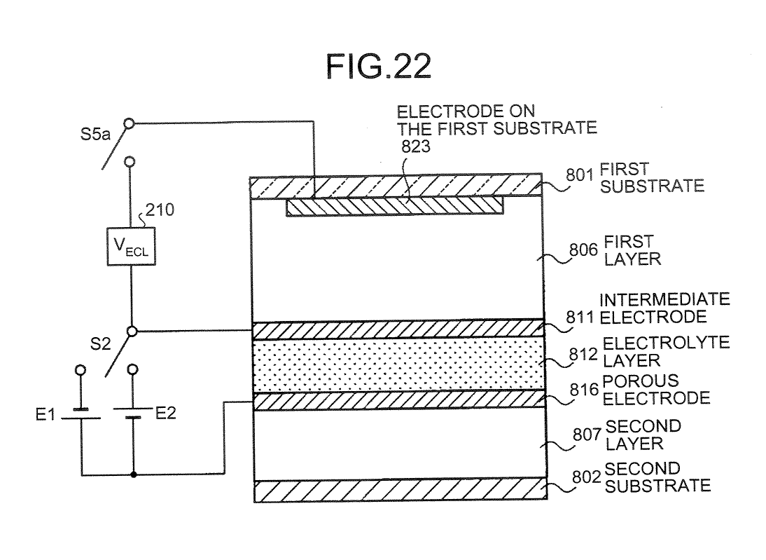

FIGS. 21 and 22 are sectional views schematically showing the configuration of the display element L_{i,j} to be the display cell in the display apparatus according to the eighth embodiment. The display element L_{i,j} according to this embodiment is, as shown in FIGS. 21 and 22, constituted so that only the electrode on the first substrate side 803 is provided onto the first substrate 801, and the transparent intermediate layer 811, electrolyte layer 812 and porous electrode (first porous electrode) 816 including a porous material are provided between the second layer 807 and the first layer 806.

In the pixel X_{i,j} of the display apparatus according to the eighth embodiment, as shown in FIG. 21, the electrode-on-first substrate (electrode on the ECL side) 823 and the intermediate electrode 811 are connected to the DC power supply circuit 210 via the switching element S5d. The DC power supply circuit 210 is composed of the DC power supply E_{ECL} 1 and the DC power supply E_{ECL} 2 including the counter voltage generating circuit 211 and the signal voltage generating circuit 212, the variable resistor 213 and the switching element 214. The DC power supply circuit 210 is a circuit that applies a DC voltage between the electrode-on-first substrate 823 and the intermediate electrode 811 so that the voltage waveform becomes trapezoid. The DC power supplies E_{ECL} 1 and E_{ECL} 2 have different polarities. The DC power supply circuit 210, the electrode-on-first substrate 823 and the intermediate electrode 811 compose the first voltage applying unit (823, 811, 210).

The counter voltage generating circuit 211 is connected to the electrode-on-first substrate 823, and the signal voltage generating circuit 212 is connected to the intermediate electrode 811 via the variable resistor 213 and the switching element 214. Similarly to the first embodiment, when the DC voltage generated from the signal voltage generating circuit 212 is applied to the intermediate electrode 811, the voltage passes through the variable resistor 213. While the voltage value is being gradually increased for the first period (t1) as shown in FIG. 4, the voltage is allowed to obtain a predetermined voltage value at the time when the first period elapses. The predetermined voltage is maintained for the second period (t2) starting from the elapse of the first period, and while the voltage value is being gradually decreased for the third period (t3) starting from the elapse of the second period, the voltage is applied so as to obtain a trapezoidal waveform where the value becomes 0 after a constant period of time elapses. Such application is repeated without changing polarity, so that the DC voltage of trapezoid wave is applied.

The luminous display of the display cell L_{i,j} in the display apparatus according to the eight embodiment is performed by applying the AC or DC voltage between the electrode-on-first substrate 823 and the intermediate electrode 811. That is, in the luminous display of the display cell L_{i,j} shown in FIG. 21, the switching element S2 is opened, and the intermediate electrode 811 and the porous electrode 816 are disconnected from the power supplies E1 and E2. Further, the switching element S5d is closed with one of the polarities, and the electrode-on-first substrate 823 and the intermediate electrode 811 are connected to any of the DC power supplies E_{ECL} 1 and E_{ECL} 2 having different polarities, respectively. A DC voltage is, therefore, generated between the electrode-on-first substrate 823 and the intermediate electrode 811, and the first layer 806 including the luminescent material emits light due to this voltage so that the luminescence color is observed. If a color filter is provided onto the first substrate 801 of the pixel X_{i,j}, the filter color is observed from the first substrate 801 side. When the application of the voltage from the DC power supply circuit 210 is stopped, the first layer 806 does not emit light, and the background color of the pixel X_{i,j}, for example, black is displayed.

In the DC power supply circuit 210 of this embodiment, the counter voltage generating circuit 211 is connected to the electrode-on-first substrate 823, and the signal voltage generating circuit 212 is connected to the intermediate electrode 811 via the variable resistor 213 and the switching element 214. On the contrary, however, the counter voltage generating circuit 211 may be connected to the intermediate electrode 811, and the signal voltage generating circuit 212 may be connected to the electrode-on-first substrate 823 via the variable resistor 213 and the switching element 214.

In this embodiment, the variable resistor 213 is used in the DC power supply circuit 210 so that the voltage waveform becomes trapezoid. Instead of the variable resistor 213, another circuit such as the low pass filter 313 shown in FIG. 2 may be used so that the voltage waveform becomes trapezoid.

Meanwhile, in FIG. 22, the electrode-on-first substrate 823 and the intermediate electrode 811 are connected to the AC power supply circuit V_{ECL} 210 via the switching element S5a. They compose the first voltage applying unit (823, 811, V_{ECL} 210). Further, the intermediate electrode 811 and the porous electrode (first porous electrode) 816 are connected to the DC power supplies E1 and E2 via the switching element S2. They compose the second voltage applying unit (811, 816, E1, E2). The switching elements S5a and S2 compose the switching units (S5a and S2) that selectively operate the first voltage applying unit (823, 811, V_{ECL} 210) and the second voltage applying unit (811, 816, E1, E2).

The AC power supply circuit V_{ECL} 210 has the similar configuration to that in the first embodiment, and is composed of the counter voltage generating circuit 211, the signal voltage generating circuit 212, the variable resistor 213 and the switching element 214. The circuit V_{ECL} 210 applies an AC voltage between the electrode-on-first substrate 823 and the intermediate electrode 811 so that the voltage waveform becomes trapezoid as shown in FIG. 4.

More specifically, the counter voltage generating circuit 211 is connected to the intermediate electrode 811, and the signal voltage generating circuit 212 is connected to the electrode-on-first substrate 823 via the variable resistor 213 and the switching element 214. Similarly to the first embodiment, when the AC voltage generated from the signal voltage generating circuit 212 is applied to the electrode-on-first substrate 823, the AC voltage passes through the variable resistor 213, so that while the voltage value is being gradually increased for the first period, the voltage is allowed to reach a predetermined voltage value at the time when the first period elapses. The predetermined voltage is maintained for the second period starting from the elapse of the first period. While the voltage is being gradually reduced for the third period starting from the elapse of the second period, the voltage is applied so that the voltage obtains a trapezoidal waveform where the value becomes 0 after elapse of constant period of time. Such application of the voltage is repeated so that the polarities differ alternately, and thus the AC voltage of the trapezoid wave is applied.

In the AC power supply circuit V_{ECL} 210, the AC voltage is applied between the electrode-on-first substrate 823 and the intermediate electrode 811 by the switching operation of the variable resistor 213 and the switching element 214 repeatedly per constant cycle as shown in FIG. 4 so that the voltage waveform for one cycle becomes trapezoid.

In the AC power supply circuit V_{ECL} 210 of this embodiment, the counter voltage generating circuit 211 is connected to the intermediate electrode 811, and the signal voltage generating circuit 212 is connected to the electrode-on-first substrate 823 via the variable resistor 213 and the switching element 214. On the contrary, however, the counter voltage generating circuit 211 may be connected to the electrode-on-first substrate 823, and the signal voltage generating circuit 212 may be connected to the intermediate electrode 811 via the variable resistor 213 and the switching element 214.

In this embodiment, the variable resistor 213 is used in the AC power supply circuit V_{ECL} 210 so that the voltage waveform becomes trapezoid. Instead of the variable resistor 213, another circuit such as the low pass filter 313 shown in FIG. 2 may be used so that the voltage waveform becomes trapezoid.

In this embodiment, the AC power supply circuit V_{ECL} 210 applies the AC voltage between the electrode-on-first substrate 823 and the intermediate electrode 811. However, the counter voltage generating circuit 211 and the signal voltage generating circuit 212 may be constituted so that the DC voltage is applied between the electrode-on-first substrate 823 and the intermediate electrode 811.

In the luminous display of the display element L_{i,j} according to this embodiment shown in FIG. 22, the switching element S2 is opened, and the intermediate electrode 811 and the porous electrode (first porous electrode) 816 are disconnected from the DC power supplies E1 and E2 with different polarities. Further, the switching element S5a is closed, and the electrode-on-first substrate 823 and the intermediate electrode 811 are connected to the AC power supply circuit V_{ECL} 210. An AC voltage is, therefore, generated between the electrode on the first substrate side 803 and the intermediate electrode 811, and the first layer 806 including the luminescent material emits light due to this voltage so that the luminescence color is observed. If a color filter is provided onto the first substrate 801 of the pixel X_{i,j}, the filter color is observed from the first substrate 801 side. When the application of the voltage from the AC power supply circuit V_{ECL} 210 is stopped, the first layer 806 does not emit light, and the background color of the pixel X_{i,j}, for example, black is displayed.

The reflection display is performed by applying the DC voltage between the intermediate electrode 811 and the porous electrode (first porous electrode) 816. In the reflection display, the switching element S2 is closed, and the intermediate electrode 811 and the porous electrode (first porous electrode) 816 are connected to any of the DC power supplies E1 and E2 with different polarities, respectively. Therefore, the DC voltage is generated between the intermediate electrode 811 and the porous electrode (first porous electrode) 816 with the same electric potential, and the electrolyte layer 812 including the material showing the EC phenomenon is colored or becomes transparent. As a result, the second substrate 802 is observed as a background color via the colored electrolyte layer 812 or the transparent electrolyte layer 812 from the outside of the first substrate 801. When the polarities of the applied voltages from the DC power supplies E1 and E2 are changed, the colored electrolyte layer 812 becomes transparent or the transparent electrolyte layer 812 is colored. As a result, the background color or the color of the electrolyte layer 812 is observed from the first substrate 801 side.

In the display apparatus according to the eighth embodiment, the user can select the luminous display or the reflection display.

In the display apparatus according to the eighth embodiment, the AC power supply circuit V_{ECL} 210 and the DC power supply circuit 210 repeat the application of the voltage with trapezoidal waveform to the display element. As a result, the light emission with high luminance by the display element can be realized for a longer period of time in comparison with the case where the voltage with rectangular waveform is applied like the conventional display apparatuses.

A ninth embodiment is explained below.

In the display apparatus according to the ninth embodiment, as to the configuration of the display element, a porous electrode is provided between the first layer and the second layer. In the display apparatus according to this embodiment, the configuration of the display element L_{i,j} of the pixel X_{i,j} is different from that in the first embodiment.

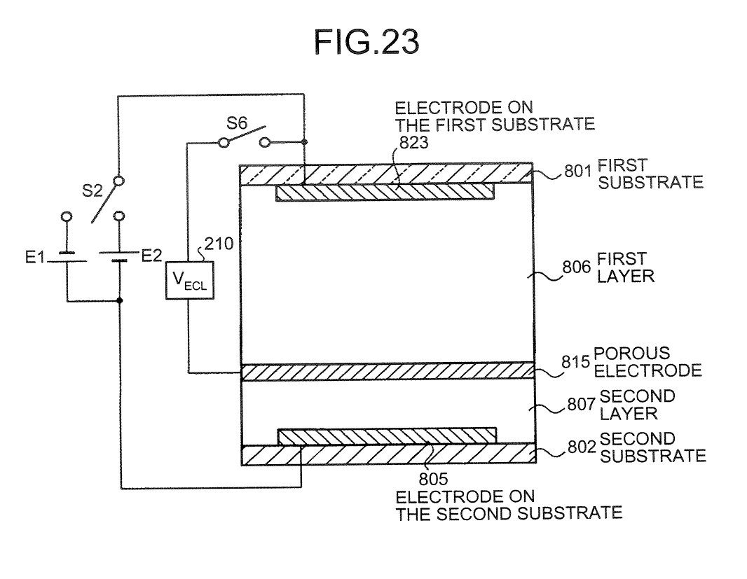

FIG. 23 is a sectional view schematically showing a configuration of the display element L_{i,j} to be the display cell in the display apparatus according to the ninth embodiment. In the display element L_{i,j} according to this embodiment, as shown in FIG. 23, the porous electrode or a porous electrode (second porous electrode) 815 including a porous material are provided between the second layer 807 and the first layer 806. The porous electrode (second porous electrode) 815 may be a composite membrane composed of a porous electrode (EC layer side) and a porous insulating film (electrolyte side). A pore diameter of the porous electrode (second porous electrode) 815 may fall within a range of 1 nm to 1000 nm, preferably a range of 1 nm to 100 nm. Various conductive materials (ITO, FTO, SnO₂ and the like) can be used, and thus it is not necessary that the pore shape and the pore diameter are uniform as long as the pore diameter falls within these ranges.

In the pixel X_{i,j} of the display apparatus according to the ninth embodiment, the luminous display is performed by applying the AC or DC voltage between the electrode-on-first substrate (electrode on the ECL side) 823 and the porous electrode (second porous electrode) 815. That is, in the display element L_{i,j} provided with only the electrode on the first substrate side 803 shown in FIG. 23, as to the luminous display, the switching element S2 is opened, the switching element S6 is closed, and the AC voltage is applied between the electrode-on-first substrate 823 and the porous electrode (second porous electrode) 815. As a result, the light emission can be observed on the first layer 806.

The reflection display is performed by applying the DC voltage between the electrode-on-first substrate 823 and the electrode-on-second-substrate (electrode on the EC side) 805. That is, in the reflection display, the switching element S2 is closed, the switching element S6 is opened, and any of the DC power supplies E1 and E2 with different polarities are connected to the electrode-on-first substrate 823 and the electrode-on-second-substrate 805, respectively. A voltage (electric potential) for causing EC reaction is applied therebetween, so that coloring and bleaching are observed on the second layer 807. When the polarities of the applied voltages from the DC power supplies E1 and E2 are changed, the colored second layer 807 becomes transparent or the transparent second layer 807 is colored. As a result, the background color or the color of the second layer 807 is observed from the first substrate 801 side.

The porous electrode (second porous electrode) 815 is normally made of an optically-transparent material so that the display can be observed. Examples of such an optically-transparent material are oxide of transition metal such as (compound) oxide of titanium (Ti), zirconium (Zr), hafnium (Hf), strontium (Sr), zinc (Zn), tin (Sn), indium (In), yttrium (Y), lanthanum (La), vanadium (V), niobium (Nb), tantalum (Ta), chromium (Cr), molybdenum (Mo) and tungsten (W) as metal oxide semiconductor, perovskite such as SrTiO₃, CaTiO₃, BlaTiO₃, MgTiO₃ and SrNb₂O₆, compound oxide of them and oxide mixture, and gallium nitride (GaN). Examples of the optically-transparent material to be frequently used are an oxide indium (In₂O₃) film (ITO) where tin (Sn) is doped, an oxide zinc (ZnO) film (IZO) where indium (In) is doped, an oxide zinc film (GZO) where gallium (Ga) is doped, and an oxide zinc film (FTO) where oxide tin (SnO₂) and fluorine for acid resistance are doped.

In this embodiment, as shown in FIG. 23, the electrode-on-first substrate 823 and the porous electrode (second porous electrode) 815 are connected to the AC power supply circuit V_{ECL} 210 via the switching element S6. They compose the first voltage applying unit (823, 815, V_{ECL} 210). Further, the electrode-on-first substrate 823 and the electrode-on-second-substrate 805 are connected to the DC power supplies E1 and E2 with different polarities via the switching element S2. They compose the second voltage applying unit (823, 805, E1, E2). The switching elements S6 and S2 compose the switching units (S6 and S2) that selectively operate the first voltage applying unit (823, 815, V_{ECL} 210) and the second voltage applying unit (823, 805, E1, E2).

The AC power supply circuit V_{ECL} 210 has the similar configuration to that in the first embodiment, and is composed of the counter voltage generating circuit 211, the signal voltage generating circuit 212, the variable resistor 213 and the switching element 214. The circuit V_{ECL} 210 applies an AC voltage between the electrode on the first substrate side 803 and the porous electrode 815 so that the voltage waveform becomes trapezoid as shown in FIG. 4.

The counter voltage generating circuit 211 is connected to the porous electrode 815, and the signal voltage generating circuit 212 is connected to the electrode-on-first substrate 823 via the variable resistor 213 and the switching element 214. Similarly to the first embodiment, when the AC voltage generated from the signal voltage generating circuit 212 is applied to the electrode-on-first substrate 823, the AC voltage passes through the variable resistor 213, so that while the voltage value is being gradually increased for the first period (t1), the voltage is allowed to reach a predetermined voltage value at the time when the first period elapses. The predetermined voltage is maintained for the second period (t2) starting from the elapse of the first period. While the voltage is being gradually reduced for the third period (t3) starting from the elapse of the second period, the voltage is applied so that the voltage obtains a trapezoidal waveform where the value becomes 0 after elapse of constant period of time. Such application of the voltage is repeated so that the polarities differ alternately, and thus the AC voltage of the trapezoid wave is applied.

In the AC power supply circuit V_{ECL} 210, the AC voltage is applied between the electrode-on-first substrate 823 and the porous electrode 815 by the switching operation of the variable resistor 213 and the switching element 214 repeatedly per constant cycle as shown in FIG. 4 so that the voltage waveform for one cycle becomes trapezoid.

In the AC power supply circuit V_{ECL} 210 of this embodiment, the counter voltage generating circuit 211 is connected to the porous electrode 815, and the signal voltage generating circuit 212 is connected to the electrode-on-first substrate 823 via the variable resistor 213 and the switching element 214. On the contrary, however, the counter voltage generating circuit 211 may be connected to the electrode-on-first substrate 823, and the signal voltage generating circuit 212 may be connected to the porous electrode 815 via the variable resistor 213 and the switching element 214.

In this embodiment, the variable resistor 213 is used in the AC power supply circuit V_{ECL} 210 so that the voltage waveform becomes trapezoid. Instead of the variable resistor 213, another circuit such as the low pass filter 313 shown in FIG. 2 may be used so that the voltage waveform becomes trapezoid.

In this embodiment, the AC power supply circuit V_{ECL} 210 applies the AC voltage between the electrode-on-first substrate 823 and the porous electrode 815. However, the counter voltage generating circuit 211 and the signal voltage generating circuit 212 may be constituted so that the DC voltage is applied between the electrode-on-first substrate 823 and the porous electrode 815.

In the display apparatus according to the ninth embodiment, the user can select the luminous display or the reflection display in the simple configuration.

In the display apparatus according to the ninth embodiment, when the AC power supply circuit V_{ECL} 210 repeats the application of the voltage of trapezoidal waveform to the display element, the light emission with high luminance can be maintained for a longer period of time in comparison with the case where a voltage with rectangular waveform is applied like conventional display apparatuses.

A tenth embodiment is explained below.

In the display apparatus according to the tenth embodiment, the first electrode-on-first-substrate as an electrode for ECL driving and the second electrode-on-first-substrate as an electrode for EC driving are provided onto the first substrate 801. The first electrode-on-second-substrate as an electrode for ECL driving and a second electrode-on-second-substrate as an electrode for EC driving are provided onto the second substrate 802, and the second layer is locally provided as the configuration of the display element.

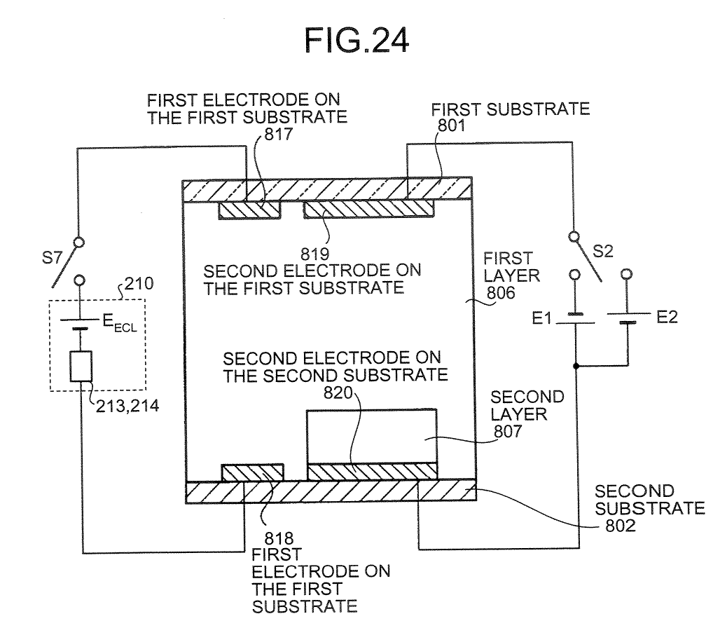

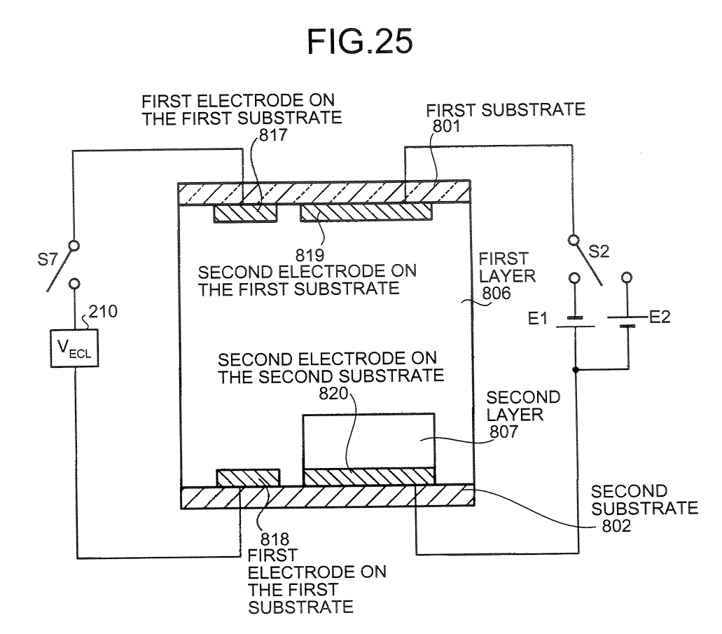

In the display apparatus according to this embodiment, the configuration of the display element L_{i,j} of the pixel X_{i,j} is different from that in the first embodiment. FIGS. 24 and 25 are sectional views schematically showing the configuration of the display element L_{i,j} to be the display cell in the display apparatus according to the tenth embodiment. The display element L_{i,j} according to this embodiment is, as shown in FIGS. 24 and 25, constituted so that a first electrode-on-first-substrate (first electrode for ECL driving) 817 and a second electrode-on-first-substrate (first electrode for EC driving) 819 are disposed on the first substrate 801, and a first electrode-on-second-substrate (second electrode for ECL driving) 818 and a second electrode-on-second-substrate (second electrode for the EC driving) 820 are disposed on the second substrate 802. Further, the first layer 806 is inserted between the first substrate 801 and the second substrate 802, so as to be locally provided between the first layer 806 and the second electrode-on-second-substrate 820.

Further, the second electrode-on-first-substrate 819 and the second electrode-on-second-substrate 820 are connected to the DC power supplies E1 and E2 with different polarities via the switching element S2. They compose the second voltage applying unit (819, 820, E1, E2). The switching elements S7 and S2 compose the switching units (S7 and S2) that selectively operate the first voltage applying unit (817, 818, 210) and the second voltage applying unit (819, 820, E1, E2).

The DC power supply circuit 210 has the similar configuration to that of the power supply circuit 210 in the first embodiment, and is composed of the DC power supply E_{ECL} including the counter voltage generating circuit 211 and the signal voltage generating circuit 212, the variable resistor 213 and the switching element 214. The circuit 210 applies a DC voltage between the first electrode-on-first-substrate 817 and the first electrode-on-second-substrate 818 so that the voltage waveform becomes trapezoid as shown in FIG. 5.

The counter voltage generating circuit 211 is connected to the first electrode-on-first-substrate 817, and the signal voltage generating circuit 212 is connected to the first electrode-on-second-substrate 818 via the variable resistor 213 and the switching element 214. Similarly to the first embodiment, when the DC voltage generated from the signal voltage generating circuit 212 is applied to the first electrode-on-second-substrate 818, the DC voltage passes through the variable resistor 213, so that while the voltage value is being gradually increased for the first period, the voltage is allowed to reach a predetermined voltage value at the time when the first period elapses. The predetermined voltage is maintained for the second period starting from the elapse of the first period. While the voltage value is being gradually reduced for the third period starting from the elapse of the second period, the voltage is applied so that the voltage obtains a trapezoidal waveform where the value becomes 0 after elapse of constant period of time. Such application of the voltage is repeated without changing polarities, so that the DC voltage of the trapezoid wave is applied.

In the DC power supply circuit 210, the DC voltage is applied between the first electrode-on-first-substrate 817 and the first electrode-on-second-substrate 818 by the switching operation of the variable resistor 213 and the switching element 214 repeatedly per constant cycle as shown in FIG. 5 so that the voltage waveform for one cycle becomes trapezoid.

In the DC power supply circuit 210 of this embodiment, the counter voltage generating circuit 211 is connected to the first electrode-on-first-substrate 817, and the signal voltage generating circuit 212 is connected to the first electrode-on-second-substrate 818 via the variable resistor 213 and the switching element 214. On the contrary, however, the counter voltage generating circuit 211 may be connected to the first electrode-on-second-substrate 818, and the signal voltage generating circuit 212 may be connected to the first electrode-on-first-substrate 817 via the variable resistor 213 and the switching element 214.

In this embodiment, the variable resistor 213 is used in the DC power supply circuit 210 so that the voltage waveform becomes trapezoid. Instead of the variable resistor 213, another circuit such as the low pass filter 313 shown in FIG. 2 may be used so that the voltage waveform becomes trapezoid.

Meanwhile, in the pixel X_{i,j} of the display apparatus according to the tenth embodiment shown in FIG. 25, the first electrode-on-first-substrate 817 and the first electrode-on-second-substrate 818 are connected to the AC power supply circuit V_{ECL} 210 via the switching element S7. They compose the first voltage applying unit (817, 818, V_{ECL} 210). Further, the second electrode-on-first-substrate 819 and the second electrode-on-second-substrate 820 are connected to the DC power supplies E1 and E2 with different polarities via the switching element S2. They compose the second voltage applying unit (819, 820, E1, E2). The switching elements S7 and S2 compose the switching units (S7 and S2) that selectively operate the first voltage applying unit (817, 818, V_{ECL} 210) and the second voltage applying unit (819, 820, E1, E2).

The luminous display on the display element L_{i,j} of the pixel X_{i,j} of the display apparatus according to the tenth embodiment shown in FIG. 25 is performed by applying the AC voltage between the first electrode-on-first-substrate 817 and the first electrode-on-second-substrate 818. That is, in the configuration of the display element L_{i,j} shown in FIG. 25, as to the luminous display, the switching element S2 is opened, the switching element S7 is closed, and the AC voltage with a frequency which the EC reaction cannot follow is applied between the first electrode-on-first-substrate 817 and the first electrode-on-second-substrate 818. As a result, the light emission is observed on the first layer 806.

The reflection display is performed by applying the DC voltage between the second electrode-on-first-substrate 819 and the second electrode-on-second-substrate 820. That is, in the reflection display, the switching element S2 shown in FIGS. 24 and 25 is closed, the switching element S7 is opened, and any of the DC power supplies E1 and E2 with different polarities are connected between the second electrode-on-first-substrate 819 and the second electrode-on-second-substrate 820. A voltage (electric potential) for causing EC reaction is applied therebetween, so that coloring and bleaching are observed on the second layer 807. When the polarities of the applied voltages from the DC power supplies E1 and E2 are changed, the colored second layer 807 becomes transparent or the transparent second layer 807 is colored. As a result, the background color or the color of the second layer 807 is observed from the first substrate 801 side.

The AC power supply circuit V_{ECL} 210 has the similar configuration to that of the power supply circuit 210 in the first embodiment, and is composed of the counter voltage generating circuit 211, the signal voltage generating circuit 212, the variable resistor 213 and the switching element 214. The circuit V_{ECL} 210 applies an AC voltage between the first electrode-on-first-substrate 817 and the first electrode-on-second-substrate 818 so that the voltage waveform becomes trapezoid as shown in FIG. 4.

More specifically, the counter voltage generating circuit 211 is connected to the first electrode-on-first-substrate 817, and the signal voltage generating circuit 212 is connected to the first electrode-on-second-substrate 818 via the variable resistor 213 and the switching element 214. Similarly to the first embodiment, when the AC voltage generated from the signal voltage generating circuit 212 is applied to the first electrode-on-second-substrate 818, the AC voltage passes through the variable resistor 213, so that while the voltage value is being gradually increased for the first period, the voltage is allowed to reach a predetermined voltage value at the time when the first period elapses. The predetermined voltage is maintained for the second period starting from the elapse of the first period. While the voltage value is being gradually reduced for the third period starting from the elapse of the second period, the voltage is applied so that the voltage obtains a trapezoidal waveform where the value becomes 0 after elapse of constant period of time. Such application of the voltage is repeated so that the trapezoid wave where polarity differs alternately. As a result, the AC voltage of the trapezoid wave is applied.

In the AC power supply circuit V_{ECL} 210, the AC voltage is applied between the first electrode-on-first-substrate 817 and the first electrode-on-second-substrate 818 by the switching operation of the variable resistor 213 and the switching element 214 repeatedly per constant cycle as shown in FIG. 4 so that the voltage waveform for one cycle becomes trapezoid.

In the AC power supply circuit V_{ECL} 210 of this embodiment, the counter voltage generating circuit 211 is connected to the first electrode-on-first-substrate 817, and the signal voltage generating circuit 212 is connected to the first electrode-on-second-substrate 818 via the variable resistor 213 and the switching element 214. On the contrary, however, the counter voltage generating circuit 211 may be connected to the first electrode-on-second-substrate 818, and the signal voltage generating circuit 212 may be connected to the first electrode-on-first-substrate 817 via the variable resistor 213 and the switching element 214.

In this embodiment, the variable resistor 213 is used in the AC power supply circuit V_{ECL} 210 so that the voltage waveform becomes trapezoid. Instead of the variable resistor 213, another circuit such as the low pass filter 313 shown in FIG. 2 may be used so that the voltage waveform becomes trapezoid.

According to the display apparatus in the tenth embodiment, the reflection and the luminous display can be realized by the simple configuration. Further, in the display apparatus according to the tenth embodiment, when the AC power supply circuit V_{ECL} 210 and the DC power supply circuit 210 repeat the application of the voltage of trapezoidal waveform to the display element, the light emission with high luminance can be maintained for a longer period of time in comparison with the case where a voltage with rectangular waveform is applied like conventional display apparatuses.

An eleventh embodiment is explained below.

In the configuration of the display element in the display apparatus according to the eleventh embodiment, a porous film is provided to the electrode on the first substrate side 803. In the display apparatus according to this embodiment, the configuration of the display element L_{i,j} of the pixel X_{i,j} is different from that in the first embodiment.

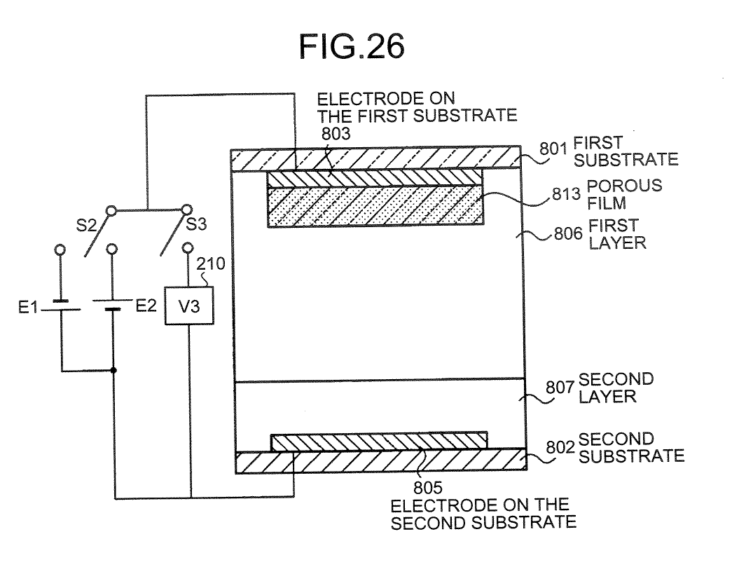

FIG. 26 is a sectional view schematically showing the configuration of the display element L_{i,j} to be the display cell in the display apparatus according to the eleventh embodiment. In the display element L_{i,j} according to this embodiment, as shown in FIG. 26, a porous film 813 is provided to the electrode on the first substrate side (electrode on ECL side) 803.

In the configuration of the display apparatus according to the third embodiment shown in FIG. 12, in the case of the reflection display, a small amount of ion radical species of the ECL material generated from the electrode on the first substrate side 803 and the second layer 807 react each other, and thus malfunction of light emission possibly occurs.

For this reason, in this embodiment, as shown in FIG. 26, the porous film 813 made of an electric conductor, a semiconductor or an insulator is provided onto the electrode on the first substrate side 803, thereby preventing transfer (diffusion) of the ion radical species generated from the electrode first substrate side 803 to the second layer 807. As a result, light emission (malfunction) due to the transfer (diffusion) of the ion radical species can be prevented.

A pore diameter of the porous film 813 may fall within a range of 1 nm to 1000 nm, preferably a range of 3 nm to 100 nm, and more preferably a range of 3 nm to 30 nm. Various electric conductors (ITO, FTO, SnO₂ and the like), semiconductors (TiO₂ and the like) or insulators (SiO₂ and the like) can be used, and thus it is not necessary that the pore shape and the pore diameter are uniform as long as the pore diameter falls within these ranges.

In the display apparatus according to this embodiment, the improvement in the light emission luminance on the electrode on the first substrate side 803 can be expected. This is because the ion radical species with different polarities which are generated from the electrode on the first electrode side 803 remain in the porous film 813 and do not diffuse into the electrolyte, so that the ion radical species collide, namely, emit light efficiently in the porous film 813.

The AC power supply circuit V3 210 in this embodiment, similarly to the third embodiment, applies an AC voltage with a frequency which the EC reaction cannot follow. The AC power supply circuit V3 210 has the similar configuration to the power supply circuit 210 in the first embodiment, and is composed of the counter voltage generating circuit 211, the signal voltage generating circuit 212, the variable resistor 213 and the switching element 214. The circuit V3 210 applies an AC voltage between the electrode on the first substrate side 803 and the electrode-on-second-substrate 805 so that the voltage waveform becomes trapezoid as shown in FIG. 4.

More specifically, the counter voltage generating circuit 211 is connected to the electrode-on-second-substrate 805, and the signal voltage generating circuit 212 is connected to the electrode on the first substrate side 803 via the variable resistor 213 and the switching element 214. Similarly to the first embodiment, when the AC voltage generated from the signal voltage generating circuit 212 is applied to the electrode on the first substrate side 803, the AC voltage passes through the variable resistor 213, so that while the voltage value is being gradually increased for the first period (t1) as shown in FIG. 4, the voltage is allowed to reach a predetermined voltage value at the time when the first period elapses. The predetermined voltage is maintained for the second period (t2) starting from the elapse of the first period. While the voltage value is being gradually reduced for the third period (t3) starting from the elapse of the second period, the voltage is applied so that the voltage obtains a trapezoidal waveform where the value becomes 0 after elapse of constant period of time. Such application of the voltage is repeated so that the trapezoid wave where polarity differs alternately. As a result, the AC voltage of the trapezoid wave is applied.

In the AC power supply circuit V3 210, the AC voltage is applied between the electrode on the first substrate side 803 and the electrode-on-second-substrate 805 by the switching operation of the variable resistor 213 and the switching element 214 repeatedly per constant cycle as shown in FIG. 4 so that the voltage waveform for one cycle becomes trapezoid.

In the AC power supply circuit V3 210 of this embodiment, the counter voltage generating circuit 211 is connected to the electrode-on-second-substrate 805, and the signal voltage generating circuit 212 is connected to the electrode on the first substrate side 803 via the variable resistor 213 and the switching element 214. On the contrary, however, the counter voltage generating circuit 211 may be connected to the electrode on the first substrate side 803, and the signal voltage generating circuit 212 may be connected to the second electrode-on-second-substrate 805 via the variable resistor 213 and the switching element 214.

In this embodiment, the variable resistor 213 is used in the AC power supply circuit V3 210 so that the voltage waveform becomes trapezoid. Instead of the variable resistor 213, another circuit such as the low pass filter 313 shown in FIG. 2 may be used so that the voltage waveform becomes trapezoid.

In this embodiment, the AC voltage is applied by the AC power supply circuit V3 210 between the electrode on the first substrate side 803 and the electrode-on-second-substrate 805, but the counter voltage generating circuit 211 and the signal voltage generating circuit 212 may be constituted so that the DC voltage with trapezoidal waveform shown in FIG. 5 is applied between the electrode of the first substrate side 803 and the electrode of the second substrate side 805.

In the display apparatus according to the eleventh embodiment, the porous film 813 is provided onto the electrode on the first substrate side 803, thereby preventing transfer (diffusion) of ion radical species generated from the electrode on the first substrate side 803 to the second layer 807 and light emission (malfunction) due to the transfer (diffusion) of the ion radical species in the case of the reflection display. In the case of the luminous display, the light emission luminance on the electrode on the first substrate side 803 can be improved.

In the display apparatus according to the eleventh embodiment, the AC power supply circuit V3 210 repeats the application of the voltage with a trapezoidal waveform to the display element. As a result, the light emission with high luminance by the display element can be maintained for a longer period of time in comparison with the case where the voltage of rectangular waveform is applied like conventional display apparatuses.

An arrangement configuration of pixels in the display apparatus having the display element L_{i,j} according to the second to eleventh embodiments is explained below. FIG. 28 is a plan view showing a part (portion of 2×2) of the pixel arrangement in the display apparatus having the display element L_{i,j} according to the second to the eleventh embodiment. The display apparatus according to the second to eleventh embodiments is, as shown in FIG. 28, constituted so that the pixels X_{i,j} are arranged in matrices two-dimensionally (i=1 to n; j=1 to m; n and m are positive integers). The matrices are composed of a plurality of first signal wirings B1ⱼ, B1ⱼ₊₁, . . . and a plurality of second signal wirings B2ⱼ, B2ⱼ₊₁, . . . which are laid in a vertical direction (column-wise direction), and a plurality of first scanning wirings W1ᵢ, W1ᵢ₊₁, . . . and a plurality of second scanning wirings W2ᵢ, W2ᵢ₊₁, . . . which extend to a horizontal direction (row direction) perpendicular to the first signal wirings B1ⱼ, B1ⱼ₊₁, . . . and the second signal wirings B2ⱼ, B2ⱼ+₁, . . . . Further, first power supply wirings P1ⱼ, P1ⱼ₊₁, . . . and second power supply wirings P2ⱼ, P2ⱼ₊₁ . . . are laid so as to be parallel with the first signal wirings B1ⱼ, B1ⱼ₊₁ . . . and the second signal wirings B2ⱼ, B2ⱼ₊₁.

As shown in FIG. 28, the first signal wiring B1ⱼ is connected to a first terminal of a first writing transistor (TFT) Q1_{i,j}, and the first scanning wiring W1ᵢ is connected to a control terminal of the first wiring transistor Q1_{i,j}. A second terminal of the first writing transistor Q1_{i,j} is connected to a control terminal of a first driving transistor (TFT) Q2_{i,j} and one terminal of a first auxiliary capacitor C1_{i,j}. A first terminal of the first driving transistor Q2_{i,j} is connected to the first power supply wiring P1ⱼ, a second terminal of the first driving transistor Q2_{i,j} is connected to the display cell L_{i,j}. The other end of the first auxiliary capacitor C1_{i,j} is grounded. The “first terminal” means a terminal to be any one of an emitter terminal and a collector terminal in a bipolar transistor (BJT). In a field-effect transistor (FET) and a static induction transistor (SIT), the “first terminal” means to be any one of a source terminal and a drain terminal. The “second terminal” means a terminal to be any one of an emitter terminal and a collector terminal which is not the first terminal in BJT or the like, and means a terminal to be any one of the source terminal and the drain terminal in FET and SIT which is not the first terminal. That is, when the first terminal is the emitter terminal, the second terminal is the collector terminal, and when the first terminal is the source terminal, the second terminal is the drain terminal. The “control terminal” means a terminal for controlling an electric current flowing between the first terminal and the second terminal, a Schottky key junction terminal, a terminal of an insulating gate structure or its structure. For example, the “control terminal” means a gate terminal or a gate structure in FET and SIT, and means a base terminal in BJT. In TFT or the like generally, since the first terminal and the second terminal have symmetrical configurations, it is simply a matter of selection as to which is called as the source terminal or the drain terminal or which is called as the emitter terminal or the collector terminal. The second signal wiring B2ⱼ is connected to a first terminal of a second wiring transistor (TFT) Q3_{i,j}, and the second scanning wiring W2ᵢ is connected to a control terminal of a second writing transistor Q3_{i,j}. A second terminal of the second writing transistor Q3_{i,j} is connected to a control terminal of a second driving transistor (TFT) Q4_{i,j} and one terminal of a second auxiliary capacitor C2_{i,j}. A first terminal of a second driving transistor (TFT) Q4_{i,j} is connected to a second power supply wiring P2ⱼ, and a second terminal of the second driving transistor Q4_{i,j} is connected to the display cell L_{i,j}. The other terminal of the second auxiliary capacitor C2_{i,j} is grounded.

The first signal wiring B1ⱼ is connected to a first terminal of the first writing transistor (TFT) Q1_{i+1,j}, and a first scanning wiring W1ᵢ₊₁ is connected to a control terminal of the first writing transistor Q1_{i+1,j}. A second terminal of the first wiring transistor Q1_{i+,j} is connected to a control terminal of a first driving transistor (TFT) Q2_{i+1,j} and one terminal of a first auxiliary capacitor C1_{i+1,j}. A first terminal of the first driving transistor Q2_{i+1,j} is connected to the first power supply wiring P1ⱼ, and a second terminal of the first driving transistor Q2_{i+1,j} is connected to the display cell L_{i+1,j}. The other terminal of the first auxiliary capacitor C1_{i+1,j} is grounded. The second signal wiring B2ⱼ is connected to a first terminal of a second wiring transistor (TFT) Q3_{i+1,j}, and the second scanning wiring W2ᵢ₊₁ is connected to a control terminal of the second writing transistor Q3_{i+1,j}. A second terminal of the second writing transistor Q3_{i+1,j} is connected to a control terminal of a second driving transistor (TFT) Q4_{i+1,j} and one terminal of a second auxiliary capacitor C2_{i+1,j}. A first terminal of the second driving transistor Q4_{i+1,j} is connected to the second power supply wiring P2ⱼ, and a second terminal of the second driving transistor Q4_{i+1,j} is connected to the display cell L_{i+1,j}. The other terminal of the second auxiliary capacitor C2_{i+1,j} is grounded.

The first signal wiring B1ⱼ₊₁ is connected to a first terminal of a first writing transistor (TFT) Q1_{i,j+1}, and the first scanning wiring W1ᵢ is connected to a control terminal of the first writing transistor Q1_{i,j+1}. A second terminal of the first writing transistor Q1_{i,j+1} is connected to a control terminal of a first driving transistor (TFT) Q2_{i,j+1} and one terminal of a first auxiliary capacitor C1_{i,j+1}. A first terminal of the first driving transistor Q2_{i,j+1} is connected to the first power supply wiring P1ⱼ₊₁, and a second terminal of the first driving transistor Q2_{i,j+1} is connected to the display cell L_{i,j+1}. The other terminal of the first auxiliary capacitor C1_{i,j+1} is grounded. The second signal wiring B2ⱼ₊₁ is connected to a first terminal of a second writing transistor (TFT) Q3_{i,j+1}, and the second scanning wiring W2ᵢ is connected to a control terminal of the second writing transistor Q3_{i,j+1}. A second terminal of the second writing transistor Q3_{i,j+1} is connected to a control terminal of a second driving transistor (TFT) Q4_{i,j+1} and one terminal of the second auxiliary capacitor C2_{i,j+1}. A first terminal of the second driving transistor Q4_{i,j+1} is connected to the second power supply wiring P2ⱼ₊₁, and a second terminal of the second driving transistor Q4_{i,j+1} is connected to the display cell L_{i,j+1}. The other terminal of the second auxiliary capacitor C2_{i,j+1} is grounded.

Further, the first signal wiring B1ⱼ₊₁ is connected to a first terminal of a first writing transistor (TFT) Q1_{i+1,j+1}, and the first scanning wiring W1ᵢ₊₁ is connected to a control terminal of the first writing transistor Q1_{i+1,j+1}. A second terminal of the first writing transistor Q1_{i+1,j+1} is connected to a control terminal of a first driving transistor (TFT) Q2_{i+1,j+1} and one terminal of a first auxiliary capacitor C1_{i+1,j+1}. A first terminal of the first driving transistor Q2_{i+1,j+1} is connected to the first power supply wiring P1ⱼ₊₁, and a second terminal of the first driving transistor Q2_{i+1,j+1} is connected to the display cell L_{i+1,j+1}. The other end of the first auxiliary capacitor C1_{i+1,j+1} is grounded. The second signal wiring B2ⱼ₊₁ is connected to a first terminal of a second writing transistor (TFT) Q3_{i+1,j+1}, and the second scanning wiring W2ᵢ₊₁ is connected to a control terminal of the second writing transistor Q3_{i+1,j+1}. A second terminal of the second writing transistor Q3_{i+1,j+1} is connected to a control terminal of a second driving transistor (TFT) Q4_{i+1,j+1} and one terminal of a second auxiliary capacitor C2_{i+1,j+1}. A first terminal of the second driving transistor Q4_{i+1,j+1} is connected to the second power supply wiring P2ⱼ₊₁, and a second terminal of the second driving transistor Q4_{i+,j+1} is connected to the display cell L_{i+1,j+1}. The other terminal of the second auxiliary capacitor C2_{i+1,j+1} is grounded.

As the first writing transistors Q1_{i,j}, Q1_{i+1,j}, Q1_{i,j+1}, and Q1_{i+1,j+1}, the first driving transistors Q2_{i,j}, Q2_{i+1,j}, Q2_{i,j+1}, and Q2_{i+1,j+1}, the second writing transistors Q3_{i,j}, Q3_{i+1,j}, Q3_{i,j+1} and Q3_{i+1,j+1}, and the second driving transistors Q4_{i,j}, Q4_{i+1,j}, Q4_{i,j+1}, and Q4_{i+1,j+1}, TFTs which are used for an active matrix substrate used in LCD and organic EL may be used.

The first scanning wirings W1ᵢ, W1ᵢ₊₁, . . . and the first signal wirings B1ⱼ, B1ⱼ₊₁, . . . are synchronized with each other so that voltages are applied, and display signals from the first writing transistors Q1_{i,j}, Q1_{i+1,j}, Q1_{i,j+1}, Q1_{i+1,j+1}, . . . are accumulated in the first auxiliary capacities C1_{i,j}, C1_{i+1,j}, C1_{i,j+1, C1}_{i+1,j+1}, . . . . The first driving transistors Q2_{i,j}, Q2_{i+1,j}, Q2_{i,j+1}, Q2_{i+,j+1}, . . . can control the amount of electric current to flow in the display cells L_{i,j}, L_{i+1,j}, L_{i,j+1} and L_{i+1,j+1} according to the amount of electric charges of the display signals in the first auxiliary capacities C1_{i,j}, C1_{i+1,j}, C1_{i,j+1}, C1_{i+1,j+1}, . . . . Similarly, the second scanning wirings W2ᵢ, W2ᵢ₊₁, . . . and the second signal wirings B2ⱼ, B2ⱼ₊₁, . . . are synchronized with each other so that voltages are applied, and display signals from the second writing transistors Q3_{i,j}, Q3_{i+1,j}, Q3_{i,j+1}, Q3_{i+1,j+1}, . . . are accumulated in the second auxiliary capacities C2_{i,j}, C2_{i+1,j}, C2_{i,j+1}, C2_{i+1,j+1}, . . . . The second driving transistors Q4_{i,j}, Q4_{i+1,j}, Q4_{i,j+1}, Q4_{i+,j+1}, . . . can control the amount of electric current to flow in the display cells L_{i,j}, L_{i+1,j}, L_{i,j+1}, and L_{i+1,j+1} according to the amount of electric charges of the display signals in the second auxiliary capacities C2_{i,j}, C2_{i+1,j}, C2_{i,j+1}, C2_{i+1,j+1}, . . . .

As a result, the electric current which flows in the display cells L_{i,j}, L_{i+1,j}, L_{i,j+1}, and L_{i+1,j+1} supplied from the first power supply wirings P1ⱼ, P1ⱼ₊₁, . . . and the second power supply wirings P2ⱼ, P2ⱼ₊₁, . . . is switched, so that display can be performed while both the reflection display and the luminous display are being switched.

[Method of Manufacturing the Display Apparatus]

The method of manufacturing the above-explained display apparatus is explained by exemplifying the display apparatus according to the second embodiment. The method of manufacturing the display apparatus explained below is one example, and needless to say, the manufacturing method including this modified example can be realized by various manufacturing methods other than the following method.

(1) Substrates with thickness of 0.7 mm made of glass are used as the first substrate 801 and the second substrate 802, and ITO with film thickness of 100 nm is formed by sputtering. ITO is patterned so that the first electrode-on-first-substrate 803, the second electrode-on-first-substrate 804 and the electrode-on-second-substrate 805 are formed.

(2) After a surface of the second substrate 802 formed with the electrode-on-second-substrate 805 is subject to UV process, the surface is spin-coated with previously synthesized polytungsten peroxide solution containing tungsten 4 mol/l, and an EC layer (W₁O₃ film) to be the second layer 807 is formed so as to have a thickness of about 100 nm.

(3) The first substrate 801 and the second substrate 802 are arranged in an opposed manner via a glass beads spacer with particle diameter of 2 μm so as to have a gap of 2 μm, and their circumference excluding an filling opening is hardened by epoxy resin so that a cell is formed.

(4) Lithium salt (LiCF₃SO₃) of 10 mM and TBAPF₆ (tetra-n-butylammoniumhexafluorophosphate) are dissolved in o-dichlorobenzene/acetonitrile mixed solvent (3/1) so that an electrolyte is formed as a supporting electrolyte. Rubrene of 10 mM as an ECL material is dissolved in the electrolyte, and it is injected into the cell so that the first layer (ECL electrolyte layer) 806 is formed. A previously created reflection plate made of Al and the cell are laminated so that the display apparatus is completed.

The display apparatus according to the second embodiment is exemplified based on the above-explained display apparatus, and its operation is explained. The 2.5 inch display apparatus was manufactured by using the above method of manufacturing the display apparatus. The display cell L_{i,j} of each pixel X_{i,j} has the configuration shown in FIG. 8 composed of a single-color electrochemical reaction element, and the display apparatus was manufactured so that the size of one pixel X_{i,j} became 100 μm. The first electrode-on-first-substrate 803 and the second electrode-on-first-substrate 804 had the same electric potential, and a voltage was applied between the electrodes 803 and the electrode 804 and the electrode-on-second-substrate 805. As a result, the polarities of the applied voltages were selected and the voltage was applied so that the electrode-on-second-substrate 805 became positive, and thus a bleached state was realized.

Further, the polarity of the applied voltage was selected and the voltage was applied so that the electrode-on-second-substrate 805 becomes negative. As a result, a blue-colored state was realized, and it was found that reflection display was possible.

The voltage was not applied to the electrode-on-second-substrate 805, and an AC voltage with rectangular wave of 20 Hz was applied between the first electrode-on-first-substrate 803 and the second electrode-on-first-substrate 804. As a result, yellow light emission was observed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A display apparatus comprising:
a display element that includes an electrolyte solution layer containing an electrochemical luminescent material; and
a voltage applying unit that applies a voltage with a waveform having a gradient for a first period and a flat top for a second period following the first period, to the electrolyte solution layer, so that the electrochemical luminescent material emits light.

2. The display apparatus according to claim 1, wherein
the display element includes a first substrate and a second substrate located so as to be separated from and opposed to the first substrate, the electrolyte solution layer is located between the first substrate and the second substrate, and
the voltage applying unit includes a first electrode located on the first substrate and a second electrode located on the second substrate and opposed to the first electrode, applies the voltage between the first electrode and the second electrode.

3. The display apparatus according to claim 2, wherein the second electrode includes a plurality of electrode portions.

4. The display apparatus according to claim 3, wherein the voltage applying unit applies the voltage between the first electrode and each of the electrode portions.

5. The display apparatus according to claim 2, wherein the waveform constitutes a trapezoidal waveform, and the voltage applying unit repeatedly applies the voltage of the trapezoidal waveform between the first electrode and the second electrode.

6. The display apparatus according to claim 5, wherein the voltage applying unit includes a voltage generating circuit that generates a voltage, and a variable resistor that generates the voltage of the trapezoidal waveform from the voltage generated by the voltage generating circuit.

7. The display apparatus according to claim 5, wherein the voltage applying unit includes a voltage generating circuit that generates a voltage, and a low-pass filter that generates the voltage of the trapezoidal waveform from the voltage generated by the voltage generating circuit.

8. The display apparatus according to claim 2, wherein the waveform constitutes a trapezoidal waveform, and the voltage applying unit repeatedly applies the voltage of the trapezoidal waveform between the first electrode and the second electrode while polarity is being changed alternately.

9. The display apparatus according to claim 8, wherein the voltage applying unit includes a voltage generating circuit that generates a voltage, and a variable resistor that generates the voltage of the trapezoidal waveform from the voltage generated by the voltage generating circuit.

10. The display apparatus according to claim 8, wherein the voltage applying unit includes a voltage generating circuit that generates a voltage, and a low-pass filter that generates the voltage of the trapezoidal waveform from the voltage generated by the voltage generating circuit.

11. A display apparatus comprising:
a first layer that includes an electrochemical luminescent material;
a second layer that includes an electrochromic material which is located so as to be opposed to at least a part of the first layer;
a first voltage applying unit that applies a voltage to the first layer so that the electrochemical luminescent material emits light;
a second voltage applying unit that applies a voltage to the electrochromic material to change a color of the electrochromic material; and
a switching unit that selectively operates the first voltage applying unit and the second voltage applying unit.

12. The display apparatus according to claim 11, further comprising:
a first substrate; and
a second substrate located so as to be separated from and opposed to the first substrate, wherein
the first layer is located close to the first substrate between the first substrate and the second substrate,
the second layer is located closed to the second substrate between the first substrate and the second substrate,
the first voltage applying unit includes a first electrode and a second electrode which are each located on the first substrate, and applies a direct voltage or an alternating voltage between the first electrode and the second electrode so that the electrochemical luminescent material emits light, and
the second voltage applying unit includes a third electrode located on the second substrate, and applies a direct voltage between each of the first electrode and the second electrode and the third electrode to change a color of the electrochromic material.

13. The display apparatus according to claim 11, further comprising:
a first substrate; and
a second substrate located so as to be separated from and opposed to the first substrate, wherein
the first layer is located close to the first substrate between the first substrate and the second substrate,
the second layer is located close to the second substrate between the first substrate and the second substrate,
the first voltage applying unit includes a first electrode located on the first substrate,
the second voltage applying unit includes a second electrode located on the second substrate,
the first voltage applying unit applies an alternating voltage between the first electrode and the second electrode so that the electrochemical luminescent material emits light, and
the second voltage applying unit applies a direct voltage between the first electrode and the second electrode to change a color of the electrochromic material.

14. The display apparatus according to claim 11, further comprising:
a first substrate;
a second substrate located so as to be separated from and opposed to the first substrate; and
an electrolyte layer including a solvent and located between the first layer and the second layer, wherein
the first layer is located close to the first substrate between the first substrate and the second substrate,
the second layer is located close to the second substrate between the first substrate and the second substrate,
the first voltage applying unit includes a first electrode and a second electrode which each are located on the first substrate, and applies a direct voltage or an alternating voltage between the first electrode and the second electrode so that the electrochemical luminescent material emits light, and
the second voltage applying unit includes a third electrode located on the second substrate and an intermediate electrode located between the first layer and the electrolyte layer, and applies a direct voltage between the intermediate electrode and the third electrode to change a color of the electrochromic material.

15. The display apparatus according to claim 11, further comprising:
a first substrate;
a second substrate located so as to be separated from and opposed to the first substrate; and
an electrolyte layer including a solvent and located between the first layer and the second layer, wherein
the first layer is located close to the first substrate between the first substrate and the second substrate,
the second layer is located close to the second substrate between the first substrate and the second substrate,
the first voltage applying unit includes a first electrode located on the first substrate and an intermediate electrode located between the first layer and the electrolyte layer, and applies a direct voltage or an alternating voltage between the first electrode and the intermediate electrode so that the electrochemical luminescent material emits light, and
the second voltage applying unit includes a second electrode located on the second substrate, and applies a direct voltage between the intermediate electrode and the second electrode to change a color of the electrochromic material.

16. The display apparatus according to claim 11, further comprising:
a first substrate;
a second substrate located so as to be separated from and opposed to the first substrate;
an electrolyte layer including a solvent and located between the first layer and the second layer; and
a porous electrode located between the second layer and the electrolyte layer, wherein
the first layer is located close to the first substrate between the first substrate and the second substrate,
the second layer is located close to the second substrate between the first substrate and the second substrate,
the first voltage applying unit includes a first electrode and a second electrode which are each located on the first substrate, and applies a direct voltage or an alternating voltage between the first electrode and the second electrode so that the electrochemical luminescent material emits light, and
the second voltage applying unit includes a third electrode located on the second substrate, and applies a direct voltage between the first electrode or the second electrode and the third electrode to change a color of the electrochromic material.

17. The display apparatus according to claim 11, further comprising:
a first substrate;
a second substrate located so as to be separated from and opposed to the first substrate; and
an electrolyte layer including a solvent and located between the first layer and the second layer, wherein
the first layer is located close to the first substrate between the first substrate and the second substrate,
the second layer is located close to the second substrate between the first substrate and the second substrate,
the first voltage applying unit includes a first electrode and a second electrode which are each located on the first substrate, and applies a direct voltage or an alternating voltage between the first electrode and the second electrode so that the electrochemical luminescent material emits light, and
the second voltage applying unit includes a porous electrode located between the second layer and the electrolyte layer, and applies a direct voltage between the first electrode or the second electrode and the porous electrode to change a color of the electrochromic material.

18. The display apparatus according to claim 11, further comprising:
a first substrate;
a second substrate located so as to be separated from and opposed to the first substrate; and
an electrolyte layer including a solvent and located between the first layer and the second layer, and
the first layer is located close to the first substrate between the first substrate and the second substrate,
the second layer is located close to the second substrate between the first substrate and the second substrate,
the first voltage applying unit includes a first electrode located on the first substrate and an intermediate electrode arranged between the first layer and the electrolyte layer, and applies a direct voltage or an alternating voltage between the first electrode and the intermediate electrode so that the electrochemical luminescent material emits light, and
the second voltage applying unit includes a porous electrode located between the second layer and the electrolyte layer, and applies a direct voltage between the intermediate electrode and the porous electrode to change a color of the electrochromic material.

19. The display apparatus according to claim 11, further comprising:
a first substrate; and
a second substrate located so as to be separated from and opposed to the first substrate, wherein
the first layer is located close to the first substrate between the first substrate and the second substrate,
the second layer is located close to the second substrate between the first substrate and the second substrate,
the first voltage applying unit includes a first electrode located on the first substrate and a porous electrode located between the first layer and the second layer, and applies a direct voltage or an alternating voltage between the first electrode and the porous electrode so that the electrochemical luminescent material emits light, and
the second voltage applying unit includes a second electrode located on the second substrate, and applies a direct voltage between the first electrode and the second electrode to change a color of the electrochromic material.

20. The display apparatus according to claim 11, further comprising:
a first substrate; and
a second substrate located so as to be separated from and opposed to the first substrate, wherein
the first layer is located between the first substrate and the second substrate,
the second layer is locally located close to the second substrate,
the first voltage applying unit includes a first electrode located on the first substrate and a second electrode located on the second substrate, and applies a direct voltage or an alternating voltage between the first electrode and the second electrode so that the electrochemical luminescent material emits light, and
the second voltage applying unit includes a third electrode located on the first substrate and a fourth electrode located between the second substrate and the second layer, and applies a direct voltage between the third electrode and the fourth electrode to change a color of the electrochromic material.

21. The display apparatus according to claim 11, further comprising:
a first substrate; and
a second substrate located so as to be separated from and opposed to the first substrate, wherein
the first layer is located close to the first substrate between the first substrate and the second substrate,
the second layer is located close to the second substrate between the first substrate and the second substrate,
the first voltage applying unit includes a first electrode which is located on the first substrate and which is coated with a porous film,
the second voltage applying unit includes a second electrode located on the second substrate,
the first voltage applying unit applies a direct voltage or an alternating voltage between the first electrode and second electrode so that the electrochemical luminescent material emits light, and
the second voltage applying unit applies a direct voltage between the first electrode and the second electrode to change a color of the electrochromic material.

22. The display apparatus according to claim 11, wherein the voltage which the first voltage applying unit applies to the first layer has a waveform having a gradient for a first period and a flat top for a second period following the first period.

23. The display apparatus according to claim 22, wherein the waveform constitutes a trapezoidal waveform, and the first voltage applying unit repeatedly applies the voltage of the trapezoidal waveform to the first layer.

24. The display apparatus according to claim 22, wherein the waveform constitutes a trapezoidal waveform, and the first voltage applying unit repeatedly applies the voltage of the trapezoidal waveform to the first layer while polarity is being changed alternately.

25. A method of driving a display element that includes an electrolyte solution layer containing an electrochemical luminescent material, the method comprising:
gradually increasing a voltage to be applied to the electrolyte solution layer up to a predetermined level; and
maintaining the voltage of the predetermined level so that the electrochemical luminescent material emits light.

26. A method of driving a display element that includes a first layer containing an electrochemical luminescent material and a second layer containing an electrochromic material and located so as to be opposed to at least a part of the first layer, the method comprising:
selectively executing a first voltage applying step and a second voltage applying step, the first voltage applying step including applying a voltage to the first layer so that the electrochemical luminescent material emits light, and the second voltage applying step including applying a voltage to the second layer to change a color of the electrochromic material.
